(19) United States
(12) Patent Application Publication
(10) Pub. No.: US 2026/0283186 A1
(43) Pub. Date: Sep. 24, 2026

(54) REFRIGERATION MACHINE FOR MAKING EDIBLE ICED PRODUCTS

(71) Applicant: Guangdong Welly Electrical Appliances Co., Ltd., Zhongshan (CN)

(72) Inventors: Xiang’an Wu, Zhongshan (CN); Yinglong Yu, Zhongshan (CN); Haoliang Tian, Zhongshan (CN); Liang He, Zhongshan (CN); Wenzhan Hu, Zhongshan (CN)

(73) Assignee: Guangdong Welly Electrical Appliances Co., Ltd., Zhongshan (CN)

(21) Appl. No.: 19/575,347

(22) Filed: Mar. 23, 2026

(30) Foreign Application Priority Data
Mar. 24, 2025 (CN) 202520526891.8
Mar. 24, 2025 (CN) 202520526920.0
Jul. 4, 2025 (CN) 202521404474.2
Jul. 11, 2025 (CN) 202510962757.7
Jul. 11, 2025 (CN) 202521460651.9
Jul. 25, 2025 (CN) 202511036996.6
Jul. 25, 2025 (CN) 202511037003.7
Jul. 25, 2025 (CN) 202521573638.4
Jul. 25, 2025 (CN) 202521573646.9
Jul. 25, 2025 (CN) 202521573656.2
Jul. 25, 2025 (CN) 202521574281.1

(51) Int. Cl. A23G 9/04; A23G 9/08; A23G 9/22

(52) U.S. Cl. CPC A23G 9/045; A23G 9/086; A23G 9/222; A23G 9/224; A23G 9/228

(57) ABSTRACT

A refrigeration machine for preparing iced edibles is disclosed. The machine includes a housing cabinet defining a cabinet interior, a storage device for storing ingredients, an evaporator drum rotatably disposed in the cabinet interior and configured to contact and freeze the ingredients, a holding tray removably installed in the cabinet interior and accessibly disposed with respect to the evaporator drum, and a blade assembly mounted to the housing cabinet proximate to the evaporator drum.

### CROSS-REFERENCE TO RELATED APPLICATIONS

The instant application claims priority to Chinese Application Nos. 202520526891.8, 202520526920.0, filed on Mar. 24, 2025, Chinese Application No. 202521404474.2, filed on Jul. 4, 2025, Chinese Application Nos. 202510962757.7, 202521460651.9, filed on Jul. 11, 2025, Chinese Application Nos. 202521573638.4, 202521573646.9, 202511036996.6, 202511037003.7, 202521574281.1, 202521573656.2, filed on Jul. 25, 2025, are incorporated herein in their entireties by reference.

### TECHNICAL FIELD

The present disclosure relates to an ice-making refrigeration machine for preparing frozen beverages and edibles and, more particularly, to the assemblies and arrangements comprising the refrigeration machine to improve variability and operability.

### BACKGROUND

Refrigeration machines for making edible iced products conduct an ice-making operation in which liquid ingredients are frozen and the resulting solid ice may be converted into shavings or particulates for consumption. These types of refrigeration machines are referred to as snowflake or ice-shaving machines due to the consistency of the resulting iced products. The refrigeration machine may include a tank or reservoir that the liquid ingredients are poured into and a chamber or cylinder at which the ice-making process occurs. The refrigeration machine also includes a refrigeration system that conducts a thermodynamic cycle that is sufficient to lower the temperature of the liquid ingredients below freezing to undergo a phase change. The chamber or cylinder in which the ice-making process occurs is operatively associated with the evaporator of the refrigeration system. The refrigeration machine may also include a scrapper or cutter to convert the frozen ingredients to shavings and flakes.

The liquid ingredients may be juices, syrups, or dairy products. The refrigeration machine directs the liquid ingredients internally to the ice-making region associated with the chamber or cylinder and then directs the converted ice particles and shavings to a dispensing region. Because the refrigeration machine produces iced products for consumption, it is necessary to periodically clean the refrigeration machine for sanitary reasons. Additionally, when changing between ingredients, it is desirable to clean the machine surfaces and components to avoid contamination due to the previous ingredients. Aspects of the present disclosure are directed to improvements in the design and operability of refrigeration machines for making edible iced products.

### SUMMARY

In an aspect of the disclosure, there is described a refrigeration machine for preparing iced edibles. The refrigeration machine includes a housing cabinet defining a cabinet interior, a storage device for storing ingredients, an evaporator drum rotatably disposed in the cabinet interior and configured to contact and freeze the ingredients, a holding tray removably installed in the cabinet interior and accessibly disposed with respect to the evaporator drum, and a blade assembly mounted to the housing cabinet proximate to the evaporator drum. The holding tray may receive the ingredients from the storage device. The blade assembly is slidably detachable from the housing cabinet and includes a scrapping blade adapted to scrape the ingredients frozen to the evaporator drum.

In an embodiment, the blade assembly includes a blade holder and the blade is fixedly attached to the blade holder.

In an embodiment, the housing cabinet further comprises a housing liner assembly removably disposed in the cabinet interior. The blade assembly is slidably attached to the housing liner assembly or the housing cabinet by a wedge-lock arrangement. The housing liner assembly or the housing cabinet includes one or more slots for receiving respective flanges of the blade assembly.

In an embodiment, the housing liner assembly and the liquid holding tray cooperatively provide a first hole and a second hole laterally spaced apart from each other and adapted to encircle one or more shafts of the evaporator drum. The refrigeration machine may further includes a first seal assembly disposed between the first hole and a first shaft of the evaporator drum and a second seal assembly disposed between the second hole and a second shaft of the evaporator drum.

In an embodiment, the liquid holding tray comprises a release mechanism to releasably latch the liquid holding tray to the housing liner assembly or the housing cabinet. The release mechanism includes an elastic element arranged to urge a securing tab to engage in the housing liner assembly or the housing cabinet.

In an embodiment, the housing liner assembly defines a guide slot that slidably receives a guide pin located on the liquid holding tray during installation.

In an embodiment, the liquid holding tray comprises a drain valve mechanism to drain the ingredients.

In an embodiment, the liquid holding tray includes an inclined surface or a depression arranged to direct liquid ingredients to the drain valve mechanism. The drain valve mechanism comprises a drain pipe defining a valve seat and a valve element located in the drain pipe and movable against and away from the valve seat and a valve actuating handle that is selectively set between opened and closed positions of the drain valve mechanism.

In an embodiment, the liquid holding tray comprises an overflow valve.

In an embodiment, the evaporator drum defines an evaporator chamber that is in fluid communication with a refrigerant introduction pipe and a vapor return pipe.

In an embodiment, the refrigeration machine may further includes a drive motor operatively disposed to rotate the evaporator drum.

In an embodiment, the refrigeration machine may further includes a detector device operatively disposed to detect detachment of the storage device.

In an embodiment, the refrigeration machine may further includes a detector device operatively disposed to detect detachment of the blade assembly.

In an embodiment, the housing liner assembly comprises an inner shell that is detachably insertable into an outer shell.

In an embodiment, the refrigeration machine may further include a control panel to interface with an operator. The control panel may include a speed dial to adjust rotational speed of the evaporator drum.

In an alternative embodiment, there is described a refrigeration machine for preparing iced edibles. The refrigeration machine includes a housing cabinet defining a cabinet interior, a storage device for storing liquid ingredients that is detachably mounted to a top panel of the housing cabinet, an evaporator drum rotatably disposed in the cabinet interior and configured to contact and freeze the liquid ingredients, a liquid holding tray removably installed in the cabinet interior and accessibly disposed with respect to the evaporator drum, and a blade assembly removably attached to the housing cabinet proximate to the evaporator drum. The liquid holding tray is adapted to receive the liquid ingredients from the storage device and to partly submerge the evaporator drum. The blade assembly includes a scrapping blade adapted to scrape the ingredients frozen to the evaporator drum.

In an embodiment, the refrigeration machine further includes a housing liner assembly defining a liquid passageway from the storage device to the liquid holding tray.

In an embodiment, the housing liner assembly defines a structural recess and the storage device includes a storage body partly receivable in the structural recess to restrain movement of the storage device.

In an embodiment, the refrigeration machine further includes at least one locking arrangement between the storage device and the structural recess releasably locking the storage body to the housing liner assembly.

In an embodiment, the housing liner assembly defines an ice-making region in communication with the liquid passageway and the liquid holding tray is installable in the ice-making region.

In an embodiment, the liquid holding tray comprises a release mechanism to releasably latch the liquid holding tray to the housing liner assembly.

In an embodiment, the release mechanism includes a spring arranged to urge a securing tab to engage with a securing slot exposed in the cabinet interior.

In an embodiment, the release mechanism includes a fixed part fixed to the liquid holding tray. A moveable part is associated with the securing tab, and a telescoping section is disposed to extend and retract the fixed part and movable part.

In an embodiment, the release mechanism includes a pair of moveable parts and a pair of telescoping sections that are symmetrically opposed and commonly joined to the fixed part.

In an embodiment, the housing liner assembly defines a guide slot that can slidably receive a guide pin located on the liquid holding tray during installation.

In an embodiment, the liquid holding tray comprises a drain valve mechanism and the securing tab and guide pin orientate the liquid holding tray at an oblique angle to direct liquid ingredients to the drain valve mechanism.

In an embodiment, the liquid holding tray includes a depression arranged to direct liquid ingredients to the drain valve mechanism.

In an embodiment, the storage device includes a dispensing valve mechanism and the liquid holding tray includes an actuation rod arranged to actuate the dispensing valve mechanism upon mounting of the storage device to the housing cabinet.

In an embodiment, the dispensing valve mechanism includes a receiving hole to mechanically mate with the actuation rod.

In an embodiment, the housing liner assembly and the liquid holding tray cooperatively provide a first hole and a second hole laterally spaced apart from each other and adapted to rotatably encircle one or more shafts of the evaporator drum.

In an embodiment, the first and second bearing holes each accommodate a bushing to make contact with the one or more shafts of the evaporator drum.

In an embodiment, the bushing includes a first bushing half and a second bushing half.

In an embodiment, wherein the first bushing half is fixed to the housing liner assembly and the second bushing half is fixed to the liquid holding tray.

In an embodiment, the first and second holes each accommodate a seal assembly.

In an embodiment, each seal assembly includes a first collar half attachable to the housing liner assembly and a second collar half attachable to the liquid holding tray.

In an embodiment, the first collar half and the second collar half each comprise a fastener with a snap-fit portion engageable with a snap-fit hole disposed in the housing liner assembly and liquid holding tray respectively.

In an embodiment, each collar half includes a rigid support body and a flexible sealing lip.

In an embodiment, the refrigeration machine further includes a blade insert frame that slidably receives the blade assembly and that is part of one or more of the housing cabinet and the housing liner assembly.

In an embodiment, the blade insert frame produces a wedge-lock attachment with a blade holder of the blade assembly.

In an embodiment, the blade insert frame includes a pair of frame legs laterally opposed to each other and the blade holder can be inserted between the pair of frame legs.

In an embodiment, the pair of frame legs each include an insert slot that slidably receives a respective insertable flange located on the blade holder.

In an embodiment, the liquid holding tray comprises a drain valve mechanism to drain the liquid ingredients.

In an embodiment, the drain valve mechanism comprises a drain pipe defining a valve seat and a valve element located in the drain pipe and movable against and away from the valve seat.

In an embodiment, the drain valve mechanism comprises a valve actuating handle that can be selectively set between opened and closed positions of the drain valve mechanism.

In an embodiment, the drain pipe includes an axial notch and a radial notch that the valve actuating handle can move with respect to.

In an embodiment, the drain valve mechanism comprises a lever arm pivotally mounted to a tray bed and pivotally moveable toward and apart from a drain port disposed in the tray bed.

In an embodiment, the liquid holding tray comprises an overflow valve.

In an embodiment, the evaporator drum defines an evaporator chamber that is in fluid communication with a refrigerant introduction pipe and a vapor return pipe.

In an embodiment, the evaporator drum comprises an oil-return conduit located in the evaporator chamber to transfer oil to the vapor return pipe.

In an embodiment, the evaporator drum defines an evaporator chamber and is associated with an introduction conduit to introduce liquid refrigeration into the evaporator chamber and a gas return conduit to return gas refrigerant from the evaporator chamber.

In an embodiment, the introduction conduit and the gas return conduit that are coaxially disposed into the evaporator drum.

In an embodiment, the refrigeration machine further includes a drive motor operatively disposed to rotate the evaporator drum. The drive motor may be a variable speed motor.

In an embodiment, the refrigeration machine further includes a detector device operatively disposed to detect detachment of one of the storage device and the blade assembly.

In an embodiment, the refrigeration machine further includes a rotatable cover hinged to the housing cabinet to occlude the evaporator drum.

In an embodiment, the refrigeration machine further includes a detector device operatively disposed to detect opening of the rotatable cover.

In an embodiment, the housing liner assembly comprises an inner shell that is detachably insertable into an outer shell.

In an embodiment, the refrigeration machine further includes one or more of a temperature sensor associated with the evaporator drum, a motor sensor associated with a drive motor operatively coupled to the evaporator drum, and a level sensor associated with the storage device.

In an embodiment, the refrigeration machine further includes a control panel to interface with an operator. The control panel includes a speed dial to adjust rotational speed of the evaporator drum.

In an embodiment, there is described a method of operating a refrigeration machine to prepare iced edibles from liquid ingredients. The method includes receiving a using input indicative of a desired ice-making operation including a preset mode and manual mode, receiving data signals from one or more installation detectors respectively associated with one or more machine parts, pausing the ice-making operation in response to determining if one more machine parts are detached, receiving data signals from one or more operation sensors respectively associated with operation of the refrigeration machine, terminating the ice-making operation in response to occurrence of an operation error, and proceeding with the ice-making operation in response to non-occurrence of an operation error.

In an embodiment, one of the one or more operation sensors includes a motor sensor. The motor sensor may be one or more of a torque sensor, a current sensor, and speed sensor.

In an embodiment, the method further includes correlating data signals from the motor sensor to liquid ingredient quantities stored in the refrigeration machine.

In an embodiment, one of the one or more operation sensors includes an temperature sensor associated with an evaporator drum.

In an embodiment, the one or more operation sensors includes a liquid level sensor associated with a storage device for the liquid ingredients

In an embodiment, the machine parts comprise one or more of a storage device for liquid ingredients, a blade assembly for scrapping an evaporator drum, and a rotatable cover associated with an ice-making region of the refrigeration machine.

In an embodiment, the installation detectors are operatively associated with each of the storage device, the blade assembly, and the rotatable cover.

In an embodiment, the step of pausing includes (i) powering off a drive motor associated with an evaporator drum and a cooling fan, and (ii) operating a refrigeration system.

In an embodiment, the step of pausing occurs for a predetermined pause duration and subsequently includes terminating operation if the one or more machine parts remains detached.

In an embodiment, the manual mode includes receiving a user input from a control panel indicative of motor speed for a drive motor associated with an evaporator drum.

In an embodiment, the preset mode includes retrieving preprogrammed settings from memory associated with the ice-making operation.

In an embodiment, the preset mode is associated with a plurality of preset product selections.

In an embodiment, the method further includes conducting a cleaning mode in response to a user input.

In an embodiment, the cleaning mode includes (i) powering off a refrigeration system, and (ii) running a drive motor associated with an evaporator drum and cooling fan.

In an embodiment, the step of terminating the ice-making operation includes powering off a refrigeration system, a drive motor, and a cooling fan.

A possible advantage of the disclosed refrigeration machine is a detachable blade assembly that may be easily removed for cleaning without using a tool by a user. The blade holder of the blade assembly may protect the user from being cut by the blade.

Another possible advantage of the disclosed refrigeration machine is a detachable housing liner assembly that may be easily removed from the housing cabinet for cleaning without the need to move the entire machine.

Another possible advantage of the disclosed refrigeration machine is the sealing between the evaporator drum and the holes formed by the liquid holding tray and the housing liner assembly. The sealing may prevent leakage into the housing cabinet

Another possible advantage of the disclosed refrigeration machine is the detachable liquid holding tray that may be easily removed for cleaning by the user.

Another possible advantage of the disclosed refrigeration machine is the drain valve mechanism on the liquid holding tray that may allow for fast drainage of the residual liquid is the liquid holding tray.

### BRIEF DESCRIPTION OF THE DRAWINGS

FIG. 1 is a front perspective view of a refrigeration machine for preparing cold beverages and frozen edibles designed in accordance with aspects of the disclosure.

FIG. 2 is another front perspective view of the refrigeration machine illustrating an evaporator drum internally disposed inside an external cabinet housing.

FIG. 3 is another front perspective view of the refrigeration machine with the liquid ingredient storage device for containing liquid ingredients that is detachable from the cabinet housing and a rotatable cover allowing viewing of the cabinet interior.

FIG. 4 is an assembly view illustrating the housing liner assembly arranged for installation in the housing cabinet in association with the storage device and a lower liquid holding tray for holding the liquid ingredients.

FIG. 5 is an exploded view of the cabinet housing comprised of detachable exterior panels that are disposed about a housing liner assembly.

FIG. 6 is a partially exploded view of the top panel detached from the cabinet housing to expose the housing liner assembly arranged to interface with the storage device.

FIG. 7 is a bottom view of the top panel of the cabinet housing.

FIG. 8 is a perspective view of the storage device comprised of a storage body, a connecting body, and a dispensing valve mechanism.

FIG. 9 is a sectional view of the storage device.

FIG. 10 is a detailed view of the area indicated in FIG. 9 illustrating the attachment of the connecting body to the storage body.

FIG. 11 is a detailed view of the area indicated in FIG. 9 illustrating the attachment of the dispensing valve mechanism to the connecting body.

FIG. 12 is a front elevational view of the refrigeration machine illustrating a diversion trough.

FIG. 13 is a sectional view of the storage device disposed in the cabinet interior of the housing cabinet indicating the gravitational feed direction of the liquid ingredients.

FIG. 14 is a detailed view of the area indicated in FIG. 13 illustrating operation of the dispensing valve mechanism associated with the storage device.

FIG. 15 is a sectional view of the liquid holding tray.

FIG. 16 is a sectional view of the cabinet interior with the storage device and the liquid holding tray removed.

FIG. 17 is a perspective view of a release mechanism for attaching and releasing the liquid holding tray to the housing liner assembly.

FIG. 18 is an exploded view of the housing liner assembly in relation to the storage device, the liquid holding tray, and a blade assembly for accommodating a scrapper blade.

FIG. 19 is an exploded view of the housing liner assembly illustrating an inner liner shell and an outer liner shell in relation to the storage device, the liquid holding tray, and a blade assembly.

FIG. 20 is an assembly view illustrating attachment of the blade assembly to the housing liner assembly in relation to the evaporator drum.

FIG. 21 is an assembly view illustrating assembly of the inner shell with the storage device.

FIG. 22 is an assembly view illustrating assembly of the inner shell with the liquid holding tray.

FIG. 23 is an exploded view of the housing liner assembly illustrating an inner or first liner shell and an outer or second liner shell.

FIG. 24 is a perspective view of the housing liner assembly and evaporator drum illustrating attachment of the rotatable cover with the housing liner assembly.

FIG. 25 is an exploded view of an integral embodiment of the housing liner assembly in arrangement with the liquid ingredient storage device and the housing cabinet.

FIG. 26 is an assembly view showing the arrangement of the integral housing liner assembly with the housing cabinet.

FIG. 27 is a perspective view of the storage device mounted to the housing liner assembly.

FIG. 28 is a perspective view of a cooperative locking structure associated with the storage device and the housing liner assembly.

FIG. 29 is a perspective view of the housing liner assembly and the liquid holding tray assembled to form holes for retaining the evaporator drum.

FIG. 30 is a perspective view of the inner shell of the housing liner assembly.

FIG. 31 is a perspective view of the liquid holding tray.

FIG. 32 is a side elevational view showing the upper liner shell and the lower liquid holding tray arranged for assembly about a sealing bushing.

FIG. 33 is a side elevational view showing the upper liner shell and the lower liquid holding tray arranged for assembly about first and second bushing halves.

FIG. 34 is a side elevational view of the refrigeration machine illustrating the spatial arrangement between the storage device and the dispensing region.

FIG. 35 is a sectional view taken of FIG. 33 illustrating the evaporator drum rotatably retained by the housing liner assembly by sealing elements.

FIG. 36 is a detailed view of the area indicated in FIG. 35 illustrating an embodiment of one or more sealing elements mounted on the evaporator drum.

FIG. 37 is a detailed view of the area indicated in FIG. 35 illustrating another embodiment of the one or more sealing elements mounted on the evaporator drum.

FIG. 38 is a perspective view of the housing liner assembly and liquid holding tray assembled to provide holes each associated with a seal assembly.

FIG. 39 is an elevational view of the seal assembly installed about a hole and comprised of first and second collar halves.

FIG. 40 is a perspective view of the seal assembly comprised of a first collar half and a second collar half.

FIG. 41 is a sectional view of the lower liquid holding tray associated with the second collar halves to provides a saddle for the sealing assembly.

FIG. 42 is a detailed view of the area indicated in FIG. 41 showing a concaved sealing surface of the second collar half.

FIG. 43 is a perspective view of the housing liner assembly and the lower liquid holding tray assembled to retain the evaporator drum with the first and second seal assemblies.

FIG. 44 is a perspective view of the lower liquid holding tray operatively associated with a drain valve mechanism.

FIG. 45 is a bottom perspective view of the lower liquid holding tray with the drain valve mechanism attached.

FIG. 46 is a bottom perspective view of the lower liquid holding tray showing the release mechanism for mounting the drain valve mechanism.

FIG. 47 is a top perspective view of the release mechanism arrangement for attaching the drain valve mechanism to the lower liquid holding tray.

FIG. 48 is a front elevational view of the liquid holding tray with the drain valve mechanism descending therefrom.

FIG. 49 is a sectional view of the liquid holding tray with the drain valve mechanism integrally joined thereto.

FIG. 50 is a bottom plan view of the liquid holding tray and the drain valve mechanism.

FIG. 51 is a sectional view of the liquid holding tray with the drain valve mechanism.

FIG. 52 is a plan view of an embodiment of the drain valve mechanism.

FIG. 53 is a bottom plan view of the liquid holding tray with the drain valve mechanism attached.

FIG. 54 is a plan view of an embodiment of the drain valve mechanism

FIG. 55 is a perspective view of the valve control member for the drawing valve mechanism.

FIG. 56 is a sequentially view of a series of operating arrangements corresponding to the opening and closing of the drain valve mechanism.

FIG. 57 is an exploded view of the evaporator drum associated with a refrigerant introduction pipe and a vapor return pipe.

FIG. 58 is a sectional view of the evaporator drum showing the evaporator chamber defined by the cylindrical structure with a first embodiment of the refrigerant introduction conduit.

FIG. 59 is an elevational view of the axial cover of the evaporator drum with an oil-return conduit disposed adjacently thereto.

FIG. 60 is a perspective view of the axial cover of the evaporator drum showing the gas return hole communicating with the gas return conduit.

FIG. 61 is a detailed view of the gas return hole indicated in FIG. 58.

FIG. 62 is a sectional view of the evaporator drum showing the evaporator chamber defined by the cylindrical structure with another embodiment of the refrigerant introduction conduit.

FIG. 63 is an assembly view of the storage device and the rotatable cover in relation to the housing cabinet and operatively associated with detector devices.

FIG. 64 is an assembly view of the rotatably cover pivotably attachable to the housing cabinet.

FIG. 65 is an assembly view showing the first detector device in operative relation with the storage device and the housing cabinet.

FIG. 66 is an exploded view showing the housing liner assembly in relation to the storage device and the liquid holding tray.

FIG. 67 is a bottom perspective view of the dispensing valve mechanism on the storage device.

FIG. 68 is an assembly view showing the blade assembly attachable to a blade insertion frame of the housing cabinet and operatively associated with a detector device.

FIG. 69 is a flow diagram of a possible method of operation for the refrigeration machine in conjunction with the detectors.

FIG. 70 is a schematic diagram of the layout and ice-making operations of the refrigeration machine.

FIG. 71 is a flow diagram of an example of the ice-making operation.

FIG. 72 is a schematic representation of a visual display that may be presented to the user of the refrigeration machine.

### DETAILED DESCRIPTION

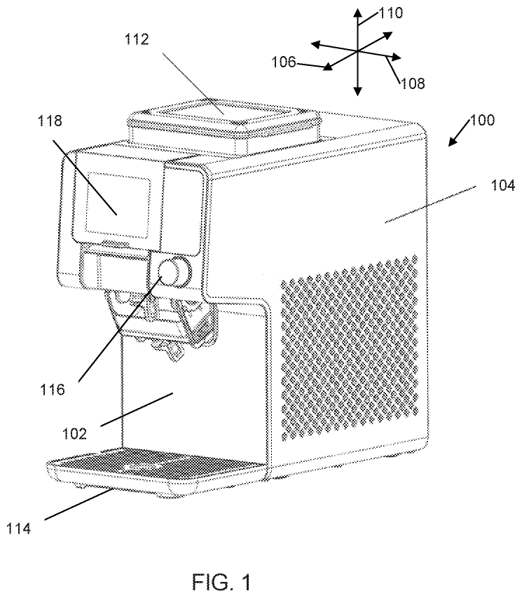

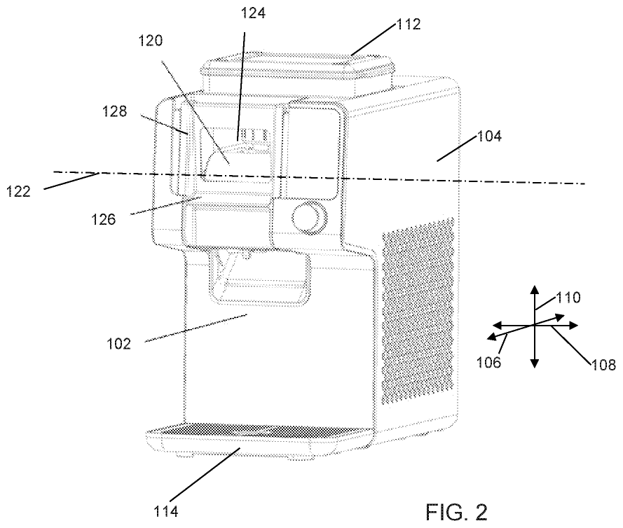

Now referring to the drawings, wherein whenever possible like reference numbers refer to like elements, there is illustrated in FIGS. 1 and 2 an example of a refrigeration machine 100 for preparing frozen beverages and frozen edibles at low temperatures for consumption. Examples of beverages and edibles included frozen or semi-frozen iced drinks, slushies, smoothies, semi-frozen juices, and flavored ices. In possible embodiments, the refrigeration machine 100 can also prepare frozen edibles and confectionaries such as ice cream, gelato, yogurt, and sorbet. The refrigeration machine 100 operates by lowering the temperature of liquid ingredients below the freezing point to convert the liquid ingredients to solid ice crystals. The ice can be discharged to a container such as a cup or mug that may be presented at a dispensing region 102 of the refrigeration machine 100

The illustrated embodiment of the refrigeration machine 100 is intended for home or commercial retail use and is designed for countertop operation. Accordingly, the refrigeration machine has a compact spatial presence and is designed to occupy a minimal footprint. However, aspects of the disclosure may also apply to larger-scale batch production as well as to high volume retail applications and involved in the continuous and repeated production of frozen beverages. The refrigeration machine 100 should demonstrate durability and ruggedness, simplicity of operation and use, and ease of cleaning and decontamination for sanitation. While the disclosure may describe a domestic configuration of the refrigeration machine 100, aspects of the disclosure may be applicable to other settings and uses, including configurations to make proportionally larger batches.

As shown in FIGS. 1 and 2, the refrigeration machine 100 can be supported on a horizontal surface such as a shelf or counter and may be geometrically configured to have a minimal footprint and to reduce the counterspace required. The refrigeration machine 100 can have an overall box-like or prismatic shape and is adapted to stand upright on the horizonal surface or shelf. For example, the refrigeration machine 100 can include an exterior housing or housing cabinet 104 that accommodates the internal components and is generally rectangular or cubic in shape. The dispensing region 102 can be located at the front or forward face of the housing cabinet 104 for accessibility. For reference purposes, the use refrigeration machine 100 can be associated with a longitudinal direction 106 that extends forwardly and rearwardly to orientate the front and back of the housing cabinet 104, a lateral direction 108 that is perpendicular to the longitudinal direction 106 and that determines the lateral sides of the refrigeration machine 100, and a vertical direction 110 associated with the upward and downward orientations. The reference directions intersect at right angles.

To receive the liquid ingredients, the refrigeration machine 100 includes a liquid ingredient storage device 112 that may be located at the top of the housing cabinet 104 in the vertical direction for accessibility and to simplify pouring ingredients into the housing cabinet 104. The storage device 112 may be generally located above the dispensing region 102 so that the processing direction of the liquid ingredients through the housing cabinet 104 is generally downward with respect to the vertical direction 110. Gravity assist in the downward flow of the liquid ingredients in the vertical direction 110 from the storage device 112 to the dispensing region 102. To capture spillage, the dispensing region 102 is associated with a drip tray 114 that is located at the front of the housing cabinet 104 and the extends forwardly in the longitudinal direction 106 beneath the dispensing region 102.

To interface with an operator, the refrigeration machine 100 includes a control panel 116 located at the front of the housing cabinet 104. The control panel 116 can be associated with a visual display screen and one or more knobs, buttons or dials for adjustment of the operation of the refrigeration machine 100. Examples of adjustable settings includes volume, temperature, production speed, and the like. The display screen associated with the control panel 116 can be an LED or LCD screen and provides visual indications of the operational settings and selections of the refrigeration machine 100.

Located laterally adjacent to the control panel 116 can be a rotatable cover 118 that is pivotally attached to the front of the housing cabinet 104. The rotatable cover 118 is located vertically above dispensing region 102 and is situated where the liquid ingredients are converted to ice and the formed ice is discharged from the housing cabinet 104. The rotatable cover 118 can pivot about a pivot axis that extends parallel to the lateral direction 108 and can be swung upwardly in the vertical direction 110 to access the internal components and critical operations associated with the ice-making process conducted by the refrigeration machine 100. The rotatable cover 118 may include a transparent plastic window or the like to enable viewing into housing cabinet 104.

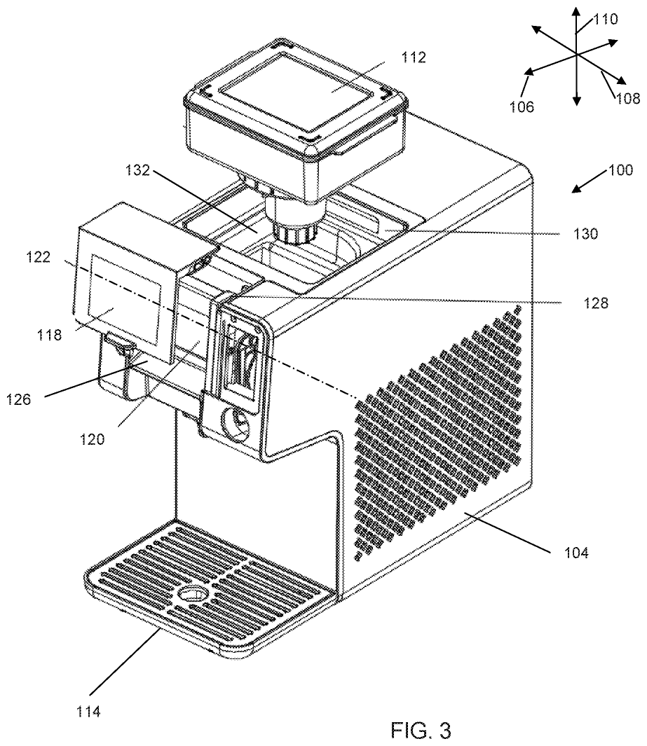

Referring to FIGS. 2 and 3, the rotatable cover 118 can occlude the interacting components of the refrigeration machine 100 responsible for producing ice from the liquid ingredients and carving the formed ice into shavings for consumption. For example, the refrigeration machine 100 can include an evaporator drum 120 that can rotate with respect to a rotation axis 122 and that is disposed in the cabinet interior 124 defined by the housing cabinet 104. The evaporator drum 120 can be a cylindrical structure and the rotation axis 122 defined by the cylindrical structure may be parallel with the lateral direction 108. The cylindrical shape of the evaporator drum 120 is thus oriented horizontally. The evaporator drum 120 can be driven to rotate against a blade assembly 126 that is located longitudinally forward of the evaporator drum 120 toward the front face of the housing cabinet 104 vertically above the dispensing region 102. The rotating evaporator drum 120 and the blade assembly 126 can physically interact in an ice-making region 128 of the refrigeration machine 100 that is located above the dispensing region 102 in the vertical direction 110.

During operation, the liquid ingredients are poured into the liquid ingredient storage device 112 located at the top of the housing cabinet 104 and that fluidly communicates with the cabinet interior 124. The liquid ingredients directed from the storage device 112 to the ice-making region 128 can solidify and form ice on the cylindrical surface of the evaporator drum 120. When the evaporator drum 120 rotates against the blade assembly 126, the ice formations are scrapped off as ice shavings and fall vertically toward the dispensing region 102. When the blade assembly 126 is attached to the housing cabinet 104 longitudinally forward of the evaporator drum 120, the blade assembly 126 may be directed vertically upwards and the evaporator drum 120 can be arranged to rotate about the rotation axis 122 downwardly against the blade assembly 136. The arrangement facilities discharging the ice shavings from the ice-making region 128 to the dispensing region 128 located vertically below. Conceivably, the blade assembly can be directed downwardly and the evaporator drum can rotate upwardly against the cylindrical surface of the blade assembly.

To chill the cylindrical surface of the evaporator drum 120 below the freezing temperature of the liquid ingredients, the evaporator drum 120 can be operatively associated with a refrigeration system accommodated in the cabinet interior 124. In addition to the evaporator drum 120, the refrigeration system can include a compressor, an expansion valve, and condenser and other components for conducting a refrigeration cycle.

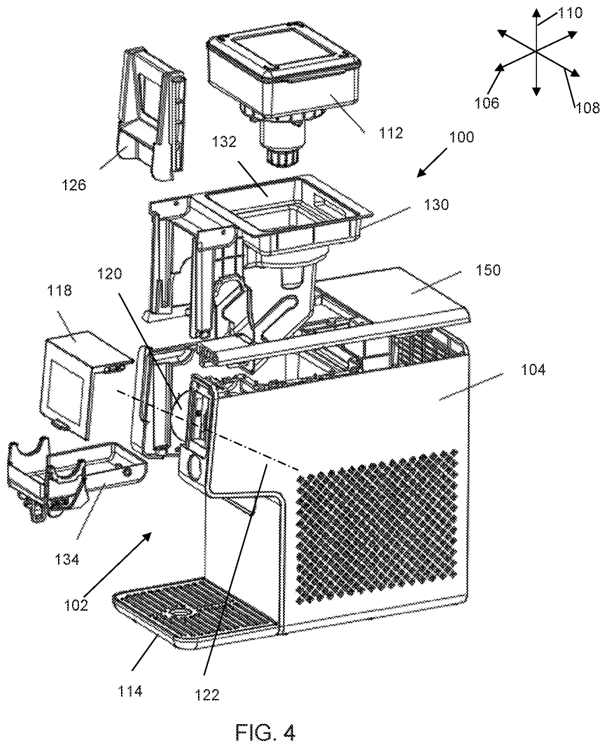

Referring to FIGS. 3 and 4, the housing cabinet 104 is configured as a structural enclosure defining the cabinet interior 124 and housing the internal components of the refrigeration machine 100. The housing cabinet 104 also defines and provides various pathways and fluid channels for directing the liquid ingredients between the storage device 112 and the ice-making region 128 accommodating the evaporator drum 120. For example, to fluidly connect the storage device 112 and the ice-making region 128, a housing liner assembly 130 can be located in the cabinet interior 124. The housing liner assembly 130 can be comprised of multiple liner shells that can be physically assembled together and that are shaped to direct fluid flow toward the ice-making region 128. For example, the shapes of the liner shells when assembled to form the housing liner assembly 130 defines a liquid passageway 132 which is an open cavity or channel inside of which the liquid ingredients can flow fluidly. Inclusion of the housing liner assembly 130 in the cabinet interior 124 separates and avoids contact of the interior surfaces of the housing cabinet 104 with the liquid ingredients. The removeable housing liner assembly 130 simplifies cleaning and improves sanitation. To interact with evaporator drum 120, the blade assembly 126 can be attached to the housing liner assembly 130 and stably held in position with respect to the ice-making region 128.

Referring to FIG. 4, to collect and retain the liquid ingredients in proximity to the evaporator drum 120, a liquid holding tray 134 is located below and in fluid communication with the housing liner assembly 130. The liquid holding tray 134 is shaped to receive and contain a fluid pool of the liquid ingredients. The liquid holding tray 134 is situated in the ice-making region 128 such that the evaporator drum 120 contacts and rotates with respect to the pool of liquid collected therein. For example, a lower arc or segment of the cylindrically shaped evaporator drum 120 is partly submerged in the liquid holding tray 134. The liquid holding tray 134 arranges the liquid ingredients in a location accessible to the evaporator drum 120 and functions similar to a bath or dip tank partly submerging the evaporator drum into the liquid ingredients for the ice-making process.

Flow and retention of the liquid ingredients may necessitate periodic cleaning and maintenance of the cabinet interior 124. During operation, scale and ingredient residues on inner walls of the cabinet interior 124 may form and require removal. Long-term use may also leads to bacterial growth and contamination of ice-making ingredients. If the housing cabinet 104 is an integral, fixed structure, cleaning and disassembly may be difficult.

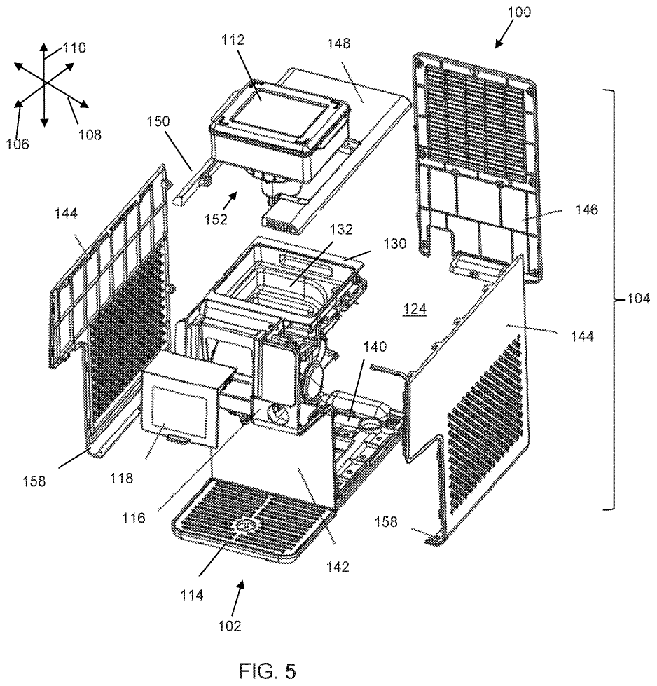

Referring to FIGS. 4 and 5, in an aspect, the housing cabinet 104 is configured for independent disassembly and separation of the fluid-contacting components to facilitate cleaning and replacement of the damage components. For example, to solve the sanitation problem, the refrigeration device 100 is comprised of the housing cabinet 104 configured for disassembly, disconnection, and removal of the storage device 112, the housing liner assembly 130, and the liquid holding tray 134. Disconnecting the housing cabinet 104 may also release the evaporator drum 120 and the blade assembly 126 for periodic cleaning. The internal components and parts of the housing cabinet 104 can be reassembled by snap-fit connections and toolless assembly methods.

In an embodiment, the refrigeration machine 100 can be assembled from the housing cabinet 104, the housing liner assembly 130, the storage device 112, and the liquid holding tray 134. The housing cabinet 104 provides external support and protection for the entire refrigeration machine 100, and the housing liner assembly 130 is detachably connected to the housing cabinet 104, allowing the housing liner assembly 130 to be separated from the housing cabinet 104. When cleaning or maintaining the housing liner assembly 130 is required, users can remove it as a whole from the cabinet interior 124 of the housing cabinet 104, providing more operating space and facilitating thorough cleaning of outer surfaces of the housing liner assembly 130 and the connection area with the housing cabinet 104. The storage device 112, and the liquid holding tray 134 are both detachably connected to and arranged on the housing liner assembly 130.

Through the detachable design between the housing cabinet 104 and the housing liner assembly 130, as well as the detachable connection methods of the storage device 112, and the liquid holding tray 134 with the housing liner assembly 130, the individual disassembly and separation of the liquid contacting components can be achieved. This enables thorough cleaning of the inner walls of the storage device 112, the interior of the liquid holding tray 134, effectively removing residual stains and bacteria. It addresses the cleaning difficulties caused by fixed components in existing apparatus, improving the hygiene performance of the apparatus. Additionally, it facilitates the separate replacement of damaged parts, reducing maintenance costs, and balancing the practicality and maintainability of the apparatus.

Referring to FIG. 5, the housing cabinet 104 includes a chassis floor 140, a front panel 142, side panels 144 that are laterally opposite each other and spaced apart in the lateral direction 108, and a rear panel 146. The front panel 142 can be associated with the control panel 116 and can be shaped to accommodate the dispensing region 102 at the front of the refrigeration machine 100. The drip tray 114 can project in the longitudinal direction 106 from the lower edge of the front panel 142 for example, as an extension of the chassis floor 140. The front panel 142, side panels 144, and the rear panel 146 extend perpendicularly upward in the vertical direction 110 from the chassis floor 140. The chassis floor 140, front panel 142, side panels 144, and rear panel 146 collectively form the overall framework of the housing cabinet 104, providing comprehensive protection for internal components such as the housing liner assembly 130. The panels may be planar in geometric shape and may be made from vacuum molded plastic. To ventilate the cabinet interior 124, select panels such as the side panels 144 and rear panel 146 may include airflow apertures or vents.

The front panel 142 and rear panel 146 are parallel and are respectively disposed at the front and rear sides of the chassis floor 140 with respect to the longitudinal direction 106, while the side panels 144 are disposed on the lateral left and right sides of the chassis floor 140. The surrounding arrangement enables the housing cabinet 104 to form an enclosed space corresponding to the cabinet interior 124, preventing external dust and impurities from entering an interior of the refrigeration machine 100, wherein the cabinet interior 124 further provides a degree of thermal insulation and sound insulation, thereby maintaining stability of an internal environment of the device and providing suitable conditions for preparation of cold drinks.

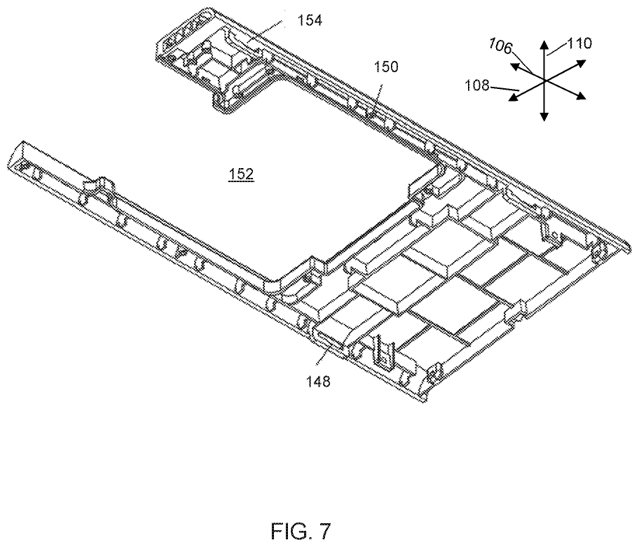

To enclose cabinet interior 124, the housing cabinet 104 can include a top panel 148 that is parallel to and located vertically above the chassis floor 140. The housing panel 148 is geometrically shaped to abut the upper edges of the side panels 144 and the rear panel 146. Referring to FIG. 7, the top panel 148 may partially embody a mounting frame 150 in which the storage device 112 can be situated. The mounting frame 150 may be a bifurcated forked structure that defines a mounting opening 152 that can receive the storage device 112. The mounting opening 152 defined between the bifurcated prongs of the mounting frame 150 corresponds in shape with the entry to the liquid passageway 132 defined by the housing liner assembly 130 and the housing liner assembly 130 and the mounting frame 150 can mate or attach together to provide a fluid tight interface.

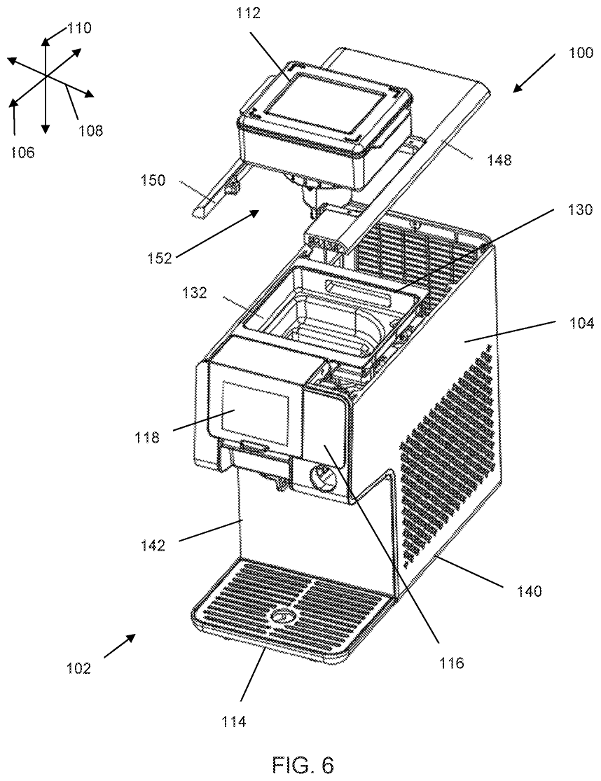

Referring to FIG. 6, the mounting opening 152 defined by the mounting frame 150 provides fluid communication with the liquid passageway 132 defined by the housing liner assembly 130. The top panel 148 provides an installation base for the mounting frame 150, while the mounting frame 150 offers positioning for the upper portion of the housing liner assembly 130, ensuring the stability of the connection between the housing liner assembly 130 and the housing cabinet 104. When the top panel 148 is situated on the housing cabinet 104, the storage device 112 can be situated in the mounting opening 152 and aligned to interface with the entry to the liquid passageway 132 of the housing liner assembly 130. The detachable placement method allows the upper lip of the housing liner assembly 130 to be removed from the mounting frame 150, facilitating subsequent cleaning and the separate replacement of damaged parts, thereby reducing maintenance costs.

Referring to FIGS. 5 and 6, to connect the top panel 148 to the housing cabinet 104, a connecting latch 154 is arranged at the bottom of the top panel 148, and a connecting hook 156 is arranged at the upper portion of the side panel 144. The connecting hook 156 can be inserted into the connecting latch 154. Through the latch-hook engagement, the top panel 148 can be quickly connected to and fixed with the side panel 144, enabling convenient installation and removal and facilitating maintenance of the upper portion of the refrigeration machine 100. A connecting clamp 158 is formed along the bottom edge of the side panels 144, through which the side panels 144 are fixed onto the chassis floor 140. This ensures a firm connection between the side panels 144 and the chassis floor 140, thereby enhancing the overall structural strength of the housing cabinet 104. As a result, the device is less likely to experience loosening of components during apparatus transportation or use, ensuring stability of the housing cabinet 104.

### Removable Liquid Contacting Parts

The liquid ingredient storage device 112 is configured for storing the liquid ingredients that the refrigeration machine 100 coverts to frozen ice shavings. Examples of liquid ingredients include water, flavored syrups, dairy products, etc. The storage device 112 is configured to function as a reservoir or tank to store and contain the liquids and to periodically dispense the liquids toward the ice-making region 128 of the refrigeration machine 100. As shown in FIGS. 5 and 6, the liquid ingredient storage device 112 can be situated in the mounting opening 152 disposed in the top panel 148 and may partially extend into the cabinet interior 124 that is exteriorly defined by the housing cabinet 104. To facilitate mounting and securing the storage device 112 in place, a portion of the lower structure of the storage device 112 may descent into the liquid passageway 132 defined at the entrance to the housing liner assembly 130 and may make abutting contact with the internal surfaces of housing liner assembly 130.

To facilitate cleaning and sanitation, the storage device 112 is detachable from the top panel 148 to expose the surfaces that are otherwise disposed in the liquid passageway 132. The liquid ingredient storage device 112 may be adapted for disassembly to enable separate cleaning of the internal surfaces and functional mechanisms. The disassembled characteristics of the storage device 112 enable effective and thorough cleaning and avoids issues and problems caused by integral containers that may form structural sanitary blind spots. When cleaning the liquid ingredient storage device 112, it can be completely removed from the housing cabinet 104, facilitating thorough cleaning of the inner walls and surfaces and the corners where it connects to the housing cabinet 104. This effectively removes scale, mold, and other residues, ensuring the cleanliness inside the storage device 112 and solving the issue of hard-to-reach cleaning areas in the prior art where the storage device 112 is non-detachable.

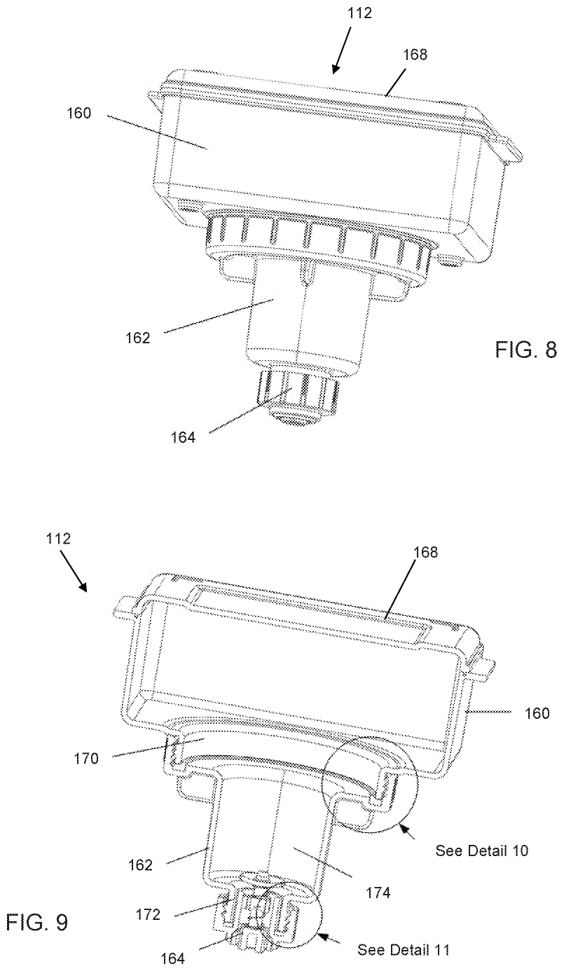

For example, referring to FIGS. 8 and 9, the storage device 112 may include a storage body 160, a connecting body 162, and a dispensing valve mechanism 164. The storage body 160 can be structurally configured as holding tank and define an internal volume 166 or space for receiving the liquid ingredients. The storage body 160 can be in a quadrilateral shape, a prismatic shape, a circular shape, a cylindrical shape, or in other shapes with a plurality of upright sidewalls perpendicularly interconnected in an orthogonal pattern to surround and enclose the internal volume. To access the internal volume 166, the storage body 160 may include a lid 168 abutting the upper edges of the upright sidewalls and that can be detached and removed for introducing liquid ingredients by pouring. The quadrilateral shape of the quadrilateral or prismatic shape of the storage body 160 corresponds to the quadrilateral mounting opening 152 so that the storage device 112 can be received in the top panel 148 while creating minimal gaps or spaces.

The dispensing valve mechanism 164 is located at the bottom of the connecting body 162 and can be configured to selectively open and close to dispense liquid ingredients from the internal volume 166. In accordance with the valve functionality, when opened the dispensing valve mechanism 164 permits fluid flow from the internal volume and when closed blocks and prevents fluid flow. The dispensing valve mechanism 164 can connect to the connecting body by a detachable connection that enables detachment and removal of the dispensing valve mechanism for more thorough and cleaner cleaning. At the same time, the dispensing valve mechanism 164 can be cleaned separately, ensuring more thorough and effective cleaning, achieving comprehensive and effective cleaning, and making the cleaning process more convenient.

The storage device 112 may have multiple configurations and embodiments that enable disassembly and cleaning. In a first embodiment, the storage body 160 and the connecting body 162 are integrally formed and the connecting body 162 and the dispensing valve mechanism 164 can be detachably connected. For example, a dispensing port can be located at the bottom of the connecting body 162, and the dispensing valve mechanism 164 is arranged at the bottom of the connecting body 162. The dispensing valve mechanism 164 and connecting body 162 can be separated, and the dispensing port defined by the connecting body 162 allows cleaning of the interior volume 166 of the storage body 160 and the connecting body, and the dispensing valve mechanism 164 can be cleaned separately.

In a second embodiment, the storage body 160 and connecting body 162 can be detachably connected, and the connecting body 162 and dispensing valve mechanism 164 are integrally formed. The dispensing port is located at the bottom of the storage body 160, and the dispensing valve mechanism 164 is arranged at the bottom of the connecting body 162. The storage body 160 and connecting body 162 can be separated, allowing cleaning of the interior volume 166 of the storage body 160, and the storage body 160 and dispensing valve mechanism 164 can also be cleaned separately.

In a third embodiment, the storage body 160 and connecting body 162 can be detachably connected, and the connecting body 162 and dispensing valve mechanism 164 can be detachably connected. The storage body 160 and connecting body 162, as well as the connecting body 162 and dispensing valve mechanism 164, are all detachable, allowing for separate cleaning of the storage body, connecting body, and dispensing valve mechanism, which enables a more comprehensive and effective cleaning, better cleaning results, and is easier to clean, reducing the possibility of sanitary blind spots and further simplifying the cleaning process.

The connecting body 162 functions to channel and guide the liquid ingredients from the internal volume 166 defined by the storage body 160 to the dispensing valve mechanism 164. The connecting body 162 functions as fluid fitting connecting the tank-like storage body 160 and the dispensing valve mechanism 164. To fluidly guide the liquid ingredients, the connecting body 162 is operatively associated with a first dispensing port 170 at the interface with the floor of the storage body 160 that is in fluid communication with the internal volume 166 and a second dispensing port 172 at the interface with the dispensing valve mechanism 164. The connecting body 162 defines a liquid guide channel 174 such as a lumen or bore that extends between and fluidly connects the first and second dispensing ports 170, 172. The liquid guide channel 174 may be a tubular channel such that the first and second dispensing ports 170, 172 are axially aligned at opposite ends of the liquid guide channel 174. Axial alignment of the first and second dispensing ports 170, 172 and the liquid guide channel 174 in the vertical direction 110 enables unobstructed flow of the liquid ingredients out of the storage device 112.

The dispensing valve mechanism 164 is associated with the second dispensing port 172. The liquid ingredients in the storage body 160 flows successively through the first dispensing port 170 and the liquid guide channel 174. When the dispensing valve mechanism 164 opens the second dispensing port 172, the ingredients can flow out of the connecting body 162 through the second dispensing port 172. When the dispensing valve mechanism 164 closes the second dispensing port 172, the liquid cannot flow into the second dispensing port 172 and is confined to the liquid guide channel 174.

Preferably, the top of the connecting body 162 is provided with an inlet port adapted to the first dispensing port 170 and the diameters of the first dispensing port 170 and the inlet port are both 50-120 mm. More preferably, the diameters of the first dispensing port 170 and the inlet port are both 60-110 mm. More preferably, the diameters of the first dispensing port 170 and the inlet port are both 70-100 mm. More preferably, the diameters of the first dispensing port 170 and the inlet port are both 80-90 mm. The size of the first dispensing port 170 and inlet port, in addition to ensuring that the first dispensing port 170 and inlet port match and allow effective connection between the storage body 160 and the connecting body 162, also facilitates cleaning by users, allowing them to use cleaning tools or their hands to clean the inside of the storage body and connecting body.

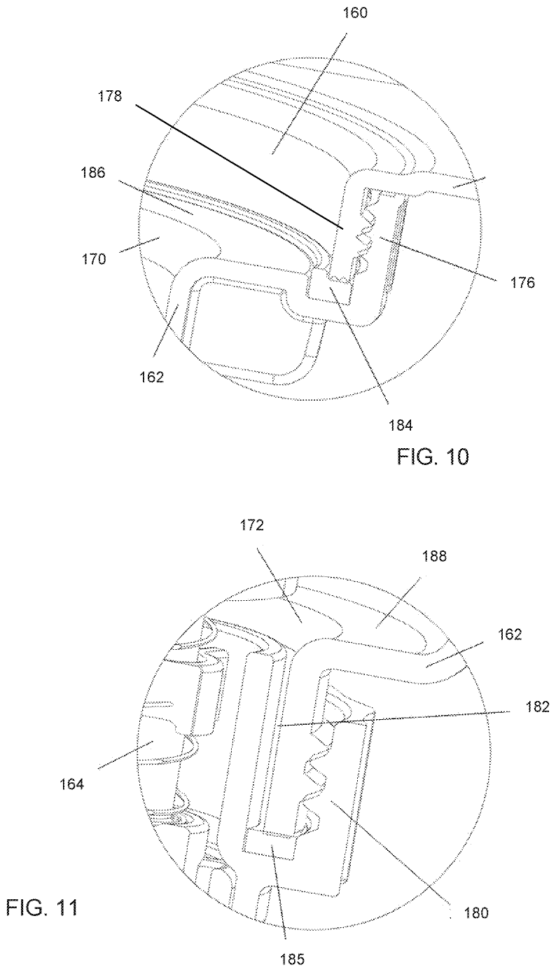

Referring to FIGS. 10 and 11, to detachably attach the connecting body 162 with the storage body 160 and the dispensing valve mechanism 164, the storage device 112 may utilize threaded connections. For example, one end of the connecting body 162 that includes the first dispensing port 170 is formed as a threaded collar 176. The threaded collar 176 may be circular in shape and may define an internal screw thread. To fasten with the threaded collar 176, the storage body 160 can include a threaded neck 176 that is located at the center of the floor and which extends downwardly from the center. The threaded neck 178 is cylindrical and can include an external thread that mates with the internal thread of the threaded collar 176. The threaded collar 176 and the threaded neck 176 have corresponding diameters and thread gauges.

To detachably attach the dispensing valve mechanism 164 with the connecting body 162, the dispensing valve mechanism 164 can be associated with a threaded collar 180 that is cylindrical in shape and that defines an internal screw thread. To fasten with the threaded collar 180, the end of the connecting body 162 associated with the second dispensing port 172 can be formed as a threaded neck 182 that is cylindrical and can include an external thread that mates with the internal thread of the threaded collar 180. The threaded collar 180 and the threaded neck 182 have corresponding diameters and thread gauges.

To fluidly seal the threaded connections between the components, the threaded collar 176 associated with first dispensing port 170 at the end of the connecting body 162 may be associated with a sealing gasket 184 such as an o-ring. The sealing gasket 184 can be an annular or ring-shaped structure made of elastomeric or resiliently compressible material. The first sealing gasket 184 can be accommodated in an annular sealing groove disposed circumferentially inside of the threaded collar 176. When the threaded collar 176 and the threaded neck 178 are fastened, the threaded neck abuts against and compresses the first sealing gasket 184 ensuring a leak tight connection and preventing leakage of liquid ingredients from the storage body 160.

To fluidly seal the connection between the connecting body 162 and the dispensing valve mechanism 164, the threaded collar 180 dispensing valve mechanism 164 can be configured to retain a second sealing gasket 185 such as an o-ring. The second sealing gasket 185 can be retained in an annular sealing groove disposed circumferentially inside of the threaded collar 180. When the threaded collar 180 is fastened to the threaded neck 182 on the connecting body 162, the threaded collar 180 abuts against and compresses the second sealing gasket 185 ensuring a leak tight connection and preventing leakage of liquid ingredients between the connecting body 162 and the dispensing valve mechanism 164.

To assist guiding the liquid ingredients through the liquid guide channel 174, the first dispensing port 170 and the second dispensing port 172 are associated with guide or drainage surfaces that function to guide and direct liquid flow. For example, the upper end of the connecting body 162 associated with first dispensing port 170 can be associated with an annular drainage surface 186 that extends radially around the first dispensing port 170 and that may be inclined or slopped centrally toward the liquid guide channel 174. The second dispensing port 172 located at the lower end of the connecting body 162 can include another annular drainage surface 188 that extends radially inward toward the threaded neck 182 that mates with the dispensing valve mechanism 164.

The arrangement and geometric surfaces function to guide the liquid ingredients, changing the direction of the fluid flow. As raw material on the annular drainage surface 186 flows into the liquid guide channel 174 by being guided and diverted by the annular drainage surface 186, ingredients on the second annular drainage surface 188 flows into the second dispensing port 172 by being guided and diverted by second annular drainage surface 188 toward the dispensing valve mechanism 164. The arrangement of the curved guide surfaces and drainages enables ingredients to automatically and rapidly flow from the storage body 160 into the second dispensing port 172.

The dispensing valve mechanism 164 controls the flow of liquid ingredients from the storage device 112 to the liquid holding tray 134 associated with the ice-making region 128 of the refrigeration machine 100. To prevent unintentional flow of the liquid when the ice-making region 128 is not properly configured, the dispensing valve mechanism 164 can be configured to automatically open and close in response to installation of the liquid holding tray 134. For example, the liquid holding tray 134 can be configured with a trigger or structure that automatically opens and/or closes the dispensing valve mechanism 164.

When the storage device 112 and liquid holding tray 134 are both installed, the trigger device or structure located on the dispensing tray 134 contacts the automatic dispensing valve mechanism 164. The dispensing valve mechanism 164 may be configured as a poppet valve or plunger valve with valve plug that can abut against a valve seat that has a valve port or liquid outlet orifice disposed though it. When the trigger pushes the self-actuating automatic dispensing valve mechanism 164 attached to the storage device 112, the contract displaces the valve plug and valve seat to open the second dispensing port 172. The liquid in the storage device 112 flows into the liquid holding tray 134, enabling automatic liquid supply to the tray without manual activation, reducing labor intensity, eliminating the need for a pump, and lowering costs. Furthermore, both the storage device 112 and the liquid holding tray 134 detachably mounted, allowing the refrigeration machine 100 to occupy a smaller area, have a simple and compact structure, and reduce the potential for liquid leakage

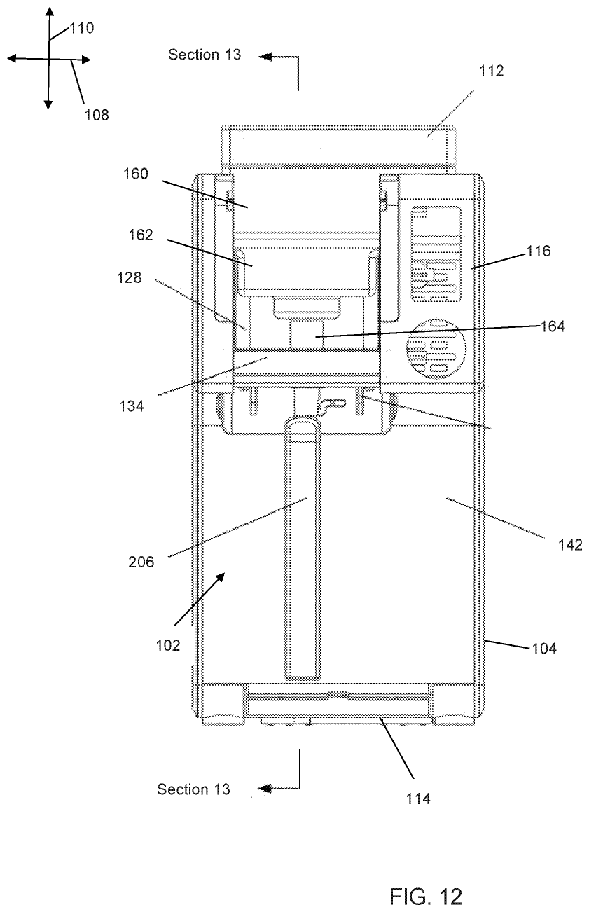

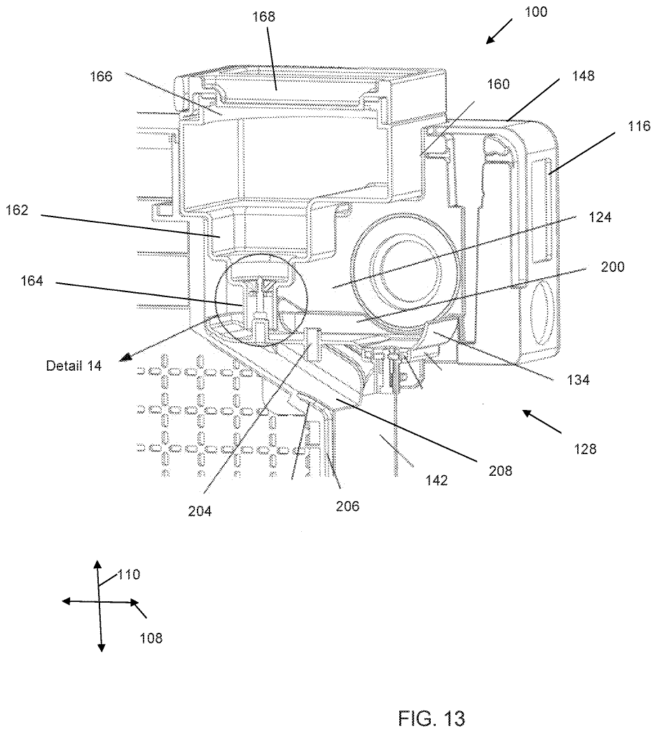

Referring to FIGS. 12 and 13, in an embodiment, when the storage device 112 is mounted in the mounting opening 152 of the top panel 148, the connecting body 162 and the dispensing valve mechanism 164 extend downward in the vertical direction 110 and are located in the cabinet interior 124 defined by the housing cabinet 104. The connecting body 162 and the dispensing valve mechanism 164 may be located rearward in the longitudinal direction 106 from the evaporator drum 120 and the ice-forming region 128. The liquid holding tray 134 is located vertically underneath both the storage device 112 and the evaporator drum 120 and can collect and form a pool of the liquid ingredients extending from the dispensing valve mechanism 164 to the ice-making region 128. The lower liquid holding tray 134 serves as a bath containing the liquid ingredients into which the lower periphery or circumferential segment of the evaporator drum 120 is submerged. Accordingly, when the dispensing valve mechanism 164 is automatically opened upon installation of the liquid holding tray 134, the liquid ingredients collect therein and are directly longitudinally forward from the storage device 112 toward the ice-making region 128.

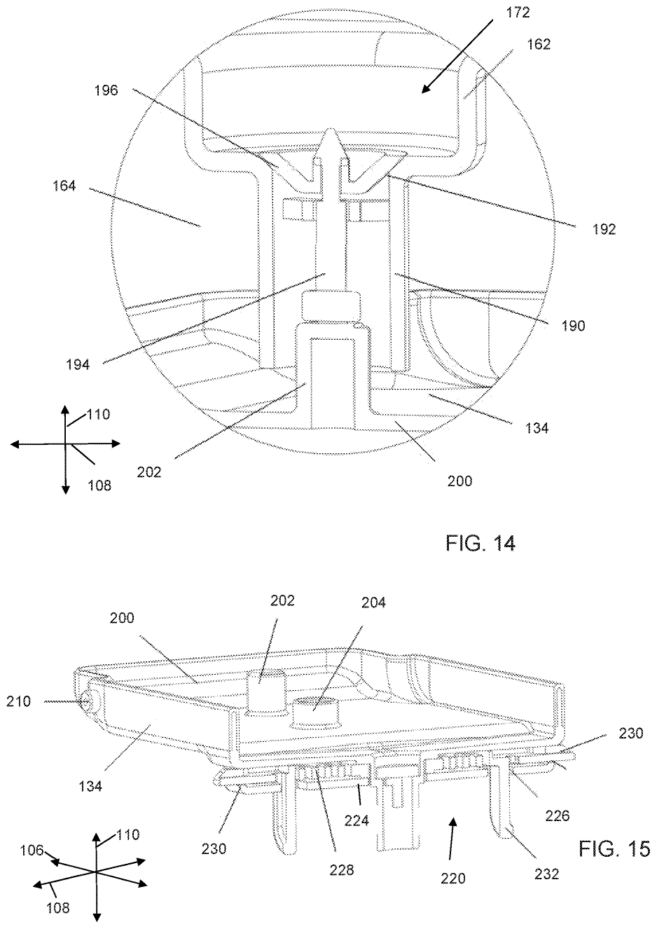

Referring to FIGS. 13 and 14, the dispensing valve mechanism 164 that descends vertically downward from the connecting body 162 of the storage device 112 can include a dispensing tube 190. The dispensing tube 190 is a cylindrical hollow tube defining a lumen that is in fluid communication with the internal volume 166 of the storage body 160. The dispensing tube 190 housing the internal components of the automatically operative dispensing valve mechanism 164 and serves to direct the liquid flow outwardly from the storage body 160 to the liquid holding tray 134 below. The upper end of the dispensing tube 190 which is integrally joined to the connecting body 162 is associated with a valve seat 192. The valve seat 192 may be an annular surface that encircles and defines a dispensing port or liquid outlet orifice through which liquids can flow.

The automatically operative components of the dispensing valve mechanism 164 can include a valve rod 194 that is concentrically located with the dispensing tube 190 and that can move up and down in the vertical direction 110. The valve rod 194 can be a slender cylindrical rod that is substantially smaller in diameter than the dispensing tube 190 in which it is concentrically disposed. Attached at the upper end of the valve rod 194 is a valve plug 196. The valve plug 196 may have a conical or frustoconical shape and may correspond in diametrical size to the valve seat 192. The valve plug 196 is made from an elastic material, such as rubber or silicone. When the dispensing valve mechanism 164 is assembled, the valve plug 196 abuts the edge of the valve seat 192, and, under hydraulic action, presses tightly against the valve seat 192 to seal it, preventing liquid from exiting the dispensing valve mechanism 164. As a result, when the storage device 112 is filled with liquid, no liquid flows out through the dispensing valve mechanism 164.

As shown in FIGS. 13 and 15, to receive and contain the liquid dispensed from the dispensing valve mechanism 164, the liquid holding tray 134 may define tray bed 200 that is a flat surface surrounded by upward edges to that provide a barrier retaining the liquid ingredients. To actuate the dispensing valve mechanism 164, the dispensing tray 134 can include a valve trigger 202 that may be formed as a rod or post that extends upright in the vertical direction 110 from the tray bed 200. The valve trigger 202 located inside the tray bed 200 may be located below the valve rod 194. When the valve trigger 202 contacts the valve rod 194, it may displace the valve plug 196 from the valve seat 192 and thereby open the dispensing tube 190. When the storage device 112 and the liquid holding tray 134 are installed, the valve trigger 202 abuts the valve rod 190, pushing the valve rod 194 upward, which moves the valve plug 196 upward, separating it from the valve seat 192 and opening the valve rod 194; liquid from the storage device 112 flows into the into the dispensing tube 190 and to the liquid holding tray 134.

To prevent the liquid ingredients from overflowing the tray bed 200, the liquid holding tray 134 includes an overflow port 204. The overflow port 204 can be structurally configured as overflow pipe located inside the tray bed 200. The upper rim of the pipe forming the structure of the overflow port 204 is in fluid communication with the tray bed 200 and is lower in elevation than the peripheral edge of the upward sidewalls of the liquid holding tray 134 defining the tray bed 200. The overflow port 204 is positioned through the bottom wall of the liquid holding tray 134, specifically at the bottom of the tray bed 200. When the liquid level inside the tray bed 200 reaches the top of the overflow port 204, liquid spills over and flows into the overflow port 204, from where it is discharged out of the tray bed 200. At the same time, to prevent liquid from spilling over the peripheral sidewalls of the liquid holding tray 134, the height of the top end of the overflow port 204 must be lower than the height of the peripheral sidewall, so that the liquid level is always kept below the upright sidewalls of the liquid holding tray 134. Thus, the arrangement of the overflow port 204 prevents excess liquid in the liquid holding tray 134 from spilling over the upright sidewalls, concentrates the collected liquid, avoids contamination, and reduces cleaning efforts.

The overflow port 204 can operate in cooperation with a diversion trough 206 located on the front face 142 of the housing cabinet 104 to direct overflowing liquid ingredients away and prevent the overflow port 204 from becoming contaminated. For example, referring to FIGS. 12 and 13, the diversion trough 206 may be located in the vertical direction 110 underneath the overflow port 204 and below the liquid holding tray 134. In an embodiment, the housing cabinet 104 may include an inclined plate 208 that is slanted underneath the liquid holding tray 134 longitudinally toward the ice-making region 128. The diversion trough 206 can be formed as a groove disposed into the inclined plate 208 and fluidly continues vertically downward along the front panel 142. Referring to FIG. 12, the diversion trough 206 can extend vertically downward to the drip tray 114 at the base of the housing cabinet 104. When liquid ingredients overflow the liquid holding tray 134 and into the overflow port 204, the liquids will fall under gravity to the inclined plate 208 and into the diversion trough 206 disposed vertically in the front panel 142 to be guided to the drip tray 114.

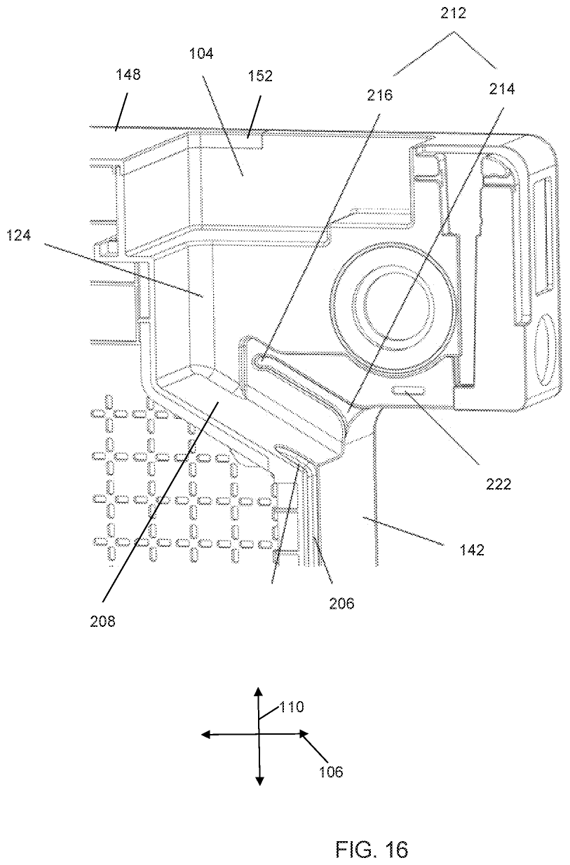

Referring to FIG. 16, the cabinet interior 124 defined by the housing cabinet 104 includes a plurality of integral walls and surfaces that are arranged to complement the shape of the storage device 112. When the storage device 112 is received into the mounting opening 152 of the top panel 148, the interior surfaces and walls align the dispensing valve mechanism 164 connected to the connecting body 162 with the valve trigger 202 located in the tray bed 200 of the liquid holding tray 134. The valve trigger 202 can contact the valve rod 194 of the dispensing valve mechanism 164 to displace the valve plug 196 from the second dispensing port 172. Thus, inserting the storage device 112 into the cabinet interior 124 causes the valve trigger 202 to actuated the dispensing valve mechanism 164, thereby automatically opening the second dispensing port 172 and delivering liquid from the storage body 160 into the liquid holding tray 134; the structure is simple, and the operation is convenient.

To install the liquid holding tray 134 in alignment with the valve mechanism 164 on the storage device 112, a pin-and-slot joint may be incorporated with the refrigeration machine 100. For example, referring to FIG. 15, the liquid holding tray 134 can include one or more guide pins 210 that protrude outwardly in the lateral direction 108 from the upright sidewalls defining the tray bed 200. In an embodiment, at least two guide pins 210 can protrude laterally from either lateral side of the liquid holding tray 134. The guide pins 210 can be rounded or cylindrical knobs of a small diameter and circular exterior.

Referring to FIG. 16, to receive the guide pins 210, a corresponding number of guide slots 212 can be disposed into interior surfaces of the housing cabinet 104 and are exposed to the cabinet interior 124. For example, the guide slots 212 may be located at the opposing laterals side of the ice-making region 128. The guide slots 212 may be formed as elongated grooves disposed into the interior surfaces of the housing cabinet 104 and can have a width corresponding to the diameter of the guide pins 210 so that the guide pins can be inserted into and slide within the guide slots.

In an embodiment, the guide slots 212 can be disposed at an inclined angle relative to the longitudinal direction 106 and may be parallel to the inclined plate 208 located in the cabinet interior 124. For example, the guide slots 212 may comprise an entrance end 214 and a positioning end 216. The positioning end 216 is vertically higher than the entrance end 214 relative to the vertical direction 110. The guide pin 210 can enter the entrance end 214 during installation and moves through the guide slot 212 upwardly toward the positioning end 216 located longitudinally rearward in the cabinet interior 124 of the ice-making region 128. The positioning end 216 is arranged horizontally, ensuring that the guide pin 210 placed within the guide slot 212 is effectively supported. The configuration of the pin-and-slot joint facilitates the installation of the rear end of the liquid holding tray 134 toward the rear of the ice-making region 128, ensuring that the bottom of the evaporator drum is placed within the tray bed 200 such that the liquid in the tray bed 200 can submerge the bottom circumferential segment of the evaporator drum, enabling the evaporator drum to contact the liquid in the liquid holding tray 134.

During installation of the liquid holding tray 134, the inclined plate 208 may assist in guiding the liquid holding tray 134 into position underneath the dispensing valve mechanism 164 of the storage device 112. The liquid holding tray 134 can be obliquely inserted into the cabinet interior 124 along the inclined plate 208. The inclined plate 208 may guide and direct the guide pins 210 to enter the entrance ends 214 of the guide slots 212 and to move upwardly toward the positioning ends 216 at an oblique angle with respect to the vertical direction 110. The guiding function of the inclined plate 208 makes the insertion path of the liquid holding tray 134 more defined, avoiding positional deviation during installation and ensuring smooth insertion of the liquid holding tray 134 into the cabinet interior 124, significantly improving installation convenience. At the same time, this inclined insertion method does not affect the detachable characteristic of the liquid holding tray 134 and it can still be easily removed along the inclined plate 208 when cleaning is required, balancing both ease of installation and convenience for subsequent cleaning. Additionally, the inclined plate 208 effectively enlarges the insertion opening of the cabinet interior 124 making the liquid holding tray 134 easier to insert and remove.

To detachably support the liquid holding tray 134 into location after installation into the cabinet interior 124, the liquid holding tray 134 can be equipped with a release mechanism 220. The release mechanism 220 is adapted to temporarily secure the liquid holding tray with respect to a corresponding feature disposed on the interior surfaces of the housing cabinet 104 that are exposed to the cabinet interior 124. For example, one or more securing slots 222 can be disposed into the interior surfaces of the housing cabinet 104 at the opposing lateral sides of the ice-making region 128. The securing slots 222 can have a flat oval outline and can be oriented in the lateral direction 108. The securing slots 222 can be located longitudinally forward of the guide slots 212 proximate to the front panel 142 and may be disposed below the location of the evaporator drum.

The release mechanism 220 attached to the liquid holding tray 134 can be a spring-loaded device that is adapted to engage the securing slots 222 located in the cabinet interior 124. The release mechanism 220 includes a spring or similar biasing element that can be elastically deformed and recover its original shape. The spring-loaded release mechanism 220 causes extension and retraction of one or more structures like prongs or tabs with respect to the tray bed 200 to engage with or release from the securing slots 222. In the example where the securing slots 222 are disposed in the lateral direction 108, the spring-loaded release mechanism 220 likewise applies a biasing force to move securing tabs in the lateral direction 108 with respect to the sidewalls of the housing liner assembly 130.

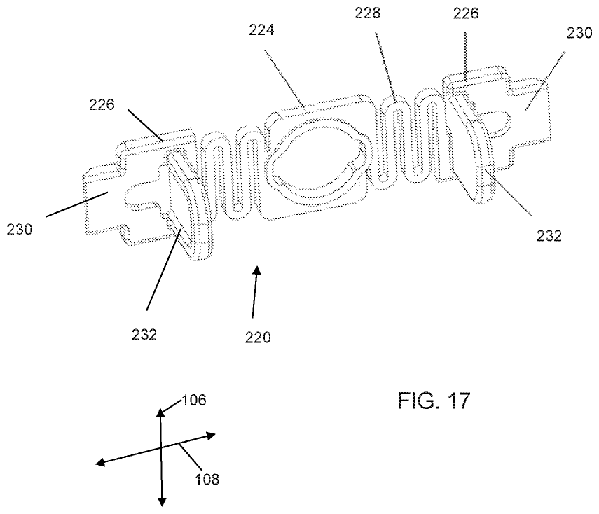

To selectively engage with the securing slots 222, referring to FIG. 17, the release mechanism 220 in an embodiment includes a fixed part 224 and at least one movable part 226, with the fixed part 224 being fixed relative to the liquid holding tray 134; the movable part 226 consists of a telescopic sub-portion 228 and a securing tab 230 that corresponds to the securing slots 222. The fixed part 224, telescoping section 228, and securing tab 230 connected laterally together in sequence. In the illustrated example, the fixed part 224, moveable part 226 and telescoping portion 228 are integrally formed, for example, molded plastic, but in other examples the structures may be distinctly formed and separable. The securing tab 230 is extendable and retractable in the lateral direction 108 via the telescoping section 228 to connect or disconnect from the housing cabinet 104.

Preferably, the telescopic sub-portion 228 is made from an elastic material. In an embodiment, the telescopic sub-portion 228 may be an elastic spring having a serpentine shape that can expand and contract with respect to the lateral direction 108. In other embodiments, the telescoping section 228 may be a helical coil spring or a resilient material like rubber or an elastomer. One end of the telescoping section 228 is fixed to the liquid holding tray 134 via the fixed part 224, while the other end connects to the securing tab 230; the securing tab 230 is driven by the laterally extendable and retractable telescoping motion of the telescopic sub-portion 228, allowing securing tab 230 to insert into or withdraw from the securing slot 222, thereby connecting or disconnecting the liquid holding tray 134 to the housing cabinet 104. When the liquid holding tray 134 is separated from the housing cabinet 104, the liquid holding tray 134 can be directly removed from the ice-making region 128.

Preferably, to actuate the release mechanism 220, the movable part 226 further includes a finger tab 232. The finger tab 232 is located laterally outward from the telescopic sub-portion 228 and is perpendicular to the fixed part 224 and with respect to the securing tab 230. The finger tab 232 enables a user to press the moveable part 226 laterally, thereby compressing the telescopic sub-portion 228 and disengaging the securing tab 230 from the securing slot 222. When the finger tab 232 is released, the telescopic sub-portion 228 returns to its original shape, resetting the securing tab 230, which can then be re-inserted into the securing slot 222 thereby fixing the liquid holding tray 134 to the housing cabinet 104 again.

Preferably, there are at least two movable parts 226, symmetrically positioned on opposite lateral sides of the fixed part 224. The two moveable parts 226 each include lateral extendable and retractable securing tabs 230 that can be received into the respective securing slots 222 when extend and removed from the securing slots 222 when retracted by moving the finger tabs 232 together in the lateral direction 108. Thus, the liquid holding tray 134 is connected to the housing cabinet 104 at four points, ensuring a reliable and stable connection.

Preferably, the securing tabs 230 may be located vertically bellow the positioning ends of the 226 of the guide slots 212 as shown in FIG. 16. The liquid holding tray 134 will therefore be arranged at an inclined or oblique angle with respect to the longitudinal direction 106. The inclined orientation of the liquid holding tray 134 causes the liquid ingredients to flow toward the longitudinal front of the tray bed 200 vertically below the evaporator drum. The sloped angle of the liquid holding tray 134 optimizes interaction between the liquid ingredients and the evaporator drum and reduces residuals in the tray bed 200.

The liquid holding tray 134 is therefore readily detachable from the housing cabinet 104 by operation of the release mechanism 220. The detachable connection design allows the liquid holding tray 134 to be removed independently from the housing cabinet 104. When there is residual liquid or stains inside the liquid holding tray 134, it can be removed for thorough cleaning. This ensures effective cleaning of the bottom of the tray bed 200 and its connecting part with the housing cabinet 104, avoiding stain accumulation and odor generation due to the non-detachable nature of the liquid holding tray 134, and maintaining the sanitation of the refrigeration machine 100.

### Housing Liner Assembly

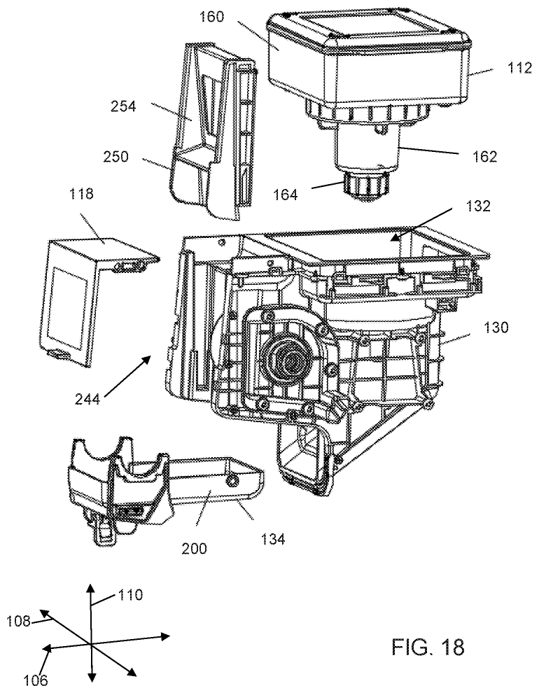

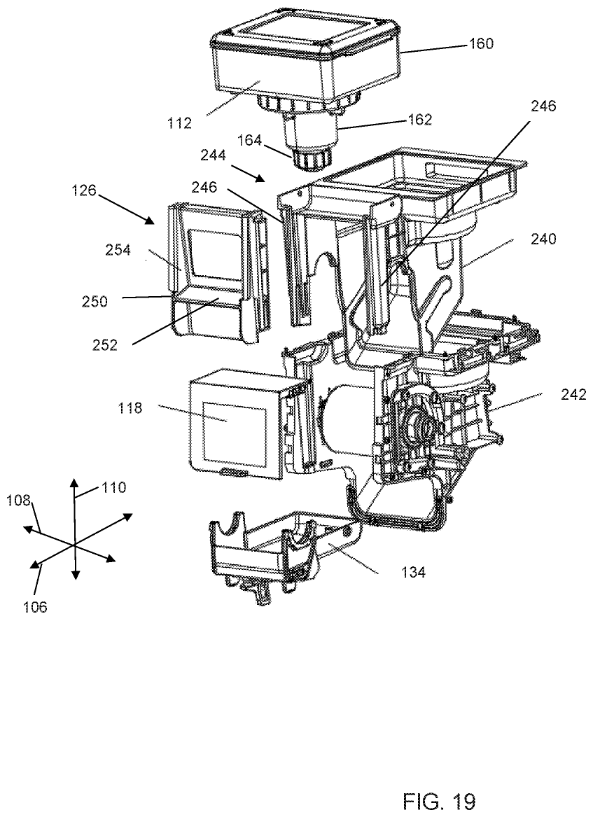

Referring to FIGS. 18 and 19, in the embodiments where the refrigeration machine 100 includes housing liner assembly 130 to facilitate the flow of the liquid ingredients through the cabinet interior 124, the housing liner assembly 130 can be structurally adapted for making detachable connections with the various components and parts of the refrigeration machine 100. The detachable connections enable partial or complete disassembly to improve cleaning and sanitation. For example, referring to FIG. 18, the liquid ingredient storage device 112, the blade assembly 126, and the liquid holding tray 134 are all adapted to be detachably connected to the housing liner assembly 130.

By designing the blade assembly 126, storage device 112, and liquid holding tray 134 to be detachably connected to the housing liner assembly 130, each device can be independently detached from the housing liner assembly 130, thereby solving the problem of difficulty in cleaning the scraper blade, storage tank, and tray bed in existing cold drink machines due to their non-detachable nature. When cleaning is required, the blade assembly 126, the storage device 112, and the liquid holding tray 134 can be detached separately, so that the scraper blade of the blade assembly 126 and the inner wall and the corner of the tray bed and the bottom and the liquid holding tray 134 can be thoroughly cleaned, whereby residual slush fragments, fruit-fiber pieces, limescale, mold and other impurities can be effectively removed, hard-to-reach cleaning areas are avoided, the hygienic safety of the apparatus is ensured, and the cleaning efficiency and effect are improved.

In an embodiment, the housing liner assembly 130 is comprised of a plurality of liner shells that can be assembled together in a stackable configuration. The assembly of the liner shells into the housing liner assembly 130 enables further disassembly further enhancing the flexibility of the structural detachment and cleaning. Referring to FIG. 19, the housing liner assembly 130 can be comprised of a first or inner shell 240 and a second outer shell 242. The second outer shell 242 can be detachably arranged within the cabinet interior 124 and can make sliding contact with the interior surface of the housing cabinet 104 or can be integrally set with other parts of the apparatus housing, providing a more stable installation base for the entire holding assembly. Alternatively, the outer shell 242 can be structurally fixed within cabinet interior 124 defined by the housing cabinet 104. The inner shell 240 is detachable inserted into the outer shell 242 by sliding the structures together to assembly the housing liner assembly 130. The inner shell 240 defines the liquid passageway 132 directing the liquid ingredients between the storage device 112 and the liquid holding tray 134.

The inner shell 240 also serves as a mounting carrier for the parts of the refrigeration devices and also forms a detachable connections the parts, further enhancing the flexibility of disassembly. In addition to the detachable connection between the blade assembly 126 and the first inner shell 240, a detachable connection is also formed between the inner shell 240 and the housing cabinet 104, resulting in a double detachable structure. Compared to the fixed connections in the prior art, this structure allows the blade assembly 126 and the inner shell 240 to be detached together from the housing cabinet 104, making it easier to clean the blade assembly 126 and independently and to clean the inner shell 240. This avoids the accumulation of impurities in the connections area between the parts, enhancing the overall cleanliness of the apparatus.

In one embodiment, the liquid ingredient storage device 112 is detachably connected to the inner shell 240. Unlike the fixed connections in the prior art, this design allows the storage device 112 to be detached along with the inner shell 240 during cleaning. Both the storage device 112 and the inner shell 240 can be removed together, facilitating thorough cleaning of the installation area of the storage device 112 on the inner shell 240 and the connecting part between the apparatus and the inner shell 240, effectively preventing the growth of residues in multiple areas.

In one embodiment, the liquid holding tray 134 is detachably connected to the inner shell 240. Differing from the fixed connection structure in the prior art, this design allows the cleaning of the liquid holding tray 134 to be combined with the detachment of the inner shell 240. It not only facilitates the independent cleaning of the liquid holding tray 134, but also allows for the cleaning of its connection parts with the liquid holding tray 134 and the connecting part between the apparatus and the inner shell 240 after detachment. This avoids residue accumulation at multiple locations, ensuring the overall sanitation of the apparatus.

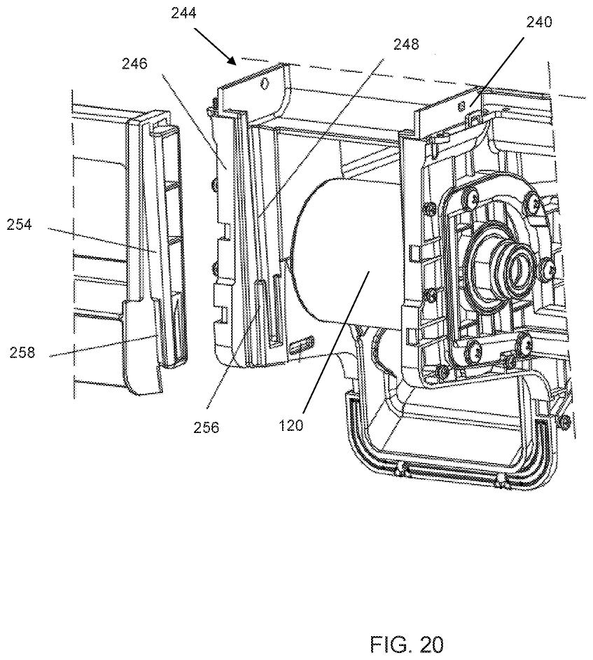

Referring to FIG. 20, to form a detachable connection with the blade assembly 126, the inner shell 240 is provided with a blade insert frame 244 which provides a dedicated positioning structure for the installation of the blade assembly 126, making the installation of the blade assembly 126 more targeted and stable. For example, the longitudinally forward end of the inner shell 240 can include two parallel frame legs 246 that are aligned in the vertical direction 110. The parallel frame legs 246 are laterally spaced apart from each other in the lateral direction 108 sufficiently to accommodate the blade assembly 126 between themselves. Disposed in each of the parallel frame legs 246 and extending the vertical direction 110 can be an insert slot 248.

Referring to FIG. 18-20, to attach the blade assembly 126 with the blade insert frame 244, the blade assembly 126 includes a blade holder 250 which accommodates the metal scrapping blade 252. The metal scrapping blade 252 can be stainless steel and the blade holder 250 may be made from plastic or the like. The blade holder 250 can be a flat or planar structure and forms a frame or outline in which the metal blade 252 is secured and held. The plastic blade holder 250 and metal scrapping blade 252 are integrally secured to avoid direct handling of the sharp scrapping blade 252 when installing and detaching the blade assembly 126. For example, the blade holder 250 can define a central window or aperture in which the scrapping blade 252 is exposed and aligned in the lateral direction 108. The scrapping blade 252 extends laterally and is angled or tilted in the longitudinal direction 106 to make contact with the evaporator drum when installed.

To cooperate with the blade insert frame 244, the blade holder 250 can include two corresponding insertable flanges 254 that are parallel and aligned in the vertical direction 110. The insertable flanges 254 correspond in shape and geometry with the insert slots 248 and both may have commensurate heights in the vertical direction 110. During installation, the insertable flanges 254 can be inserted into the insert slots 248 disposed toward the opposite lateral sides of the blade insert frame 244. For example, the blade holder 250 can be inserted vertically downwardly with respect to the blade insert frame 244 so that the insertable flanges 254 are received in the insert slots 248 and slide vertically downward. This installation method is convenient to operate and requires no additional tools. It ensures the stability of the blade assembly 126 after installation and allows for easy removal of the blade holder 250 from the inner shell 240 when cleaning is needed, facilitating the rapid disassembly of the blade assembly 126.

In an embodiment, the blade insert frame 244 and the blade holder 250 are configured to produce a wedge-lock attachment that securely fixes the blade assembly 126 with respect to the housing cabinet 104. The wedge-lock attachment is characterized by arranging the structures so that, during insertion of the blade holder 250 vertically into the blade insert frame 244, the blade insert frame 244 produces a compressive fit against the blade holder 250. The blade holder 250 becomes wedged with respect to the blade insert frame 244. The wedge-lock arrangement secures the blade assembly 126 against vibration from operation including scrapping contact between the scrapping blade 252 and the rotating evaporator drum 120. To remove the blade assembly 126 for periodic cleaning, a pulling force must be applied to the blade holder 250 in the vertical direction 110 to overcome the compressive forces associated with the wedge-lock arrangement.

In an example, the width of the insert slots 248 disposed in the parallel frame legs 246 of the blade insert frame 244 gradually narrows from top to bottom in the vertical direction 110 so that the insert slots 248 are tapered. When the insertable flanges 254 are inserted, as the insertion depth increases, the walls of the insert slots 248 applies a progressively stronger clamping effect on the insertable flanges 254. The tapered insert slots 248 thus form a wedge-lock connection compressively squeezing and holding the insertable flanges 254. This structural design ensures the smooth insertion of the blade holder 250 to the blade insert frame 244 while also improving the stability of the connection between the blade assembly 126 and the inner shell 240 through clamping force after the insertion is completed, preventing the blade holder 250 from shaking during the operation. At the same time, compared to fixed connections or detachable structures with no clamping effect, this design ensures reliable connection while allowing the blade assembly 126 to be easily extracted from the blade insert frame 244, without affecting the convenience of disassembling and cleaning, further balancing connection stability with disassembly flexibility.

Referring to FIGS. 19 and 20, in another example of the wedge-lock arrangement, the pair of frame legs 246 forming the blade insert frame 244 can be angularly inclined toward each other with respect to the vertical direction 110. The gap disposed between the frame legs 246 laterally tappers or narrows in the lateral direction 108. When the blade holder 250 is inserted vertically between the inclined frame legs 246, the blade insert frame 244 will apply an increasing compressive force in the lateral direction 108 on the blade assembly 126 to structurally hold it steady with respect to the housing cabinet 104.

Referring to FIG. 20, the side of the insert slot 248 is provided with a limiting rib 256, which protrudes from the side of the insert slot 248. The side of the insertable flanges 254 is provided with a limiting slot 258, the shape of which corresponds to the shape of the limiting rib 256. The limiting rib 256 can be inserted into the limiting slot 248. When the insertable flanges 254 are inserted into the insert slot 248, the limiting rib 256 can simultaneously insert into the limiting slot 258. Through the shape matching, the blade holder 250 can be horizontally limited, preventing any displacement or wobbling of the blade holder 250 in the longitudinal and lateral directions 106, 108. This structural design further enhances the stability of the blade holder 250 after installation, especially during operation, avoiding displacement deviations of the scraper blade caused by the rolling effect of the evaporating drum, thus affecting the working precision of the blade holder 250.

In an alternative embodiment, the wedge-lock arrangement between the blade assembly 126 and the housing liner assembly 130 may be arranged in a different direction than that described above. For example, the wedge-lock arrangement may be arranged along the longitudinal direction 106.

Still alternatively, the slots on the housing liner assembly 130 and the flanges on the blade assembly 126 may be interchanged. For example, the slots may be formed on the blade assembly 126, while the flanges may be formed on the blade assembly 126.

In a still alternative embodiment, the blade assembly 126 may be slidably attached to the housing cabinet 104 through other arrangements. For examples, the blade assembly 126 may be slid onto a stud or shaft that is disposed on the housing cabinet 104. The stud or shaft may be fixedly disposed on the housing cabinet 104 or attached to the housing cabinet through a pivotal joint. The stud or shaft may be pivoted towards or away from the housing cabinet 104 when the blade assembly 126 is installed or removed.

In still alternative embodiments, the blade assembly 126 may be mounted to the housing cabinet 104 through a buckle or clip structure. For example, the buckle or clip structure may include an elastic element that is engaged with a counterpart block when the blade assembly 126 is mounted to the housing cabinet 104. The blade assembly 126 may be detached from the housing cabinet 104 by disengaging the elastic element with the counterpart block.

Alternatively, the buckle or clip structure may include a clipping element that is engaged with a counterpart block or groove when the blade assembly 126 is mounted to the housing cabinet 104. The blade assembly 126 may be detached from the housing cabinet 104 by disengaging the clipping element from the counterpart block or groove.

Still alternatively, the blade assembly 126 may be mounted to the housing cabinet 104 through a magnetic structure. The magnetic structure may include a magnetic element disposed on the blade assembly 126 or the housing cabinet 104 that is configured to attach and hold the blade assembly 126 to the housing cabinet 104.

Still alternatively, the blade assembly 126 may be mounted to the housing cabinet 104 through a push-lock structure. When the push-lock structure is pressed or pull, the blade assembly 126 may be detached from the housing cabinet 104 by an elastic force or the gravitational force.

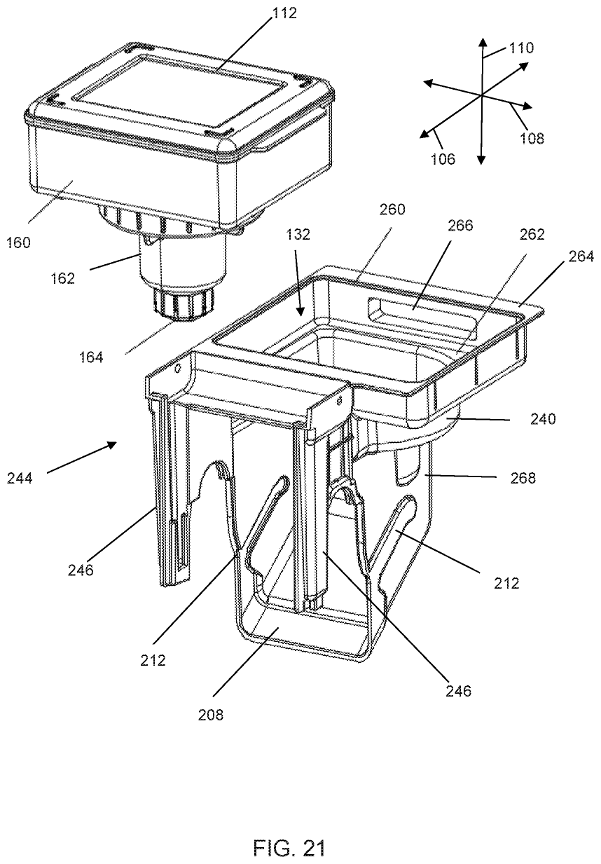

Referring to FIG. 21, to mount with the liquid ingredient storage device 112, the upper end of the inner liner 240 can define a structural recess 260 that corresponds to the entrance to the liquid passageway 132. The geometry and shape of the structural recess 260 correspond to the shape of the storage body 160 of the storage device 112. For example, if the storage body 160 is square or quadrilateral, the structural recess 260 is also square or quadrilateral. The storage device 112 can be detachably placed within the structural recess 260 and the corresponding geometries and shapes between the structural recess 260 and the storage body 160 located therein restrain movement of the storage device 112, preventing agitation and possibly leakage of the liquid ingredients therein.

When installing the storage device 112, it can be detachably placed into the structural recess 260, where the profile of the structural recess 260 helps position the storage body 160, and the structural recess 260 provides stable support to ensure that the storage device 112 does not easily wobble after being installed on the inner shell 240. During cleaning, the storage device 112 can be completely removed from the inner shell 240, making it easier to thoroughly clean the inner and outer walls of the storage device 112 as well as the interior of the structural recess 260. This effectively prevents the accumulation of residues at the connecting part, improving both the thoroughness and simplicity of the cleaning process.

The structural recess 260 is equipped with a support ledge 262 which protrudes from the inner wall of the structural recess 260 and provides more precise positioning support for placing the storage device 112. When the storage device 112 is placed into the structural recess 260, the bottom part of the storage body 160 can rest against the support ledge 262. The support ledge 262 supports the storage body 160 and prevents the storage device 112 from sinking too deeply into the liquid passageway 132, ensuring the accurate positioning of the liquid passageway 132 after installation. This structural design does not affect the detachable nature of the storage device 112. During removal, the storage device 112 can be easily taken out of the structural recess 260. The arrangement of the supporting ledge 262 further reduces the direct contact area between the bottom of the storage body 160 and the bottom of the structural recess 260, thereby lowering the likelihood of wear caused by friction between the two components, and facilitates cleaning of the area surrounding the supporting ledge 262.

To mate with the outer shell 242, the inner shell 240 can include an abutment flange 264 that is disposed partially about the peripheral rim of the structural recess 260. The abutment flange 264 may protrude perpendicularly outwardly from the upper structural walls defining the structural recess 260 and is perpendicular to the vertical direction 110. To assist in inserting and removing the inner shell 240 from the outer shell during assembly, the first shell 240 may also include a hand-grip hole 266 that is disposed into the structural walls that define the structural recess 260. With the help of the hand-grip hole 266, the user can easily lift the inner shell 240, providing a convenient force application point for disassembling the inner shell 240.

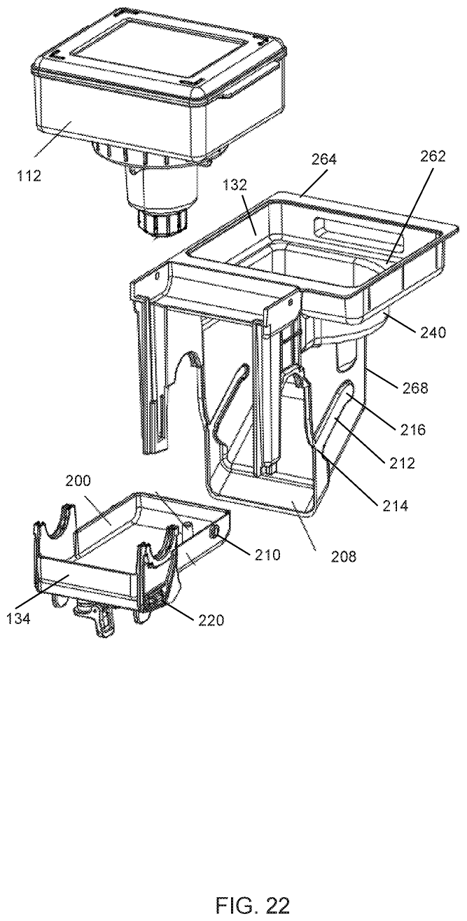

The bottom of the first shell 240 is provided with an insert portion 268 that extends downward from the structural recess 260 in the vertical direction 110. The insert portion 268 is formed as a plurality of integrally joined walls and surfaces that encompass and define the liquid passageway 132 in the vertical direction 110 downwardly from the structural recess 260. Referring to FIG. 22, in the embodiments of the refrigeration device 100 which include an inclined plate 208 to guide installation of the liquid holding tray 134, the inclined plate 208 may be integrally formed at the lowermost structure of the insert portion 268 at an oblique angle to the longitudinal direction 106. The guide slots 212 that are used to guide and secure the liquid holding tray 134 can also be formed as grooves disposed into the structural walls that define the insert portion 268 of the first shell 240. The inclined plate 208 and the guide slots 212 are fixedly situated parallel with each other at the oblique angle to the longitudinal direction 106 due to being commonly formed in the insert portion 268.

The liquid holding tray 134 that receives the liquid ingredients and melted slush during operation can be detachably connected to the insert portion 268 of the inner shell 240. The detachable connection between the liquid holding tray 134 and the inner shell 240 allows the liquid holding tray 134 to be removed as a whole. Compared with the situation in the prior art in which the liquid-receiving component is fixed inside the apparatus and is difficult to clean thoroughly, this design enables a user to perform comprehensive cleaning by removing the liquid holding tray 134, including internal corners and outer walls, and further enables convenient cleaning of residue inside the inner liner 240. This effectively prevents long-term accumulation of water stains that may cause bacterial growth and odor, thereby improving the hygiene level of the apparatus.

To install the liquid holding tray 134, the liquid holding tray 134 is moved longitudinal into the opening of liquid passageway 132 defined by the insert portion 268 of the inner shell 240. The guide pins 210 that protrude laterally from the opposite sides of the tray bed 200 can be aligned with the entrance ends 214 of the guide slots 212 that are formed into the inner surfaces of the inner shell 240 and accessible to the liquid passageway 132. Due to inclined angles of the guide slots 212 with respect to the longitudinal direction 106, pushing the liquid holding tray 134 rearwardly in the longitudinal direction 106 will cause the rear of the tray bed 200 to move vertically upward. The inclined plate 208 of the inner shell 240 assists in the guiding the liquid holding tray 134 into the liquid passageway 132. The oblique angle of the inclined plate 208 and guide slots 212 cooperate to smoothly guide installation of the liquid holding tray 134 into the inner shell 240 at an inclined or oblique angle relative to the longitudinal direction 106. The guide pins 210 can be received into the position ends 216 of the guide slots 212 which are aligned parallel to the longitudinal direction 106 and can support and retain the guide pins 210 against unintentional removal by utilizing gravity. The release mechanism 220 on the underside of the tray bed 200 can be utilized to fixedly secure the liquid holding tray 134 to the inner shell 240.

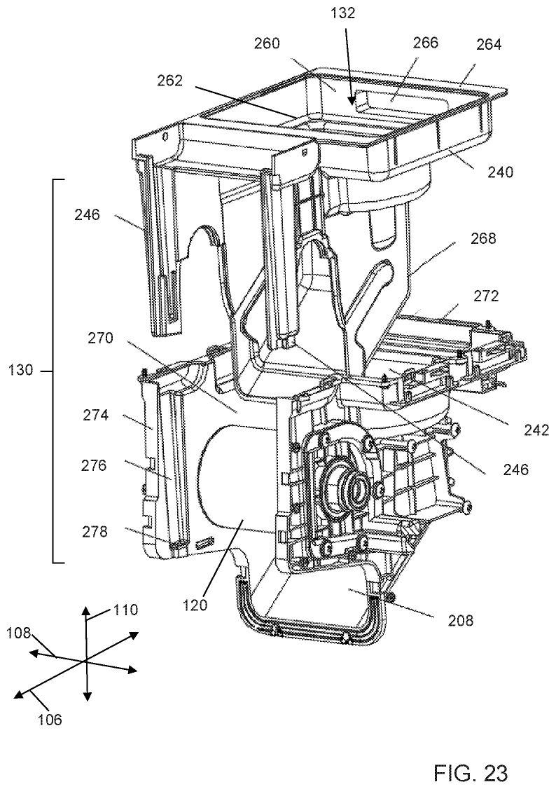

Referring to FIG. 23, to attach with the inner shell 240, the outer shell 242 defines and encompasses a fixing cavity 270 in which the inner shell 240 can be detachably inserted to adjacently overlay the inner surfaces of the outer shell 242. When the evaporator drum is installed, the inner shell 240 surrounds the periphery of the evaporator drum. When the evaporator drum rotates and freezes the liquid ingredient inside the housing liner assembly 130, the inner shell 240 forms a cover for the fixing cavity 270, ensuring that liquids ice-making region 128 associated with the evaporator drum chamber only splatter onto the inside of the inner shell 240 and not onto the outer shell 242. This design greatly simplifies the cleaning process of the apparatus. During cleaning, only the inner shell 240 needs to be removed and cleaned, and the outer shell 242 does not require complex cleaning. Whether the outer shell 242 is detachably set or integrally set with the apparatus does not affect the cleaning of the inner shell 240, ensuring the cleanliness of the apparatus and improving cleaning efficiency.

The upper edges of the outer shell 242 can include an abutment platform 272 that protrudes outwardly with respect to the fixing cavity 270 and perpendicular to the vertical direction 110. To assemble the housing liner assembly 130, the insert portion 268 of the inner shell 240 is placed into the fixing cavity 270 of the outer shell 242 and abutment flange 264 can abut against the abutment platform 272.

When the inner shell 240 is disposed in the outer shell 242, the insert portion 268 is located in the fixing cavity 270. At the same time, the abutting contact between the abutment flange 264 and the abutment platform 272 limits the insertion of the inner shell 240 in the vertical direction 110 and support the inner shell 240. The insert portion 268 and the fixing cavity 270 can correspond in geometric shape to align and positionally fixate the assembly of the housing liner assembly 130. For example, through the cooperation of the insert portion 268 and the abutment flange 264, and the fixing cavity 270 and the abutment platform 272, the inner shell 240 is fixed in both the upper and lower positions, effectively preventing it from shaking or shifting during the operation of the refrigeration machine 100. This ensures that the inner shell 240 covers the interior walls and surfaces of the fixing cavity 270, further ensuring that liquids only splatter onto the interiors of the inner shell 240 during the operation, facilitating subsequent cleaning of the housing liner assembly 130.

To further secure and fixate the connection between the assembly between the inner shell 240 and the outer shell 242, the front face of the outer shell 242 can include a mounting frame 274 that corresponds in location with the blade insert frame 244 of the inner shell 240. The mounting frame 274 can include two laterally opposed frame slots 276 that are parallel and spaced apart with respect to the lateral direction 108. The lateral spacing between the frame slots 276 is sized to fit the blade insert frame 244 and the widths of the frame slots 276 corresponds to the widths of the parallel frame legs 246. When the inner shell 240 is inserted in the vertical direction 110 into the outer shell 242, the blade insert frame 244 aligns with the mounting frame 274 and the parallel frame legs 246 are received into and slide with respect to the opposed frame slots 276.

Physical cooperation between the blade insert frame 244 and the mounting frame 274 also further fixes the blade holder 250 when installed on the front side of the inner first shell 240, enhancing the stability of the blade assembly 126, thereby improving the stability of the housing liner assembly 130. Compared with a structure that relies solely on the fixing cavity to position the inner shell, this design further improves the overall stability of the inner shell installation, ensuring stable material scraping during the operation of the apparatus.

In a further embodiment, the mounting frame 274 can include mounting holes 278 that are disposed at the bottom of the each of the opposed frame slots 276 and that are aligned in the vertical direction 110. When the blade insert frame 244 of the inner shell is inserted vertically into the mounting frame 274 of the outer shell 242, the lower distal ends of the parallel frame legs 246 can be vertically inserted and received into the mounting holes 278. Inserting and accommodating the distal ends of the parallel frame legs 246 into the mounting holes 278 further secures the structures against motion in response to vibrations arising from the ice-making process.

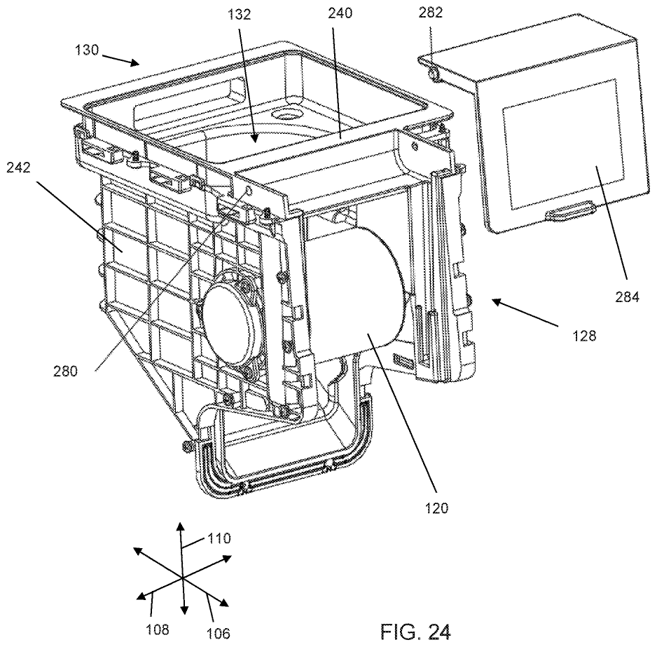

Referring to FIG. 24, to pivotally connect with the rotatable cover 118, the inner shell 240 can include a pair of pin holes 280 that are located toward the longitudinal front of the housing liner assembly 130 and vertically above the ice-making region 128. The pin holes 280 are laterally spaced apart from each other and are aligned in the lateral direction 108. To engage with the pin holes 280 of the inner shell 240, the rotatable cover 118 includes hinge pins 282. The hinge pins 282 also project in the lateral direction 108 and are sized to pivotally fit within the pin holes 280 allowing the rotatable cover 118 to rotate relative to the housing liner assembly 130. When cleaning or maintaining the blade holder and scraper blade, the rotatable cover 118 can be flipped open for easy operation. During operation, closing the rotatable cover 118 occludes the ice-making region 128 and provides effective protection, balancing ease of observation with operational safety.

In an embodiment, the rotatable cover 118 can include a transparent window 284. This feature allows users to directly observe the working condition of the ice-making region 128 including the interaction of the blade assembly with the evaporator drum 120 through the window 284, facilitating real-time monitoring of the apparatus's operation. The rotatable cover 118 covers the ice-making region 128, providing protection to prevent foreign objects from entering or impurities from splashing out while the blade assembly and the evaporator drum are working, without affecting the observation effect.

### Second Embodiment

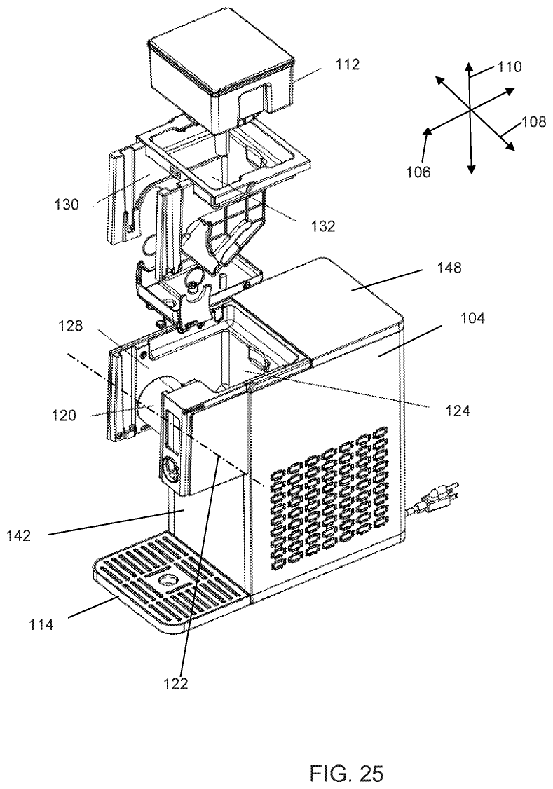

Referring to FIG. 25, in a second embodiment, the housing liner assembly 130 may be integrally formed as a single piece construction. The housing liner assembly 130 can be inserted directly into the cabinet interior 124 defined by the housing cabinet 104. The housing liner assembly 130 can structurally define the ice-making region 128 disposed longitudinally toward the front of the refrigeration machine 100 and the liquid passageway 132 that fluidly communicates with the liquid ingredient storage device mounted to the top panel 148 of the housing cabinet 104. The liquid holding tray 134 can be detachably connected to the lower end of the housing liner assembly 130 generally below the ice-making region 128 and at the end of the liquid passageway 132. Hence, the housing cabinet 104 does not directly contact or is not exposed to the ice-making region 128.

Instead, the evaporator drum 120 is located in the cabinet interior 124 and the axial ends of the evaporator drum 120 can be supported by bearings attached to the housing cabinet 104 and located toward the lateral sides of the cabinet interior 124 such that the rotational axis 122 is aligned parallel with the lateral direction 108. However, the main extension of the evaporator drum 120 that extends laterally is positioned between the housing liner assembly 130 and the liquid holding tray 134. The location of the ice-making region 128 where the liquid ingredients contact the evaporator drum 120 is enclosed by the housing liner assembly 130 and the liquid holding tray 134 and the interior surfaces of the housing cabinet 104 are not exposed to the ice-making process.

For example, referring to FIG. 25, the integral embodiment of the housing liner assembly 130 is removably placed in the cabinet interior 124 and shields side walls of the housing cabinet 104. The evaporation drum 120 is located in the cabinet interior 124 to perform ice making, whereby the ice-making region 128 is isolated from the housing cabinet 104 by the housing liner assembly 130. The housing liner assembly 130 forms an independent ice-making region 128 and effectively prevents ingredients from splashing or leaking about the cabinet interior 124. When the refrigeration machine 100 needs to be cleaned, the housing liner assembly 130 is removed alone, so that the entire interior surfaces of the housing cabinet 104 are exposed. At this time, a user uses a water gun or similar tool to perform thorough cleaning alone and directly on the interior surfaces of the housing cabinet 104. The detachable structural design makes the cleaning process more convenient and efficient and effectively reduces cleaning time and labor intensity. Compared with the prior art, because a housing cabinet 104 in the prior art has a complex structure, multiple components need to be removed during cleaning, the operation is cumbersome, and thorough cleaning is difficult.

The embodiment of the utility model has the following beneficial effects: The refrigeration machine 100 of this embodiment is provided with the housing cabinet 104 and the housing liner assembly 130 which is integrally formed as a single piece. The housing cabinet 104 is provided with the cabinet interior 124. The housing liner assembly 130 is removably placed in the cabinet interior 124 and shields the side walls of the cabinet interior 124. The evaporation drum 120 is located in the cabinet interior 124 and performs ice making. Because the housing liner assembly 130 shields the interior surfaces of the cabinet interior 124, ingredients and slush do not enter the cabinet interior 124 of housing cabinet 104 during ice making and adhere only to the housing liner assembly 130. When cleaning is required, the housing liner assembly 130 is removed alone, so that the entire inner wall of the housing cabinet 104 is exposed. A water gun or similar tool is used to perform thorough cleaning alone and directly, whereby cleaning is facilitated, maintenance cost for a user is reduced, and user experience is improved.

When the refrigeration machine 100 needs to be cleaned, the housing liner assembly 130 is removed alone, and the storage device 112 is then removed from the housing liner assembly 130, so that the entire ice-making region 128 is exposed. At this time, a user uses a water gun or similar tool to perform thorough cleaning alone and directly on the ice-making region 128.

In an embodiment, the liquid holding tray 134 is removably placed in the ice-making region 128 and located below the evaporator drum 120. In another embodiment, the liquid holding tray 134 is removably connected to the housing cabinet 104. The liquid holding tray 134 not only supplies ingredients but also receives liquid formed after the slush melts, thereby further preventing the liquid from seeping into the cabinet interior 124. During cleaning, the detachable liquid holding tray 134 is taken out alone for washing (from the housing liner assembly 130 or from the housing cabinet 104), whereby the problem of water accumulation and mildew caused by a non-detachable water receiving structure in the prior art is avoided. The liquid holding tray 134 is connected to the housing liner assembly 130 or from the housing cabinet 104 and surrounds two ends of the evaporator drum 120. The housing liner assembly 130 or from the housing cabinet 104 and the liquid holding tray 134 form seals at upper and lower ends of the evaporator drum 120 respectively. The seal structure design effectively prevents ingredients or water formed after the slush melts from leaking into the cabinet interior 124, further protects the housing cabinet 104, and also facilitates separate cleaning of the liquid holding tray 134.

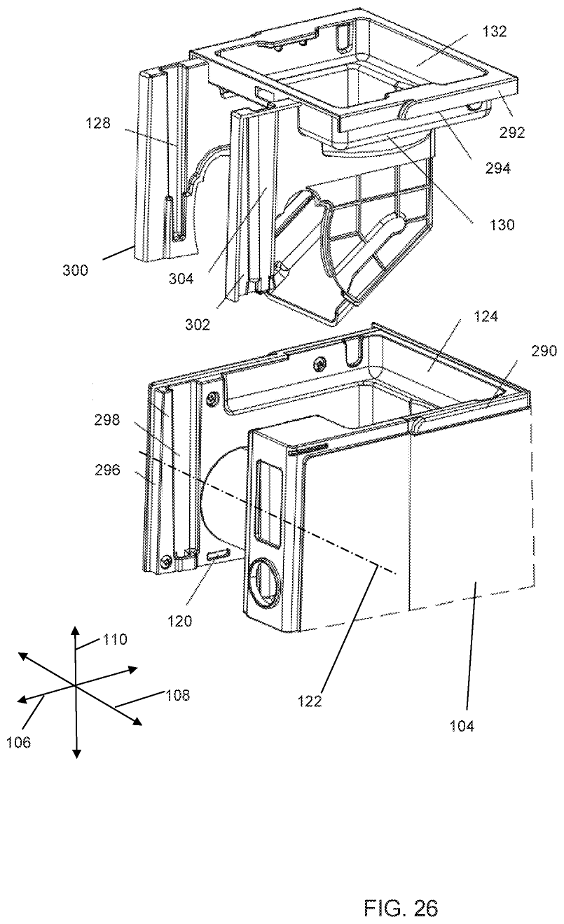

Referring to FIG. 26, to attach the integral housing liner assembly 130 to the housing cabinet 104, an attachment frame 290 can be formed about the edge of the housing cabinet 104 surrounding the entrance to the cabinet interior 124 and projecting upward. To attach with the attachment frame, an insert frame 292 is formed at the upper edges of the housing liner assembly 130, the insert frame 292 surrounds the periphery of the entrance to the liquid passageway 132 and is bent downward to form an frame groove 294 together with the side wall of the housing liner assembly 130. When the housing liner assembly 130 is placed in the cabinet interior 124 of the housing cabinet 104, the side attachment frame 290 projecting vertically upwardly can be inserted into the frame groove 294 directed downwardly. The attachment frame 290 of the housing cabinet 104 and the frame groove 294 of the housing liner assembly 130 form a nested sealing structure. When the housing liner assembly 130 is placed in the cabinet interior 124, the attachment frame 290 is inserted upward into the frame groove 294 and forms an annular sealing interface by means of the bent-edge structure. This design not only increases the connection strength between the housing cabinet 104 and the housing liner assembly 130 but also prevents liquid splashing during ice making from reaching the area outside the cabinet interior through physical shielding.

In order to fix the housing liner assembly 130, a front mounting portion 296 is provided at the front end of the housing cabinet 104. The front mounting portion 296 is located longitudinally forward of the ice-making region 128 and the evaporator drum 120. The front mounting portion 296 include a pair of laterally opposed mounting slots 298 that extends parallel to the vertical direction 110. The mounting slots 298 are spaced apart from each other in the lateral direction 108 and define a gap. When viewed from the longitudinal front, the evaporator drum 120 laterally extends between the gap defined by the laterally opposed pair of mounting slots 298.

To accommodate the blade assembly 126, the housing liner assembly 130 can include a blade insert frame 300 located at the longitudinal front of the housing liner assembly 130 forward of the ice-making region 128. The blade insert frame 300 is similar to the blade insert frame 244 of the inner liner 240 and includes parallel first and second frame legs 302 that extend in the vertical direction 110. The frame legs 302 are spaced apart in the lateral direction 108 and can accommodate the blade assembly 126 therebetween. The blade assembly 126 can be moved vertically up and down between the frame legs 302 for adjustment. In an embodiment, the frame legs 302 be inclined toward each other or may include tapered slots to form a wedge-lock arrangement with the blade assembly 126.

Formed on the exterior of each frame legs 302 and protruding laterally outward can be an insert flange 304 that extends parallel to the vertical direction 110. The widths of the insert flanges 304 can correspond with the mounting slots 298 of the front mounting portion 296 of the housing cabinet 104. When the housing liner assembly 130 is inserted vertically into the cabinet interior 124 of the housing cabinet 104, the insert flanges 304 align with and are received in the mounting slots 298. The sliding relation between the insert flanges 304 and the mounting slots 298 result in the front mounting frame 296 constraining movement of the housing liner assembly 130. To ensure a tight sliding relation between the insert flanges 304 and the mounting slots 298, the widths of the mounting slots 298 may tapper or narrow in the vertical direction 110 to increasingly compressively fit with the insert flanges 304 during insertion.

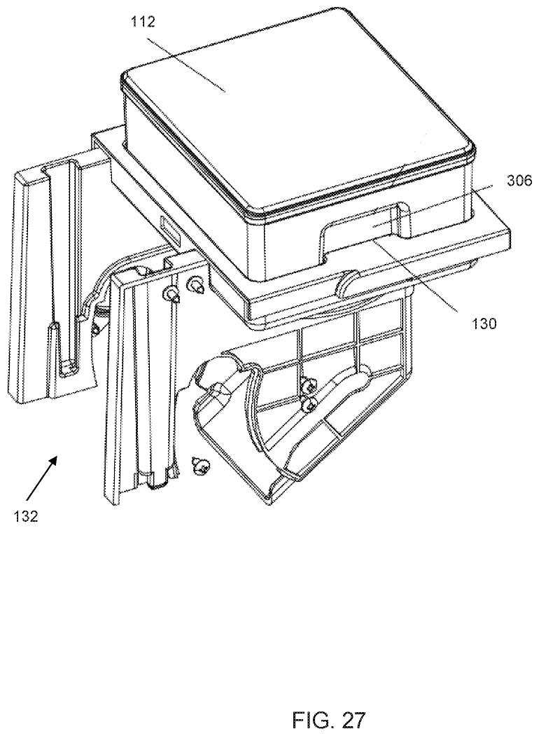

Referring to FIG. 27, the liquid ingredient storage device 112 can be mounted directly to the integral housing liner assembly 130. For example, the storage device 112 can be inserted into the entrance to the liquid passageway 132 defined by the housing liner assembly and can abut against the upper edges of the walls comprising the housing liner assembly 130. Recesses can be formed into the upper edges of the housing liner assembly 130 to locationally fix and align the storage device 112 with the liquid passageway 132. To assist in dismounting the storage device 112, one or more finger-hold grooves 306 can be disposed into the sidewalls of the storage device 112. The finger-hold grooves 306 allow a user to grasp and lift the storage device 112 out of the liquid passageway 132 and from the housing liner assembly 130 in the vertical direction 110.

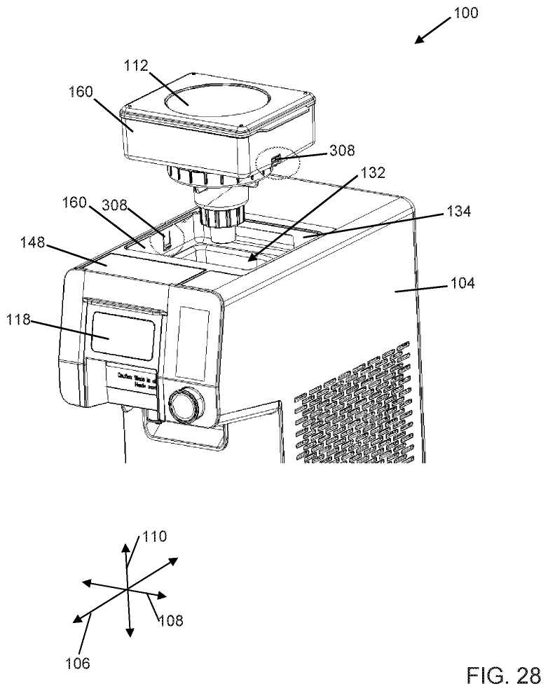

Referring to FIG. 28, in an embodiment, the storage device 112 and the housing liner assembly 130 can include a cooperative locking structure 308 to retain the storage device 112 into the entrance of the liquid passageway 132. For example, the cooperative locking structure 308 can be embodied as a snap-fit joint. A surface of the structural recess 260 associated with the housing liner assembly 130 may include a cantilevered snap-fit arm that is oriented in the vertical direction 110 and the storage body 160 may include a corresponding hook or socket. The snap-fit structures can be provided on both lateral sides of the structural recess 260 and the storage body 160 to apply a symmetrical retaining force holding the storage device 112.

When the storage device 112 is inserted into the structural recess 260 in the vertical direction 110, the cantilevered snap-fit arm in the structural recess deflects until aligned with the socket hook on the storage body 160. The snap-fit structures then engage securely retaining the storage body 160 into the structural recess 260. The cooperative locking structure 308 may provide an audible or tactile indication to the user that the storage device 112 has been correctly installed into the housing liner assembly 130. To remove the storage device 112, a force is applied to the finger-hold grooves 306 to overcome the cooperative locking structure 308.

### Sealing

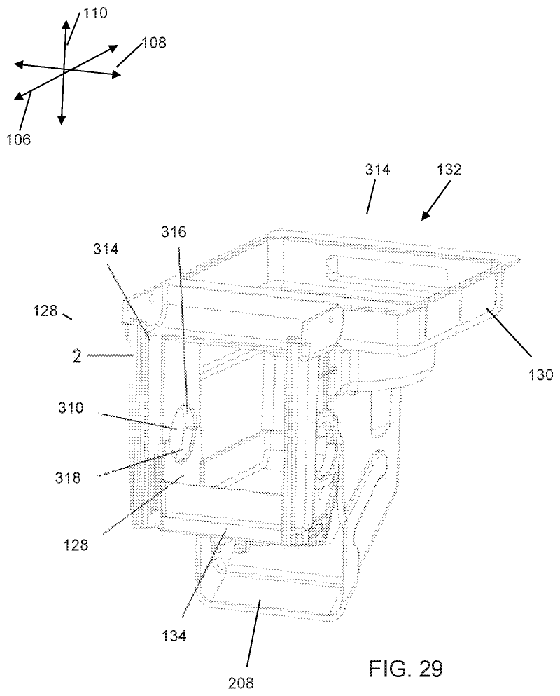

Referring to FIG. 29, the housing liner assembly 130 and the liquid holding tray 134 may form first and second holes 310, 312. The holes 310, 312 correspond in location to the ice-making regions 128 and are aligned with the lateral direction 108. The first and second holes 310, 312 are laterally spaced apart from each other with respect to the lateral direction 108 can be formed in opposite lateral sidewalls 314 of the housing liner assembly 130. For example, the lateral sidewalls 314 may be laterally spaced apart and define a bifurcated gap that corresponds to the ice-making region 128 of the refrigeration machine 100. The holes 310, 312 can be circular in shape and can encircle and surround shaft journals disposed at the axial ends of the evaporator drum 120. The holes 310, 312 can be symmetrically arranged and are axially aligned with each other with respect to the rotational axis 122 of the evaporator drum (parallel to the lateral direction 108) that passes perpendicularly between the lateral sidewalls 314.

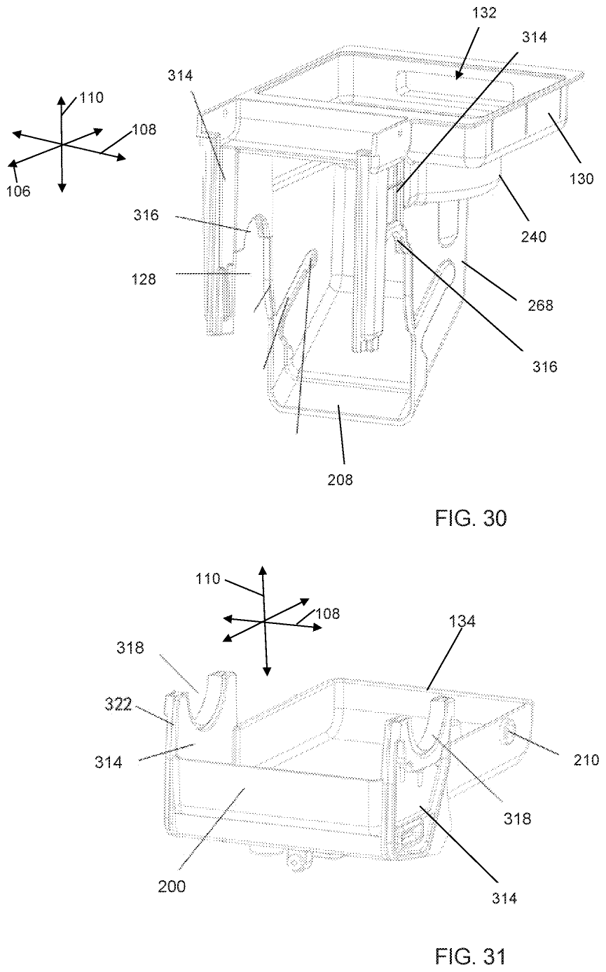

Referring to FIGS. 30 and 31, in the embodiments wherein the housing liner assembly 130 is comprised of the inner shell 240 and outer shell 242, the holes 310, 312 can be formed by cooperative arrangement between the inner shell 240 and the liquid holding tray 134. For example, disposed into the laterally opposite sidewalls of the inner shell 240 can be semicircular holes 316 that are recessed radially in the vertical direction 110. When the housing liner assembly 130 is installed in the housing cabinet 104, the semicircular hole 316 partially surrounds the shafts of the evaporator drum 120 which may include an appropriately shaped shaft journal. To completely form the circular shape of the bearing hole 310, 312, the liquid holding tray 134 can also include semicircular holes 318 disposed into the upright sidewalls defining the tray bed 200. For example, the upper edges of the tray bed 200 of the liquid holding tray 134 is provided with semicircular hole 318 recessed radially downward in the vertical direction 110. A position of the semicircular hole 318 corresponds to a position of the semicircular hole 316 in the inner shell 240.

When the liquid holding tray 134 is installed with respect to the inner shell 240, the upper semicircular holes 316 radially surrounds the upper segment of the shafts of the evaporator drum 120 and the lower semicircular hole 318 radially surround lower segment of the shafts of the evaporator drum 120. The upper and lower semicircular holes 316, 318 cooperate to form the circular holes 310, 312 that encircle and surround the shafts of the evaporator drum. The structure enables the inner shell 240 to shield interior surfaces of the cabinet interior 124 and, through close fit between the edge of the holes 310, 312 and the evaporation drum, strictly confines ingredients and slush during ice making inside the ice-making region 128 of the housing liner assembly 130.

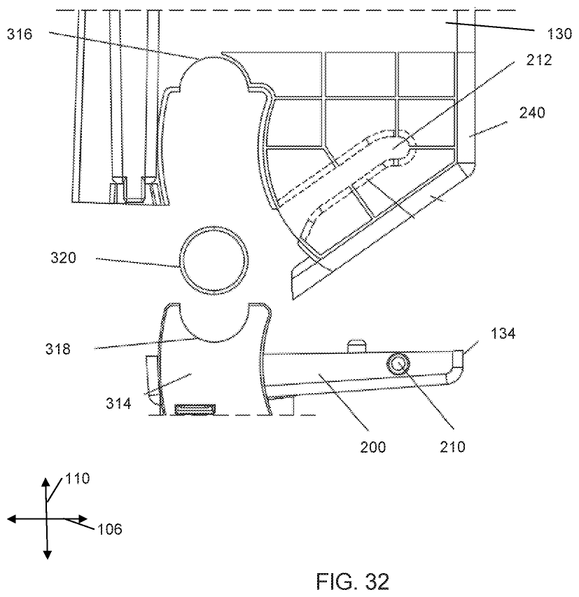

Referring to FIG. 32, in an embodiment, the shafts of the evaporator drum 120 may be provided with sealing rings or sealing bushings 320. The sealing bushings 320 are arranged at the shaft of the evaporation drum 120 and located at side walls of the housing liner assembly 130, thereby forming the rotary shaft seal. The upper and lower semicircular holes 316, 318 are each semicircular in shape. The upper semicircular hole 316 and the lower semicircular hole 318 form the circular holes 310, 312 and surround an outer side of the sealing bushings 320. On one hand, an annular structure enhances sealing effect at the two shafts of the evaporation drum 120 and prevents liquid from leaking through a gap between the sealing bushing 320 and the housing cabinet 104 during ice making. On the other hand, when the inner shell 240 and the liquid holding tray 134 are detached, the sealing bushing 320 are fully exposed, so that a user directly observes wear of the sealing bushing 320 and performs cleaning or replacement, whereby a maintenance blind area caused by hidden installation of the sealing bushing 320 in the prior art is solved.

In the first embodiment, the sealing bushing 320 has a complete annular structure. An upper half portion of the sealing bushing 320 abuts an inner radial edge of the upper semicircular hole 316, and a lower half portion of the sealing bushing 320 abuts an inner radial edge of the lower semicircular hole 318. The sealing bushing 320 forms complete sealing for the upper and lower semicircular holes 316, 318 that produce the circular holes 310, 312. In the embodiments, the sealing bushing 320 may be statically fixed to the inner shell 240 and located with respect to the holes 310, 312 or the sealing bushing 320 may rotate together with the evaporation drum 120 and makes sliding contact with the holes 310, 312. Because complete sealing is formed, the sealing bushing 320 achieves complete sealing function while rotating together with the evaporation drum 120.

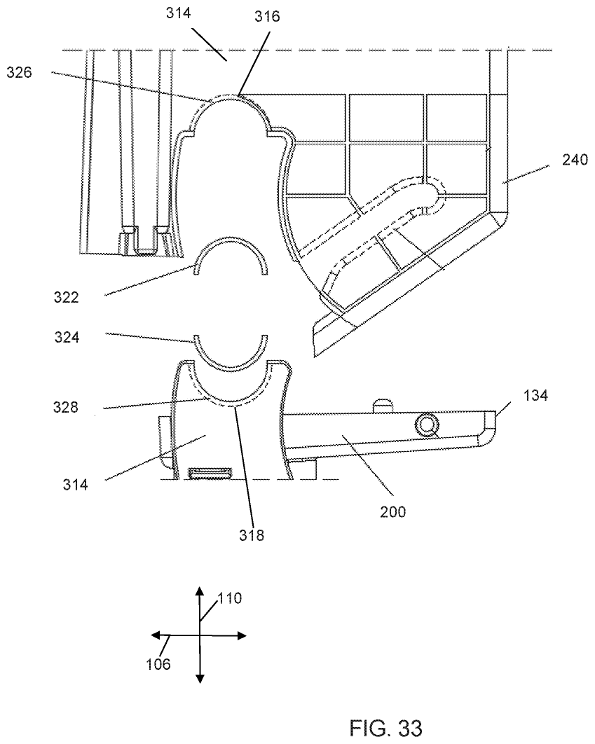

Referring to FIG. 33, in the second embodiment, the sealing bushing 320 is split into two parts, specifically including a first bushing half 322 and a second bushing half 324. The first bushing half 322 is installed in the upper semicircular hole 316 that is, the first bushing half 322 is located at the lower part of the inner shell 240. The second bushing half 324 is installed in the lower semicircular hole 318, that is, the second bushing half 324 is located at the upper part of the liquid holding tray 134. The first bushing half 322 seals the upper semicircular hole 316, and the second bushing half 324 seals the lower semicircular hole 318. One end of both the first bushing half 322 and the second bushing half 324 features a concave arc-shaped structure, enabling them to respectively surround the end shaft of the evaporation drum 120 from the upper and lower parts, thus forming a seal around the end shaft of the evaporation drum 120.

In the second embodiment, the first bushing half 322 and the second bushing half 324 may be stationary and fixed relative to the evaporation drum 120. After installation, the inner shell 240 generates a downward pressing force on the first bushing half 322, and the liquid holding tray 134 generates an upward pressing force on the second bushing half 324. As a result, the first bushing half 322 and the second bushing half 324 can form a complete seal around the end shaft of the evaporator drum, and there will be no leakage between first bushing half 322 and the second bushing half 324.

Referring to FIG. 33, in the second embodiment, a first sealing insert slot 326 is provided inside the upper semicircular hole 316 in the inner shell 240. The first sealing insert slot 326 can be formed as a radially directed recess or slit formed in the radial inner edge of the upper semicircular hole 316 and disposed partially into the structure of the lateral sidewall 314. A second sealing insert slot 328 is provided inside the lower semicircular hole 316, and the second sealing insert slot 328 can be formed as a radially disposed recess or slit formed into the inner radial edge of the lower semicircular hole 318 and disposed partially into the structure of the lateral sidewall 314. The first bushing half 322 is installed and fixed in the first sealing insert slot 326, and the second bushing half 324 is installed and fixed in the second sealing insert slot 328. The first and second bushing halves 322, 324 may include tabs or the like that can be inserted and held in the first and second sealing insert slots 326, 328 to fix the bushing halves against rotation.

The first bushing half 322 and the second bushing half 324 together form a sealing area that is compatible with the end shaft of the evaporator drum 120. Specifically, the inner sides of the first bushing half 322 and the second bushing half 324 can form a circle, which is compatible with the shaft journals at the axial ends the evaporator drum 120, thus forming a complete seal around the end shaft.

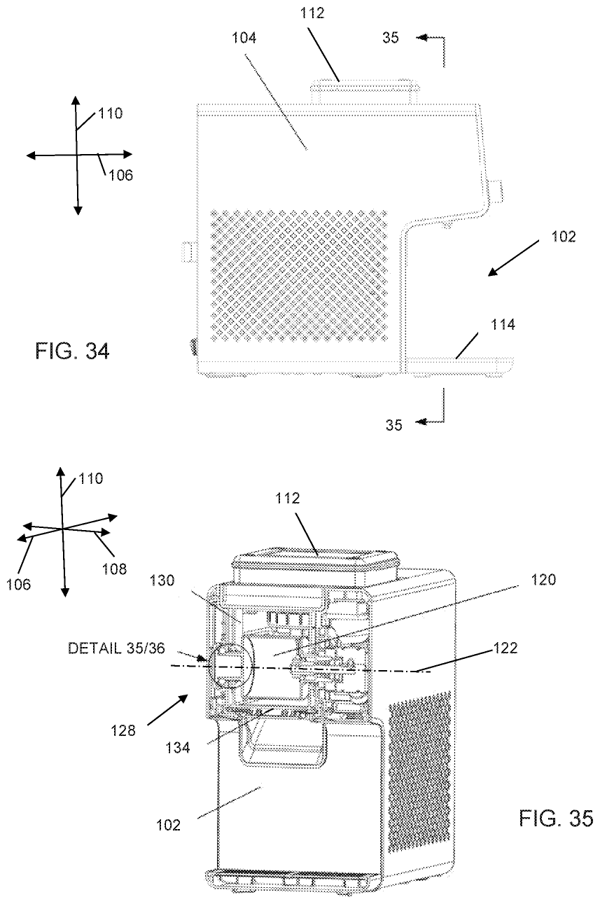

Referring to FIGS. 34 and 35, in an embodiment the refrigeration machine 100 can be associated with more robust seals to form a sealed connection with the rotating evaporator drum disposed internally in the housing cabinet 104 to prevent leakage of the liquid ingredients. For example, the refrigeration machine 100 includes a liquid ingredient storage device 112 that is located vertically on top of the housing cabinet 104. The liquid ingredients can travel due to gravity through the cabinet interior 124 defined by the housing cabinet 104 and can be dispensed at the dispensing region 102 located at the longitudinal front of the refrigeration machine 100. The ice-making region 128, where the liquid ingredients are converted to solid ice shavings, is located between the storage device 112 and the dispensing region 102 and is in fluid communication with both locations.

Referring to FIG. 35, to freeze and solidify the liquid ingredients, the evaporator drum 120 is disposed inside the housing cabinet 104 and locationally associated with the ice-making region 128. Locationally, the evaporator drum 120 is downstream of the storage device 112 and upstream of the dispensing regions 102 and is disposed in the fluid path of the liquid ingredients between those locations. The cylindrical shape of the evaporator drum 120 is situated horizontally such that the rotational axis 122 of the evaporator drum 120 is aligned with the lateral direction 108. To avoid contaminating the internal surfaces of the housing cabinet 104, the evaporator drum 120 may be supported by the housing liner assembly 130 and locationally confined within the liquid passageway 132. The rotational axis 122 can pass laterally through the housing liner assembly 130. When the liquid ingredients pass from the storage device 112 through the liquid passageway 132 they contact and freeze against the evaporator drum 120 and can be converted to ice shavings by the blade assembly.

Referring back to FIG. 29, when the liquid holding tray 134 is installed with respect to the inner shell 240 of the housing liner assembly 130, the upright sidewalls of the two structures cooperate to produce the opposite lateral sidewalls 314. The lateral sidewalls 314 are spaced apart in the lateral direction 108 and form a bifurcated gap that corresponds to the ice-making region 128. To support the evaporator drum within the ice-making region 128, the first and second holes 310, 312 are disposed into the lateral sidewalls 314 and are axially aligned with the rotational axis 122. The axial alignment of the first and second holes 310, 312 with respect to the rotational axis 122 can support the shaft of the evaporator drum extending between the laterally spaced apart lateral sidewalls 314.

When the evaporator drum is supported between the holes 310, 312, the evaporator drum will be positioned vertically above the liquid holding tray 134 and can be partially submerged into the liquid ingredients contained therein to coat and freeze to the evaporator drum. The evaporator drum will also be laterally constrained between the laterally opposed sidewalls 314 of the housing liner assembly 130, such that during the ice-making process the liquid will only contact the inner liner and not the body, making it easier to clean and improving food safety.

To enable rotation of the rotary evaporator drum 120 about the rotational axis 122 with respect to the stationary housing liner assembly 130, the evaporator drum 120 can be rotatably connected to the housing liner assembly 130 by a pair of sealing elements 330. The sealing elements 330 may be operatively associated with the first and second holes 310, 312 located in the laterally opposed sidewalls 314 of the housing liner assembly 130 can make sliding contact with the shaft journals associated with the evaporator drum. The sealing elements 330 can be made of elastomeric silicone or rubber that are compressible and resilient. The sealing elements 330 may have different embodiments.

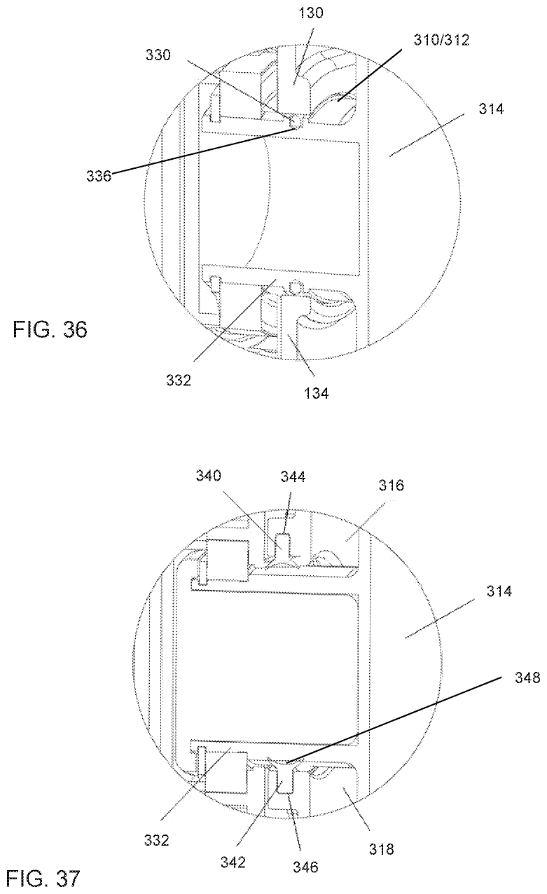

Referring to FIG. 36, the sealing element 330 is disposed around the peripheral side of the rotating shaft journal 332 that is located at the axial end of the evaporator drum 120 and is configured to form a circular structure. For example, the sealing element 330 may be an O-ring. Specifically, the circumferential surface of the rotating shaft journal 332 is provided with a sealing groove 334, wherein the sealing element 330 is installed in the sealing groove. The sealing element 330 is in contact with the circumferential surfaces of the first and second holes 310, 312 disposed in the laterally opposite sidewalls 314 of the housing liner assembly 130, preventing liquid from leaking through the gap between the housing liner assembly 130 and the rotating shaft journal 332, and the gap between the liquid holding tray 134 and the rotating shaft journal 332. The sealing element 330 is held fast in the sealing groove 334 and rotates with the rotating shaft journal 332 in relation to the stationary holes 310, 312. In a variation, the sealing groove 334 may be formed in the radial surface of the first and second holes 310, 312 such that the rotating shaft journal 332 remains cylindrically smooth. The sealing element 330 is held fast to the lateral sidewalls 314 and fixed and stationary with respect to the rotating shaft journal 332.

Referring to FIG. 37, in the embodiments in which the first and second holes 310, 312 disposed in the laterally opposed sidewalls 314 are produced by the installation of the liquid holding tray 134 to the housing liner assembly 130, the sealing element 330 can be split into a first element segment 340 and a second element segment 342. The first element segment 340 can be disposed within the upper semicircular hole 316 located in the housing liner assembly 130 and a second element segment 342 can be disposed within the lower semicircular hole 318 located in the liquid holding tray 134. The first element segment 340 and the second element segment 342 are respectively arranged around the outer circumference of the rotating shaft journal 332. That is, the first element segment 340 and the second element segment 342 are respectively wrapped around the rotating shaft journal 332. The first element segment 340 and the second element segment 342 are both concavely curved toward one side of the rotating shaft journal 332, and the curved structure matches the outer shape of the rotating shaft, ensuring that the first element segment 340 and the second element segment 342 tightly fit around the outer circumference of the rotating shaft, thereby ensuring the sealing between the liquid holding tray 134 inner liner and the rotating shaft journal 332, and between the housing liner assembly 130 and the rotating shaft journal 332, preventing leakage.

In an embodiment, to hold the first and second element segments 340, 342, the radial edge of the upper semicircular hole 316 is provided with a first sealing groove 344, and the radial edge of the lower semicircular hole 318 is provided with a first sealing groove 346. The first element segment 340 is disposed within the first sealing groove 344 and abuts against the rotating shaft journal 332 and the second element segment 342 is disposed within the second sealing groove 346 and abuts against the rotating shaft journal 332. More specifically, the first element segment 340 is embedded within the first sealing groove 344, fixing the first element segment to the housing liner assembly 130 and the second element segment 342 is embedded within the second sealing groove 346, fixing the second element segment to the liquid holding tray 134. The first and second element segments 340, 342 together form a sealing area adapted to the rotating shaft journal 332, wherein the shape of the sealing zone is the same as the cross-sectional shape of the rotating shaft journal 332, and the area of the sealing zone is equal to or slightly smaller than the cross-sectional area of the shaft, ensuring an effective seal.

In an embodiment, the first and second element segments 340, 342 may include a concaved curved profile 348 that is arranged to make sealing contact with circumference of the rotating shaft journal 332. The concaved curved profile 348 is adapted to be pressed radially against the curved circumference of the rotating shaft journal 332 and form a seal there against. The first and second element segments 340, 342 are formed of a compressible elastic material and the concaved curved profile 348 includes two concaved tips that each form a running line seal against the curved rotating shaft journal 332. In an embodiment, the first and second element segments 340, 342 can be integrally combined and the concaved curved profile 348 may be formed as a continuous annular ring or profile.

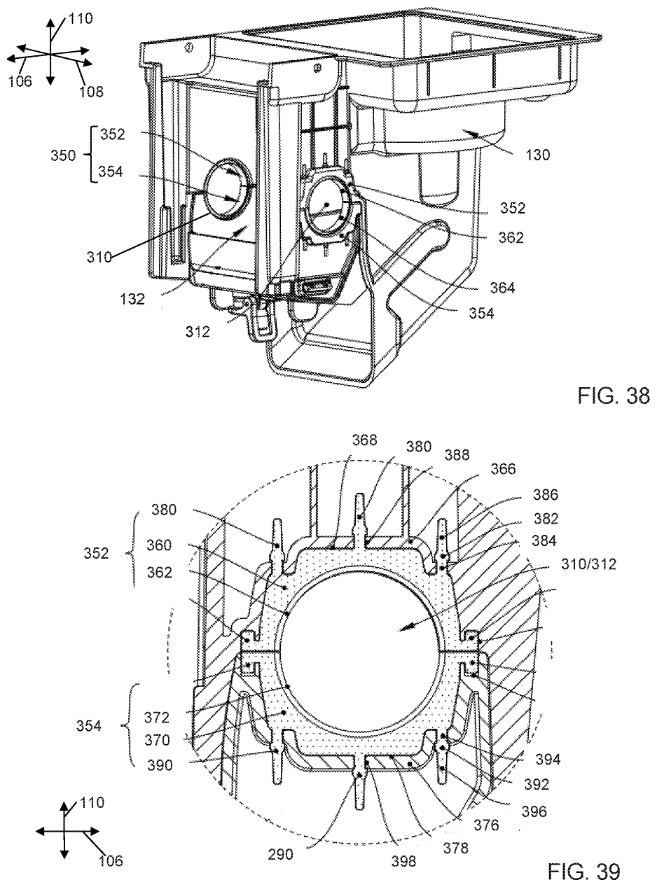

Referring to FIGS. 38 and 39, in another embodiment, the refrigeration machine 100 can include a seal assembly 350 comprised of a first collar half 352 and second collar half 354 to support and seal the evaporator drum with respect to the housing liner assembly 130 and the liquid holding tray 134. For example, the first collar half 352 and the second collar half 354 are disposed on opposite circumferential halves of the shaft journals extending axially from the evaporator drum such that the seal assembly 350 circumferentially collar and supports the shaft journals. The first and second collar halves 352, 354 may be symmetrical in design and geometry.

In the present embodiment, the housing liner assembly 130 and the liquid holding tray 134 are removeable from the housing cabinet and can be disassembled from each other to facilitate cleaning. The multipart seal assembly 350 facilitates attachment and detachment of the housing liner assembly 130 and the liquid holding tray 134. For example, the first collar half 352 and second collar half 354 can be readily assembled and disassembled to enable installation and separation of the housing liner assembly 130 and the liquid holding tray 134. In addition, designing the multipart seal assembly 350 from separable first and second collar halves 352, 354 facilitates removal, inspection and discarding of worn or damages components.

Referring to FIG. 37, in accordance with the disclosed design, the housing liner assembly 130 is structurally shaped and configured to define the liquid passageway 132 that directs the liquid ingredients to the liquid holding tray 134 that may be installed in the vertically lower portion of the housing liner assembly 130. As described above, the liquid holding tray 134 is detachable and removeable from the housing liner assembly 130. When installed, the upright sidewalls of the liquid holding tray 134 cooperate with the structural walls of the housing liner assembly 130 to produce the laterally opposed sidewalls 314 that define the bifurcated gap corresponding to the ice-making region 128. When assembled, the evaporator drum will be accommodated in the ice-making region 128 and lateral disposed between the laterally opposed sidewalls 314.

To support the evaporator drum, the first and second holes 310, 312 are disposed in the laterally opposed sidewalls 314. The first and second holes 310, 312 are symmetrical and are axially aligned with the rotational axis 122 associated with the evaporator drum 122 that is parallel to the lateral direction 108. The first and second bores 310, 312 may be circular in shape. In the embodiments where the first and second holes 310, 312 are produced by installation and cooperative arrangement of the liquid holding tray 134 and the housing liner assembly 130, the first and second holes 310, 312 are comprised of an upper semicircular hole 316 and a lower semicircular hole 318. The upper semicircular hole 316 is formed in the housing liner assembly 130 and the lower semicircular hole 318 is formed in the liquid holding tray 134.

To fix the seal assembly 350 with both the upper semicircular hole 316 and the lower semicircular hole 318, the multipart seal assembly is comprised of the first and second collar halves 352, 354. The first collar half 352 is detachably mounted to the housing liner assembly 130, and the second collar half 354 is detachably mounted to the liquid holding tray 134. The first and second collar halves 352, 354 cooperatively form a sealing assembly 350 that is used to seal the gap between the ice-making region and the evaporator drum 120.

This embodiment of the seal assembly 350 for the refrigeration machine 100 splits the seal assembly 350 into a first collar half 352 and the second collar half 354 which are respectively installed on the detachable housing liner assembly 130 and the liquid holding tray 134 fundamentally changing the traditional integral sealing ring structure placed around the end shaft of the evaporation drum. This modification significantly simplifies the sealing replacement process. In this embodiment, both ends of the evaporator drum pass through the ice-making regions 128 and are rotatably mounted in the inner shell of the housing cabinet of the refrigeration machine, with one end of the evaporator drum connected to the drive motor. When it is necessary to replace the seal assembly 350 there is no need to disassemble the entire evaporation drum from the ice-making regions 128. By simply disassembling the housing liner assembly 130 and the liquid holding tray 134, the first collar half 352 and the second collar half 354 can be removed from the evaporator drum.

This allows for easy inspection of the wear condition of the first collar half 352 and the second collar half 354, and replacement of the severely worn first or second collar halve. This design significantly saves time and labor costs required for replacement. At the same time, this modular structure also facilitates cleaning of the first collar half 352 and the second collar half 354. During use, the first collar half 352 can be removed with the housing liner assembly 130, and the second collar half 354 can be removed with the liquid holding tray 134. This makes it easier to clean both collar halves thoroughly while cleaning the housing liner assembly 130 and the liquid holding tray 134, preventing ingredient residue from affecting the sealing effect and the hygiene of the apparatus.

Additionally, since the disassembly and reinstallation of the evaporation drum are avoided, the possibility of unnecessary damage to the evaporator drum, the laterally opposed walls 314 of the ice-making region, or other related components during operation is reduced. This consequently lowers the maintenance costs and the risk of apparatus failure due to component damage. Furthermore, the annular sealing structure formed by the first collar half 352 and the second collar half 354 ensures continuous and reliable sealing of the gap between the cabinet interior 124 ice-making regions 128 and the evaporator drum 120, effectively preventing the leakage of ingredients or water from melted slush during long-term use. The modular design allows for the individual replacement of a single sealing element when worn, without needing to replace the entire multipart seal assembly 350. This further improves the convenience and cost-effectiveness of sealing maintenance and ensures the long-term sealing performance of the apparatus.

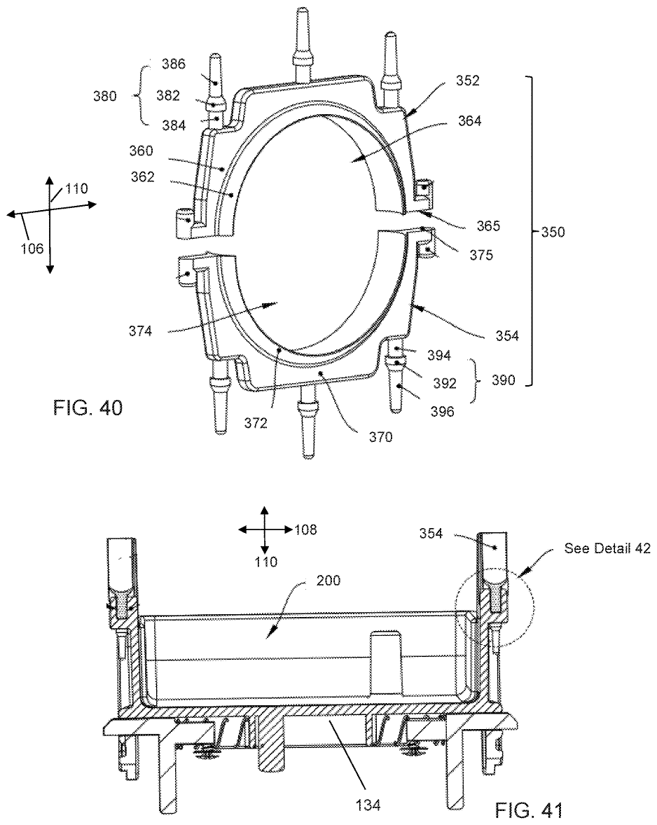

Referring to FIG. 40, in an embodiment, the first collar half 352 can be comprised of a first support body 360 and a first sealing lip 362. The first support body 360 is a rigid structure that corresponds to a housing or casing and the first sealing lip 362 is a flexible material attached to the support body 360 that can make a compressible running contact with a moving surface. Examples of materials for the support body 360 include rigid plastics and for the sealing lip 362 include flexible and resilient rubbers and elastomers. A portion of the first support body 360 is shaped to form a radial recess 364 which may be semi-circular and wraps about the circumference of the shaft of the evaporator drum.

The first sealing lip 362 is a flange formed by the attachment to the first support body 360 extending outward along the circumferential profile of the first recess 364. The first sealing lip 362 enables the first collar half 352 to form a sealed running contact with the upper circumference surface of the evaporator shaft. The two sides of the first sealing lip 362 protrude from both sides of the first support body 360, which expands the sealing coverage area, reduces the gap caused by assembly errors between the evaporator and ice-making regions 128, or slight axial movement during operation, thereby improving the sealing redundancy.

The second collar half 354 can be comprised of a second support body 370 and a second sealing lip 372. The second support body 370 is a rigid structure that corresponds to a housing or casing and the second sealing lip 372 is a flexible material attached to the support body 370 that can make a compressible running contact with a moving surface. Examples of materials for the support body 370 include rigid plastics and for the sealing lip 372 include flexible and resilient rubbers and elastomers. A portion of the second support body 360 is shaped to form a radial recess 374 which may be semi-circular and wraps about the circumference of the shaft of the evaporator drum.

The second sealing lip 372 is a flange formed by the attachment to the second support body 370 extending outward along the circumferential profile of the second recess 374. The second sealing lip 372 enables the second collar half 354 to form a sealed running contact with the upper circumference surface of the evaporator shaft. The two sides of the second sealing lip 372 protrude from both sides of the second support body 370, which expands the sealing coverage area, reduces the gap caused by assembly errors between the evaporator and ice-making regions 128, or slight axial movement during operation, thereby improving the sealing redundancy.

The semicircular first recess 364 and the second recess 374 together form the first and second circular holes 310, 312. The rotating shaft of the evaporator drum is rotatably installed within the holes 310, 312, and the first sealing lip 362 and the second sealing lip 372 respectively contact the rotary journal shaft of the evaporator drum, thereby sealing the gap between the cabinet interior 124, ice-making regions 128 and the evaporator drum 120.

In one embodiment, the semicircular endpoints of the first collar half 352 at diametrically opposite ends of the first recess 364 are first abutment surfaces 365 which are used for contact with the second collar half 354. The semicircular endpoint of the second collar half 354 at diametrically opposite ends of the second recess 374 are second abutment surfaces 375 which are used for contact with the first collar half 352. Both the first abutment surface 365 and the second abutment surface 375 are planar. By making both the first abutment surface 365 and the second abutment surface 375 flat, it facilitates a closer fit at the connection between the first collar half 352 and the second collar half 354, further enhancing the sealing effect.

To hold and secure the first collar half 352, the housing liner assembly 130 can include a first mounting boss 366. The first mounting boss 366 can be formed as a raised boss or ribs formed about the edges or rims of the laterally opposed sidewall 314 that are disposed around and associated with the first and second holes 310, 312. The first mounting boss 366 provides strength and rigidity for holding and securing the first collar half 352 and can support and transfer loads associated with the evaporator drum.

The first mounting boss 366 defines a first mounting profile 368 with an opening facing the evaporator drum, and the shape and size of the first mounting profile 368 is adapted to geometrically correspond to the first support body 360 of the first collar half 352, allowing the first support body 360 to be detachably mounted inside the first mounting profile 368. The shape and size of the first mounting profile 368 match the shape and size of the first support body 360, allowing the first support body 360 to be precisely installed within the first mounting profile 368. The matching shape and geometry between the first support body 360 of the first collar half and the first mounting boss 366 produces a keyed relation to properly position the first sealing lip 362 with respect to the rotary journal shaft of the evaporator drum 120.

The first support body 360 installed inside the first mounting profile 368 provides a stable mounting base for the first collar half 352, effectively limiting its displacement during apparatus operation, preventing the first collar half 352 from shifting due to the rotation of the evaporator and affecting the sealing effect, thereby enhancing the stability of the sealing structure. Additionally, since the first collar half 352 protrudes from both sides of the first mounting boss 366, and the first sealing lip 362 is located outside the first mounting profile 368, it can better fit the evaporation cylinder and further prevent leakage from the gap between the cabinet interior 124, ice-making regions 128 and the evaporator drum 120. Furthermore, during the rotation of the evaporator, it first contacts the first collar half 352, which has a certain degree of elasticity, instead of directly hitting the rigid first mounting boss 366. This reduces impact wear during the rotation of the evaporator, lowers the noise during apparatus operation, and prevents damage to the first mounting boss 366 from direct impact, thus extending the service life of the apparatus and ensuring smooth rotation of the evaporator.

Moreover, this structural design makes the disassembly and installation of the first collar half 352 more targeted. The cooperation between the first support body 360 and the first mounting profile 368 facilitates quick positioning and operation. When replacing or cleaning the first collar half 352, it can be disassembled and assembled more easily, further reducing maintenance time and labor costs. At the same time, the first sealing lip 362 protruding from the first mounting profile 368 improves the contact area and fit when sealing with the second collar half 354. This ensures the sealing structure can adapt to minor vibrations or displacements during operation, guaranteeing reliable sealing during long-term use and reducing the risk of failure due to sealing issues.

In one embodiment, both sides of the liquid holding tray 134 are provided with second mounting boss 376 for installing the second collar half 354. The second mounting boss 376 defines a second mounting profile 378 with an opening facing the evaporator drum, and the shape and size of the second mounting profile 378 are adapted to geometrically correspond to the shape of the second support body 370 of the second collar half 354, allowing the second support body 370 to be detachably mounted inside the second mounting profile 378. The structural effect of this design is the same as that of the first collar half 352 so it will not be further elaborated here.

It is worth noting that after the housing liner assembly 130 and the liquid holding tray 134 are assembled into the housing cabinet 104 of the refrigeration machine 100, the position of the second mounting boss 376 corresponds to the position of the first mounting boss 366. The first and second mounting boss 366, 376 come into contact, so that the first collar half 352 and the second collar half 354 abut against each other; or the gap between the first and second mounting boss 366, 376 is very small, with the first abutment surface 365 of the first collar half 352 protruding from the first mounting boss 366, and the second abutment surface 375 of the second collar half 354 protruding from the second mounting boss 376, allowing the first and second abutment surfaces 365, 375 to abut against each other. This ensures that the first collar half 352 and the second collar half 354 to make close contact, forming an annular sealing structure.

Preferably, the first abutment surface 365 may protrude from the first mounting boss 366, and the second abutment surface 375 may also protrude from the second mounting boss 376. After the liquid holding tray 134 and the housing linear assembly 130 are assembled into the housing cabinet of the refrigeration machine 100, the location of the liquid holding tray 134 and the housing linear assembly 130 can be controlled and structurally set so that the first collar half and the second collar half are pressed against each other, forming a tighter connection and better sealing effect.

Referring to FIG. 40, to releasably attach the first collar half 352 to the first mounting boss 366 formed on the housing liner assembly 130, a plurality of first fasteners 380 can be fixedly connected to the first support body 360 opposite the location of the first sealing lip 362. The first fastener 380 allows for the detachable connection between the first collar half 352 and the first mounting boss 366.

In one embodiment, the first fasteners 380 include a first snap-fit portion 382 a first limit post 384 and a first guide post 386, which are sequentially connected. The first snap-fit portion 382 may have a larger diameter than the first guide post 386 and protrudes circumferentially outward from the first guide post. The first snap-fit portion 382 is fixedly connected to the first support body 360 by the first limit post 384.

The first mounting boss 366 is provided with a number of first snap-fit holes 388 which communicate with and are disposed into the first mounting profile 368. The diameter and length of the first snap-fit portion 382 are respectively adapted to the diameter and depth of the first snap-fit hole 388, the diameter of the first guide post 386 is greater than the diameter of the first snap-fit hole 388, and the diameter of the first guide post 386 is smaller than the diameter of the first snap-fit hole 388. The first limit post 384 and the first guide post 386 pass through the first snap-fit hole 388 and snap into place on the exterior of the first mounting boss 366.

The diameter and length of the first snap-fit portion 382 are adapted to the first snap-fit hole 388, ensuring a tight connection after insertion, preventing loosening. The first guide post 386 has a smaller diameter, making it easier to guide the entire assembly through the first snap-fit hole 388, improving the smoothness of installation. The first limit portion 384 has a larger diameter, and after passing through the first snap-fit hole 388, it snaps into place on the exterior of the first mounting boss 366, firmly holding the first collar half 352 in place and preventing it from falling off, thus enhancing installation stability. Due to the design of the first collar half 352, the disassembly and assembly of the first collar half 352 can be completed without tools, further simplifying the maintenance process. This design makes the disassembly and assembly of the first collar half 352 time-and labor-efficient while maintaining installation firmness and operational convenience. To detach the first collar half 352 from the first mounting boss 366, force can be applied to the first support body 360 to overcome the retention force associated with the first snap-fit portion 382 and remove the first fasteners 380 from the first snap-fit hole 388.

In one embodiment, the second collar half 354 also includes a number of second fasteners 390, one end of each second fastener 390 being fixedly connected to the second support body 370 opposite to the second sealing lip 372, and the other end being detachably connected to the second mounting boss 376. The second fasteners 390 allow for the detachable connection between the second collar half 354 and the second mounting boss 376.

In one embodiment, the second fastener 390 includes a second snap-fit portion 392, a second limit post 394, and a second guide post 396, which are sequentially connected. The second snap-fit portion 392 may have a larger diameter than the second guide post 396 and protrude circumferentially outward from the second guide post. The second snap-fit portion 392 is fixedly connected to the second support body 370 by the second limit post 394

The second mounting body 370 is provided with a number of second snap-fit holes 398, which communicate with the second mounting profile 372. The diameter and length of the second snap-fit portion 392 are respectively adapted to the diameter and depth of the second snap-fit hole 398, the diameter of the second limit post 394 is greater than the diameter of the second snap-fit hole 398, and the diameter of the second guide post 396 is smaller than the diameter of the second snap-fit hole 398. The second limit post 394 and second guide portion 396 pass through the second snap-fit hole 398 and snap into place on the exterior of the second mounting boss 370.

The diameter and length of the second snap-fit portion 392 are adapted to the second snap-fit hole 398, ensuring a tight connection after insertion, preventing loosening. The second guide portion 396 has a smaller diameter, making it easier to guide the entire assembly through the second snap-fit hole 398, improving the smoothness of installation. The second limit portion 394 has a larger diameter, and after passing through the second snap-fit hole 398, it snaps into place on the exterior of the second mounting boss 376, firmly holding the second mounting boss 376 in place and preventing it from falling off, thus enhancing installation stability. Due to the design of the second collar half 354, the disassembly and assembly of the second collar half 354 can be completed without tools, further simplifying the maintenance process. This design makes the disassembly and assembly of the second collar half 354 time-and labor-efficient while maintaining installation firmness and operational convenience. To detach the second collar half 354 from the second mounting boss 376, force can be applied to the second support body 370 to overcome the retention force associated with the second snap-fit portion 392 and remove the second fasteners 390 from the second snap-fit hole 398.

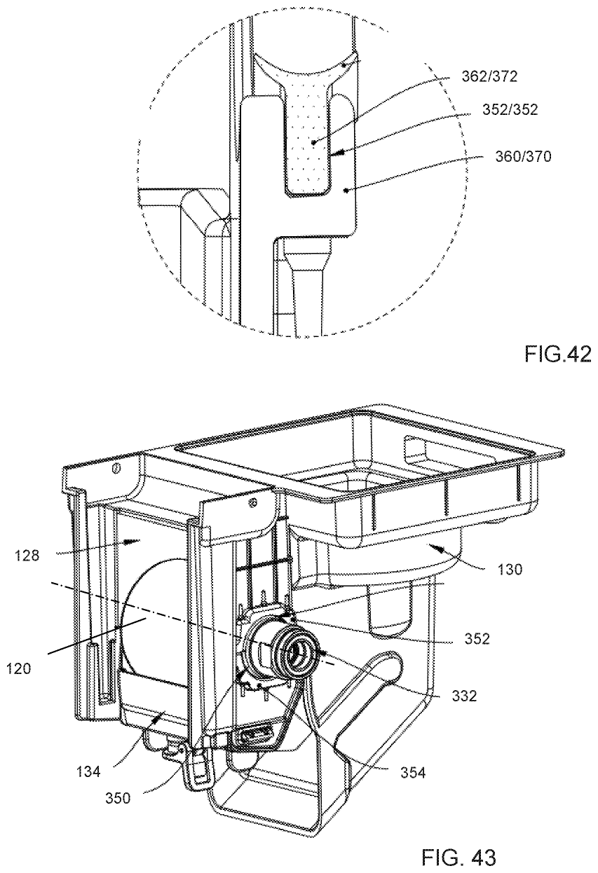

Referring to FIG. 42, in an embodiment, the flexible sealing lip 362, 372 can be press fitted into a groove formed in the radial surface of the rigid support body 360, 370. The sealing lips are held fixed to the rigid support bodies which are held stationary with respect to the mounting bosses by operation of the first and second fasteners. The flexible sealing lips 362, 372 can have the same concaved sealing profile described above.

Referring to FIG. 43, the rotary shaft journal 332 may protrude through the first and second holes 310, 312 defined by the cooperative connection of the first and second collar halves 352, 354 when arranged to product the seal assembly 350. The first and second collar halves 352, 354 are located on either circumferential side of the rotary shaft journal 332. The rotary shaft journal 332 may protrude axially in the rotation axis 122 from the seal assembly laterally outward of the housing liner assembly, for example, to be operatively connected with a drive motor.

### Liquid Holding Tray

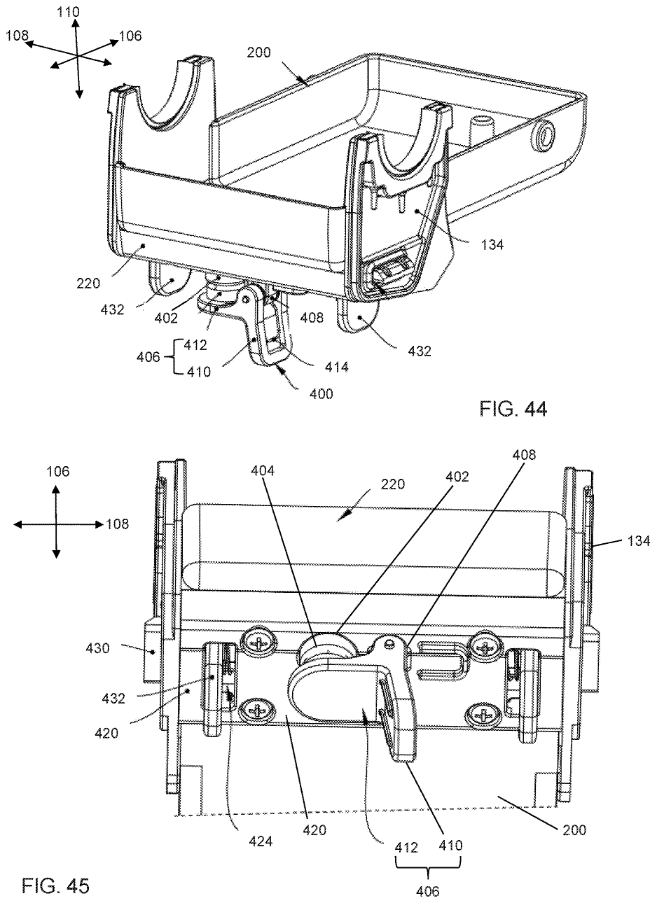

Referring to FIGS. 44 and 45, there is illustrated another embodiment of the liquid holding tray 134 for receiving and containing the liquid ingredients and the slush formed during the ice-making process. As described above, the liquid holding tray 134 can have a rectangular shape and includes a bottom planar floor and plurality of upright sidewalls that are joined at orthogonal angles to provide a tray bed 200. When the liquid holding tray 134 is installed in the housing cabinet, the evaporator drum is located vertically above the tray bed 200 and the circumference can be partly submerged into the liquid ingredients. The liquid holding tray 134 functions as a bath to apply the liquid ingredients to the surface of the evaporator drum. To align and guide the installation of the liquid holding tray 134 to the housing cabinet, two guide pins 210 can protrude laterally from the tray bed 200 in the lateral direction 108. The liquid holding tray 134 may also be associated with a release mechanism 220 attached to the underside of the tray bed 200. The release mechanism 220 can be a spring-loaded device actuated by hand to latch and release the liquid holding tray 134 to the housing cabinet.

As described above, the liquid holding tray 134 can include an overflow port 204 that can drain the overflow of liquid ingredients from the tray bed 200. In an embodiment, the overflow port 204 can be configured as a cylindrical pipe defining a fluid communication lumen that is disposed though the floor or underside of tray bed 200. In an embodiment, the liquid holding tray 134 may include a drain orifice that may be operatively associated with the overflow port 204 or may be separately disposed in the tray bed 200. To selectively open and close the overflow port or drain ports, a drain valve mechanism 400 can be included with the liquid holding tray 134. The drain valve mechanism 400 can be arranged to open and close the pipe end of the overflow port 204 that extends vertically downward from the underside of the tray bed 200. In the illustrated embodiment, the overflow port and/or drain port may be associated with an drain orifice 402 that extends vertically downwardly from the release mechanism 220, and the drain valve mechanism 400 can be attached to the release mechanism 220 to interact with the drain orifice 402, although in other embodiments, the structures may be directly attached to the underside of the tray bed 200.

By installing the drain valve mechanism 400 to the release mechanism 220 on the underside of the tray bed 200, rather than disposing it inside the overflow port 204 or coextensively inside of the tray bed 200, the drain valve mechanism 400 can be more readily cleaned and sanitized. The design completely avoids ingredient residue caused by complicated structure and numerous component gaps of the valve mechanism. Since the drain valve mechanism 400 is located outside the overflow port 204, its surface and the areas in contact with the overflow port 204 are easier to clean. During routine cleaning, residual ingredients can be thoroughly removed, and particularly viscous ingredients are less likely to accumulate. This effectively prevents bacterial growth and ensures the hygienic quality of the slush or ice cream. It also addresses the issue of difficult cleaning in existing designs where self-starting components are placed inside the draining portion, which affects hygiene.

Referring to FIGS. 44 and 45, the drain valve mechanism 400 is associated with the drain orifice 402 that may be fluidly connected to the overflow port 204 in the liquid holding tray 134 or may be disposed separately into tray bed 200. In an embodiment, the drain orifice can be structurally configured as a drain pipe that protrudes from the underside of the release mechanism 220. The drain orifice 402 is cylindrical and extends downwardly in the vertical direction 110. In other embodiments, the drain orifice 402 is disposed directly into the underside of the release mechanism 220.

To seal the orifice or lumen of the drain orifice 402, the drain valve mechanism 400 is equipped with a sealing element 404. The sealing element 404 can be made of a compressible material like elastic silicone or rubber to distort against and seal the drain orifice 402. The drain orifice 402 is sealed by either inserting the sealing element 404 into the liquid outlet orifice of the drain orifice or placing it over the outside of the liquid outlet orifice of the drain orifice 402 to occlude and seal the orifice. The liquid outlet orifice of the drain orifice 402 is opened by moving the sealing element 404 away from the drain orifice 402.

The sealing element 404 of the drain valve mechanism 400 is positioned outside the drain orifice 402 and closes the drain orifice 402 by either being partially inserted into it or by covering the outside of the liquid outlet orifice of the drain orifice 402. These configurations shield the drain orifice 402, ensuring that no small components or hidden gaps are present. When cleaning is required, the sealing element 404 can be detached from the drain orifice 402, allowing for direct cleaning of both the surface of the sealing element 404 and the inner and outer surfaces of the pipe structure associated with the drain orifice 402. There are no hard-to-reach cleaning areas due to complicated structures or concealed parts, and residual ingredients-particularly highly viscous ingredients—can be removed quickly and thoroughly.

To move the sealing element 404 to open and close the drain orifice 402, the drain valve mechanism 400 includes a lever arm 406 that is pivotally connected to a fulcrum seat 408. In an embodiment, the fulcrum seat 408 is fixedly attached to the bottom of the release mechanism 220 and the lever arm 406 is pivotally mounted to the fulcrum seat 408 for example by a pin hinge or pivot joint. In another embodiment, the fulcrum seat 408 can be directly attached to the underside of the tray bed 200.

The lever arm 406 may be a bent arm or crank arm and include a handle 410 and a driven head 412 that are interconnected at substantially 90° perpendicular angle. The sealing element 404 is an elastic sealing element and is mounted on the side of the driven head 412 facing the drain orifice 402. The position of the sealing element 404 corresponds to the position of the drain orifice 402. By rotating the handle 410, the driven head 412 rotates, causing the sealing element 404 to either seal the liquid outlet orifice of the drain orifice 402 or move away from it. The perpendicular angle of the lever arm 406 redirects the force applied to the handle 410 90° to move the driven head 412 with respect to the drain orifice 402. The handle 410 can be structurally adapted to be pressed by a user's finger to actuate the drain valve mechanism 400.

The handle 410 and the driven head 412 of the lever arm 406 are interconnected at an angle, for example, a substantially perpendicular angle, allowing rotation of the handle 410 to easily move the sealing element 404 attached to the driven head 412 away from the drain orifice 402, making the operation simple and labor-saving. The material inside the liquid holding tray 134 contacts only the surface of the sealing element 404 and does not substantially contact the lever arm 406. During cleaning, only the surface of the sealing element 404 needs to be cleaned, ensuring the cleaning process is simple, thorough, and free from ingredients residue.

In one embodiment, the drain valve mechanism 400 further includes a torsional elastic component 414. An example of the torsional elastic component 414 may be a torsion spring. The torsional elastic component 414 includes a main body and first and second torsional parts, which extend from opposite sides of the main body at an angle to each other. The main body is mounted about the fixed fulcrum seat 408, the first torsional part bears against the bottom surface of the release mechanism 220, and the second torsion arm bears against the handle 410.

When the drain orifice 402 is closed by the sealing element 404, the angle between the handle 410 and the driven head 412 and the bottom surface of the release mechanism 220 is smaller than the angle between the first and second torsional parts, causing the cooperation of the torsional parts to continuously urge the sealing element 404 against the drain orifice 402. This arrangement ensures that the sealing element 404 tightly closes the drain orifice 402, effectively preventing ingredients leakage during preparation and enhancing sealing reliability.

Due to the elastic characteristics of the torsional elastic component 414, the urging force remains stable and durable, unaffected by long-term use, thereby further ensuring stable sealing performance. When the drain orifice 402 is to be opened, the handle 410 is rotated away from the drain orifice 402, causing the angle between the first and second torsional parts to decrease, which moves the sealing element 404 away from the drain orifice 402. Releasing or reducing the force on the handle 410 allows the sealing element 404 to re-close the drain orifice 402 due to the resilience of the torsional elastic component 414.

In another embodiment, the torsional elastic component 414 may be configured as a living hinge which is operatively associated with the lever arm 406. The living hinge may be characterized by resilient shape member to bias the driven head 412 against the drain orifice 402 and which can be overcome by force applied to the handle 410 to move the driven head 412 away from the drain orifice 402.

The size of the sealing element 404 corresponds to the size of the drain orifice 402, allowing the sealing element 404 to close the drain orifice 402 through elastic deformation. This design achieves tight sealing, prevents ingredients leakage, and accommodates minor dimensional deviations of the liquid outlet orifice, thereby improving sealing adaptability and reliability. Preferably, the end of the sealing element 404 facing the drain orifice 402 is smaller than the liquid outlet orifice of the drain orifice 402, whereas the side of the sealing element 404 remote from the draining portion is larger than the liquid outlet orifice of the drain orifice 402. This configuration allows one end of the sealing element 404 to be partially inserted into the liquid outlet orifice, while the other end remains outside, thereby achieving an effective sealing performance.

To improve cleaning, the drain valve mechanism 400 can be operatively associated with the release mechanism 220 and can be removed from the tray bed 200. As described above, the release mechanism 220 can be a spring-loaded mechanism that can be actuated to attach and detach the liquid holding tray 134 to the housing cabinet allowing installation and removal of the liquid holding tray 134. For example, the release mechanism 220 can include movable latching members that are moveably reciprocal with respect to the lateral direction 108 and can extend and retract beyond the lateral sides of the tray bed 200 to engage and disengage corresponding features in the cabinet interior of the housing cabinet. The spring-loaded latching members of the release mechanism 220 can be manipulated by hand to move in the lateral direction 108 to release the liquid holding tray 134.

In the illustrated embodiment, the release mechanism 220 can include a cover seat 420 that can be mounted to the underside of the tray bed 200 of the liquid holding tray 134. The cover seat 420 functions to cover and protect the spring-biased latch members of the release mechanism 220. The cover seat 420 can be attached to the tray bed 200 by threaded fasteners although other attachment means may be used. The cover seat 420 can extend in the lateral direction 108 coextensive with the lateral edges of the tray bed 200. The drain valve mechanism 400 can be operatively attached to the cover seat 420.

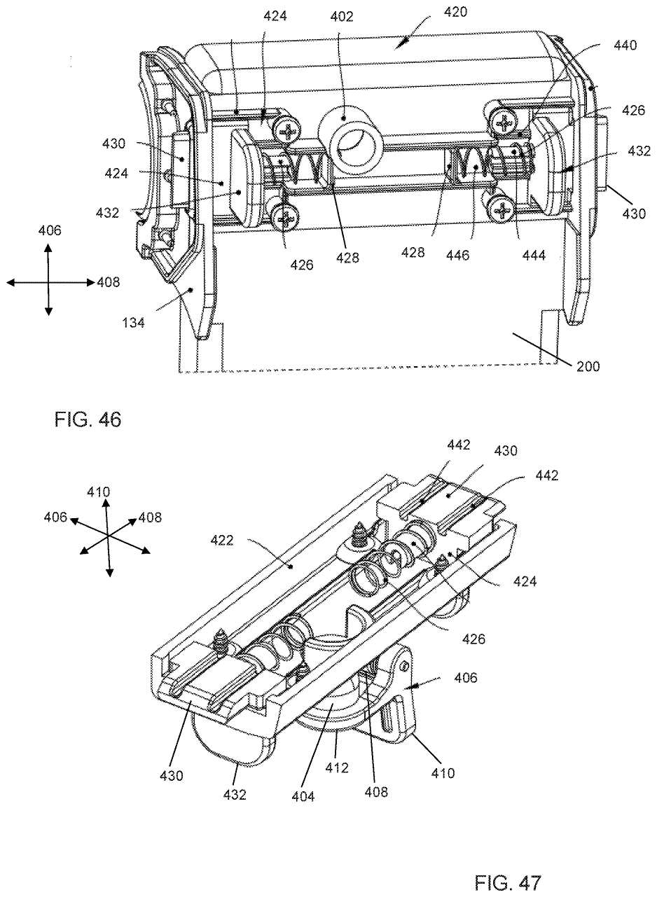

Referring to FIGS. 46 and 47, the cover seat 420 can have a trough-like structure and can define a sliding cavity 422 that extends in the lateral direction 108. When the cover seat 420 is mounted to the underside of the tray bed 200, the sliding cavity 422 is enclosed by the structures. The latch members 424 can be slidably mounted inside the sliding cavity 422 and are configured to reciprocally move with respect to the lateral direction. The latch members 424 are rigid parts, for example, made of molded plastic, and can securely engage with a corresponding structural catch or slot to secure the liquid holding tray 134 in place. To bias the latch members 424 in the lateral direction 108, an elastic member 426 can be disposed inside the sliding cavity 422 and aligned with the lateral direction 108.

The elastic member 426 provides telescopic driving force, and the latching member 424 performs connection or separation with the machine body, so that functions are clearly divided. When the elastic member 426 develops non-recoverable deformation or damage after long-term repeated telescopic movement, only the elastic member 426 is replaced individually, and the whole release mechanism 220 is not required to be replaced, whereby replacement cost is substantially reduced. The elastic member 426 is selected from common elastic members having strong universality, is not limited by model differences of cold-drink apparatus, and can be easily purchased even after equipment upgrading, whereby replacement and maintenance procedures are greatly simplified, and problems of high replacement cost and scarce spare parts existing in the integrally formed disassembly-assembly member are solved.

In an embodiment, the elastic member 426 can be a helical coils spring comprised of successive helical windings that can expand and contract along the axial length of the coil spring. The elastic member 426 can be made of metal, and a metal elastic member 426 exhibits superior long-term stability. In existing disassembly-assembly members for feeding devices, a fixed part, a telescopic sub-portion and a latching sub-portion are integrally formed and are usually made of plastic; the plastic telescopic sub-portion easily creeps under long-term repeated force and develops permanent deformation, whereby the feeding tray cannot be normally fixed. Because the liquid holding tray 134 is applied in a cold-drink apparatus and is used for preparing slush, the telescopic sub-portion of the disassembly-assembly member is kept in a low-temperature working environment for a long time; the low-temperature environment easily reduces flexibility of the plastic telescopic sub-portion, expected elastic deformation is difficult to generate under force, a larger force is required to compress the telescopic sub-portion in order to remove the feeding device, and in severe cases the telescopic sub-portion cracks due to increased brittleness, whereby the entire disassembly-assembly member is scrapped.

To cause the elastic member 426 to bias against the moveable latch member 424, a pressing plate 428 can be arranged inside the sliding cavity 422. The pressing plate 428 can be a planar plate or panel perpendicular to the lateral direction and oriented in the vertical direction 110 and that extends vertically downward from the underside of the tray bed 200, although the pressing plate 428 can also be integral to the cover seat 420. One end of the elastic member 426 abuts against the latching member 424, the other end of the elastic member 426 abuts against the pressing plate 428, so that elastic deformation of the elastic member 426 drives the latching member 424 to slide in the lateral direction 108 along the length of the sliding cavity 422, whereby one end of the latching member 424 opposite the elastic member 426 selectively extends outward beyond a lateral edge of the tray bed 200 to engage a correspond feature of the housing cabinet or can be retracted into the sliding cavity 422 and disengages from housing cabinet. The latching members 424 are engaged or disengaged, and attachment and removal of the liquid holding tray 134 is thereby achieved.

In an embodiment, the latching member 424 can be an L-shaped structure and can include a securing tab 430 and a finger tab 432 that are orthogonally arranged and perpendicularly joined together. When installed in the cover seat 420, the finger tab 432 is vertically arranged at a bottom of the securing tab 430 and protrudes outward beyond the sliding cavity 422, and one end of the elastic member 426 abuts against the finger tab 432. The securing tab 430 can be generally flat and parallel with the underside of the tray bed 200.

To constrain the lateral movement of the latching member 424, the tray bed 200 of the liquid holding tray 134 includes a lateral hole 434 that is disposed in the lateral side of the tray bed 200. The lateral hole 434 is aligned with the sliding cavity 422 and oriented in the lateral direction 108. The lateral hole 434 may have a slot-like shape and is longer in the longitudinal direction 106 than tall in the vertical direction 110. Lateral holes 434 can be located at both lateral sides of the tray bed 200 and opposite lateral ends of the sliding cavity 422. The lateral hole 434 is arranged so that the securing tab 430 of the latch member 424 moves toward and away from the lateral hole 434.

In an embodiment, the securing tab 430 can include a protruding portion 436 and a limiting portion 436 that are sequentially joined in the lateral direction 108. The limiting portion 438 is wider than the protruding portion 436 and the lateral hole 434 disposed in the tray bed at the end of the sliding cavity 422. When the latching member 424 is moved laterally toward the lateral hole 434, the narrower protruding portion 436 moves through the lateral hole 434 and the wider limiting portion 438 abuts against the structure in which the lateral hole 434 is formed. The limiting portion 438 limits movement of the latch member 424 to the sliding cavity 422.

The latching member 424 is composed of the securing tab 430 and the finger tab 432, and functions of the securing tab 430 and the finger tab 432 are clearly divided and cooperate smoothly. The finger tab 432 is arranged vertically at the bottom of the securing tab 430 and projects outside the sliding cavity 422. This design allows the user to directly operate it by hand without tools, easily driving the securing tab 430 of the latching member 424 to extend or retract with respect to lateral holes 434 at the ends of the sliding cavity 422, thereby greatly simplifying the mounting and demounting procedure of the liquid holding tray 134 and significantly improving operational convenience.

The tray bed 200 is formed with the lateral hole 434, the protruding portion 436 extends through the lateral hole 434, and the lateral hole 434 guides a sliding direction of the protruding portion 436 so that the protruding portion 436 accurately engages with corresponding feature arranged in the cabinet interior of the housing cabinet. When the elastic member 426 expands and contracts, the protruding portion 436 stably projects from or retracts into the lateral hole 434, reliable connection with or separation from the slots of the machine body is achieved, and unstable connection caused by latching offset is avoided.

In the illustrated embodiments, two latching members 424 are located in a symmetrical arrangement in the cover seat 420 and moveable in the lateral direction 108 in the sliding cavity 422. The latching members 424 are symmetrically opposed to each other and can be biased in opposite lateral directions by the elastic members 426. To release the liquid holding tray 134, the finger tabs 432 of the two latching members 424 can be pressed laterally together to overcome the biasing forces of the elastic members 426 and retract the securing tabs 430 into the lateral holes 434. When the fingers tabs 432 are released, the elastic member 426 urge the latching members 424 to laterally move in the sliding cavity 422 and cause the securing tabs 430 to protrude from the lateral holes 434.

In an embodiment, a guide rib 440 protrudes downwardly within the sliding cavity 422. The guide rib 440 is arranged in a straight line, and its extending direction is aligned with the sliding direction of the latching members 424. A guide groove 442 is recessed inwardly on the side of the securing tab 430 facing the tray bed 200, and the guide groove 442 slidably engages with the guide rib 440. Through the sliding engagement between the guide rib 440 and the guide groove 442, when the elastic member 426 undergoes elastic deformation, the securing tab 430 is guided to perform linear movement along the guide rib 440, thereby avoiding sliding offset of the latching member 424, enhancing its sliding stability, and ensuring accurate alignment with the slots of the machine body.

In an embodiment, a mounting prong 444 is provided on the finger tab 432 of the latching member 424 facing the pressing plate 428. The end of the elastic member 426 facing the latching member 424 is fitted over the outer periphery of the mounting prong 444 and abuts against the finger tab 432. An elastic limiting slot 446 having a size matching the elastic member 426 is provided on a side of the sliding cavity 422 away from the finger tab 432, and an end of the elastic member 426 away from the finger tab 432 is mounted in the elastic limiting slot 446 and abuts against the pressing plate 428.

Through the cooperation between the mounting prong 444 and the elastic limiting slot 446, the elastic member 426 is restrained in both directions. This prevents the elastic element 426 from shifting, tilting, or detaching during expansion and contraction. It ensures that force is consistently applied in a predetermined direction, thereby enhancing the accuracy of the movement of the latching member 424. The two ends of the elastic member 426 abut against the latching member 424 and the pressing plate 428, thereby ensuring uniform force distribution, reducing local wear, and prolonging the service life.

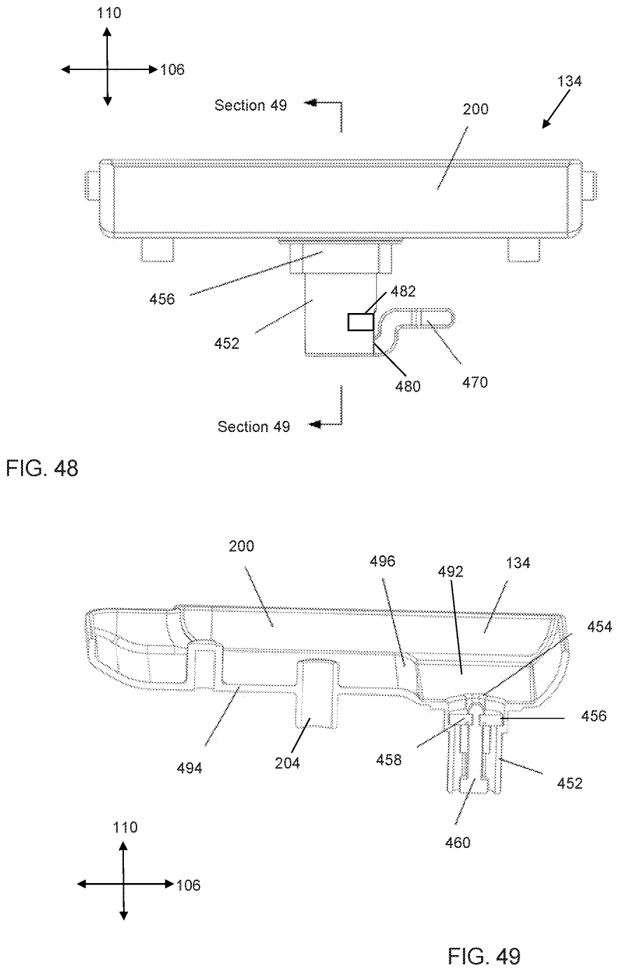

Referring to FIG. 48, there is illustrated another embodiment of a drain valve mechanism 450 that can be operatively controlled to drain liquid from the liquid holding tray 134. The drain valve mechanism 450 can be attached to the underside of the tray bed 200 and extends downwardly in the vertical direction 110. The drain valve mechanism 450 can be located laterally central of the tray bed 200 so liquid ingredients may flow toward it due to gravity and may be located toward the longitudinal forward edge of the tray bed 200 for accessibility. Referring to FIG. 48, the drain valve mechanism 450 can be separate from the overflow port 204 disposed in the tray bed 200 although in possible embodiments the two features can be combined.

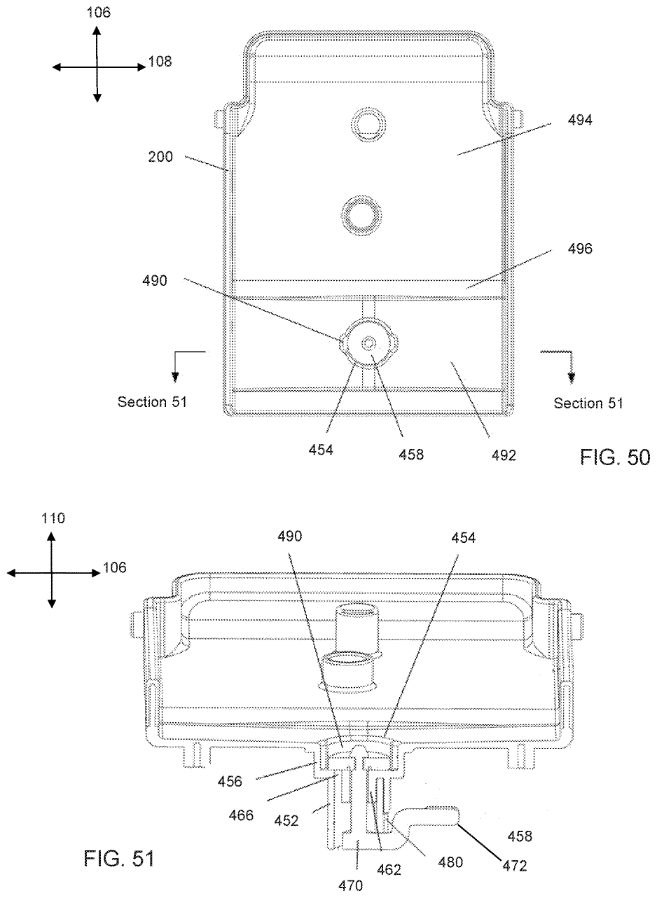

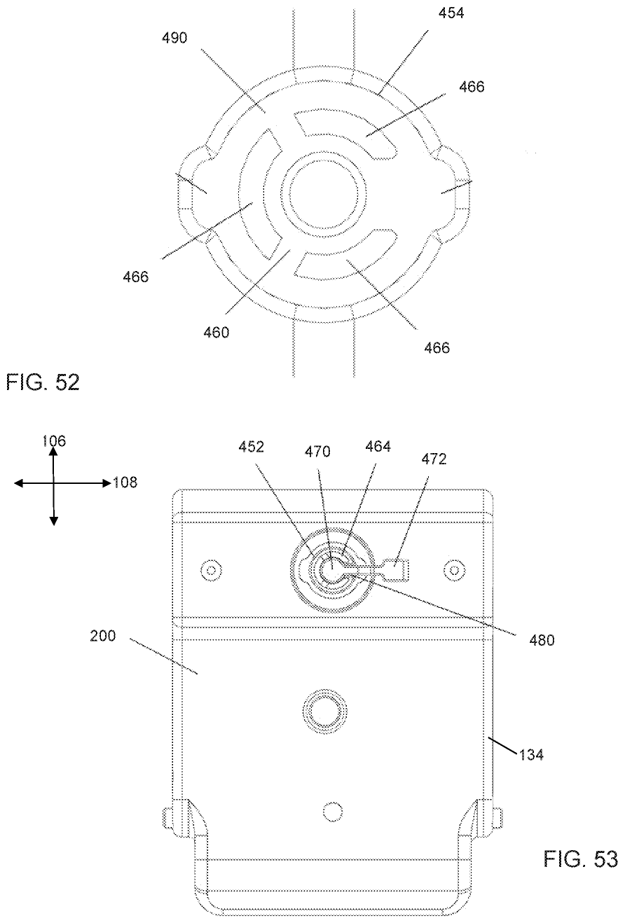

Referring to FIGS. 49-51, the drain valve mechanism 450 includes a drain pipe 452 that is connected to the underside of the tray bed 200 and fluidly communicates with a drain pipe 452 that is disposed into the tray bed 200. The drain pipe 452 can be cylindrical and defines a fluidly accessible lumen and the drain port 454 can be an circular opening or aperture that is fluidly connected to the lumen of the drain pipe 452. The drain pipe 452 may be integrally formed with the tray bed 200 or may be a separate component attached to the tray bed, for example, by a threaded connection.

To open and close the drain valve mechanism 450, the drain pipe 452 may include a valve seat 456 that is internally formed in the lumen and that is operatively associated with a valve element 458. The valve seat 456 may be a flat surface orthogonal to the axial direction of the drain pipe 452 and the valve element 458 can be a circular disc that can adjacently abut against the valve seat 456 and thus functions as a poppet valve to occlude the drain pipe 452. The valve element 458 can comprise a compressible or elastomeric material and can make sealing contact with the flat surface of the valve seat 456. Contact between the valve seat 456 and the valve element 458 blocks the drain pipe 452 and prevents fluid flow through the drain valve mechanism 450.

To control opening and closing, the drain valve mechanism 450 includes a valve control member 460. The valve control member 460 can be embodied as a rod that is located in the lumen defined by the drain pipe 452 and the is axially movable in the vertical direction of the drain pipe 452. The valve element 458 is provided at and fixed to the distal end of the valve control member 460. When the valve control member 460 is moved axially within the drain pipe 452, the valve element 458 may be moved apart from or against the valve seat 456 thereby achieving opening or closing of the drain valve mechanism 450.

In operation, in a initial state, the sealing element 458 is pressed tightly against the valve seat 456 under hydraulic action, preventing fluid communication through the drain pipe 452. When the user actuates the valve control member 460 to move the sealing element 458 against the hydraulic pressure, the valve seat 456 and the lumen of the drain pipe 452 become fluidly connected, allowing liquid within the liquid holding tray 134 to flow sequentially through the drain port 454, valve seat 456, and drain pipe 452 for drainage, achieving liquid drainage from the tray bed 200. The structure is simple, easy to operate, and highly efficient.

Referring to FIGS. 49 and 51, to guide axial movement of the valve control member 460, a support bracket 462 can be located within the drain pipe 452 and the valve control member 460 is moveably connected to the support bracket 462. The drain pipe 452 is provided with a drain chamber 464 that penetrates both end faces of the drain pipe 452. The support bracket 462 is positioned within the drain chamber 464 and is provided with a liquid passage 466, through which the drain port 454 communicates with the drain chamber 464.

The valve control member 460 pass axially through the support bracket 462, and the valve element 458 is mounted on the support bracket 462. The valve element 458 can cover the liquid passage 466, preventing communication between the drain port 454 and the liquid-passage 466, thereby closing the drain valve mechanism 450. When the valve control member 460 is driven to axially move the valve element 458 upward, the liquid passage 466 is opened, allowing the liquid within the tray bed 200 to sequentially flow through the drain port 454, the liquid-passage 466, and the drain chamber 464, and finally be discharged through the lumen of the drain pipe 452. The provision of the support bracket serves to support the seal-release sub-assembly. The structure is simple, easy to operate, and highly efficient.

Referring to FIGS. 51 and 53, the valve control member 460 may include a stem 470 and a valve-actuating handle 472. The valve stem 470 can be a rod-like structure and the valve-actuating handle 472 can extend perpendicularly from the valve stem 470. To attach to the valve element 458, the valve stem 470 can include a circumferential recess 474 toward one end. The valve element 458 can be shaped as a disk with a central aperture and can be pressed over the valve stem 470 to fit within the circumferential recess 474. The valve element 458 is axially fixed to the valve stem 470 can moves with displacement of the valve control member 460. Referring to FIGS. 51 and 53, when the drain valve mechanism 450 is assembled, the valve stem 470 is concentrically disposed inside the drain pipe 452 and can move axially in the drain pipe 452 causing movement of the valve element 458 attached to the circumferential recess 474. The valve element 458 is thus displaced with respect to the drain port 454 in the tray bed 200.

The valve-actuating handle 472 can be shaped to facilitate manipulation by an operator. For example, referring to FIG. 55, the valve-actuating handle 472 can comprise a connecting part 476, a positioning part 477, and a hand grip part 478. The connecting part 476 connects perpendicularly to the valve stem 470, the positioning part 477 extends sequentially and perpendicularly from the connecting part 476 and the hand grip part 478 extend sequentially and perpendicularly from the connecting part 476. The connecting part 476 and the hand grip part 478 are parallel and offset from each other. The height of the connecting portion 476 is lower than that of the hand-grip portion 478, resulting in the valve-actuating handle 472 forming a structural shape similar to a “Z”.

In other words, there is a certain angle between the limiting portion and the hand-grip portion, allowing the user's fingers to be placed between them for anti-slip purposes, facilitating better manipulation of the valve control member. There is also a certain angle between the connecting part and the positioning portion. When the valve-actuating handle is pushed to the top of the clearance notch, the limiting portion will abut against the outer sidewall of the liquid discharge pipe. The cooperation of the connecting arm and the limiting portion with the liquid discharge pipe from two different angles, along with the limiting effect of the clearance notch on both sides of the connecting arm, effectively positions the valve-actuating handle both horizontally and vertically, further ensuring its movement in a predetermined direction and thereby guaranteeing the accuracy of opening or closing the drain port by the sealing element.

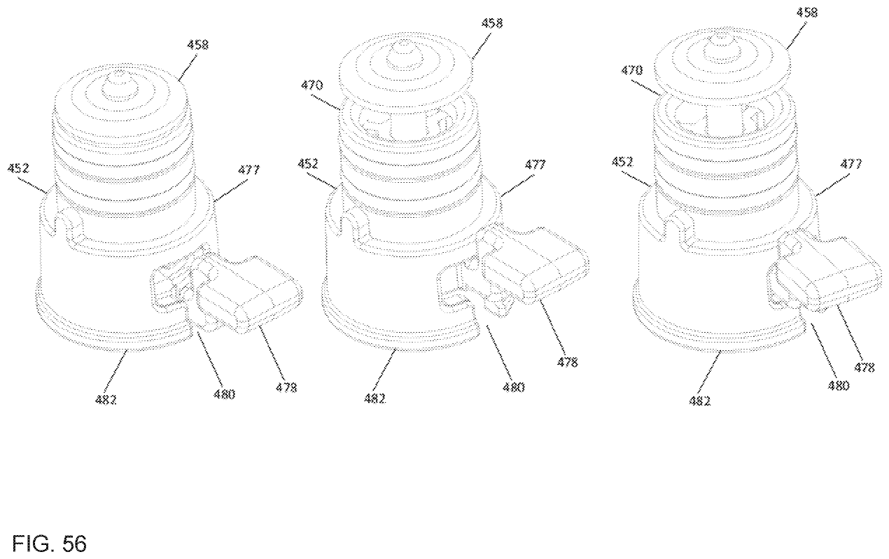

Referring to FIG. 56, the drain pipe 452 can have an axial notch 480 that is disposed through the cylindrical wall of the drain pipe 452 in the axial direction. The axial notch 480 can be formed as a groove or slot disposed through the drain pipe 452. The valve actuating handle 472 extends through the axial notch 480 such that the hand grip part 478 is located externally of the drain pipe 452 and is connected to the valve stem 470 concentrically disposed in the drain pipe 452 by the positioning part 477 that extends through the axial notch. The user can place their finger against the hand grip part 478 of the valve actuating handle 472 to move the valve control member 460 axially upward in the drain pipe 452. The axial notch 480 enables the vertical movement of the valve actuating handle 472 located externally of the drain pipe 452 and which is connected by the connecting part 476 to the stem 470 disposed internally of the drain pipe 452. Movement of the valve actuating handle 472 along the axial notch 480 causes the valve stem 470 to move the valve element 458 attached thereto to move with respect to the valve seat 456 inside the drain pipe 452.

In an embodiment, the axial notch 480 is connected with a radial notch 482 that is also disposed through the cylindrical wall of the drain pipe 452. The radial notch 482 extends partially about the circumference of the drain pipe 452. When desired to keep the drain valve mechanism in a fluidly opened state, the valve actuating handle 472 can be rotated with respect to the axial direction of the drain pipe 452 to move the valve actuating handle 472 into the radial notch 482. The location of the radial notch 482 corresponds to the displaced position of the valve element 458 from the valve seat 456. Hydraulic forces of the liquid ingredients pressing against the valve element 458 are transferred to through the valve stem 470 to the valve actuating handle 472 causing it to be retained in the radial notch 482. Movement of the valve actuating handle 472 sequentially through the axial and radial notches 480, 482 functions as a bayonet lock holding the drain valve mechanism 450 in the opened position. To close the drain valve mechanism 450, the valve actuating handle 472 can be rotated back out of the radial notch 482 and allowed to axially drop in the axial notch 480, moving the valve element 458 back into contact with the valve seat 456 inside the drain pipe 452 fluidly closing the drain valve mechanism 450.

The drain valve mechanism 450 allows intermittent draining of the tray bed 200 by temporarily moving the valve actuating handle 472 upwardly in the axial notch 480 then releasing the valve actuating handle 472. The drain valve mechanism 450 also allows more complete draining of the tray bed 200 by rotating the valve actuating handle 472 into the radial notch 482 where the valve actuating handle 472 is restrained against axial movement and the valve element 458 remains displaced from the valve seat 456. When the valve actuating handle 472 is positioned in the radial notch 482, the drain valve mechanism 450 is maintained and secured in the opened configuration enabling through and complete draining of the liquid holding tray 134.

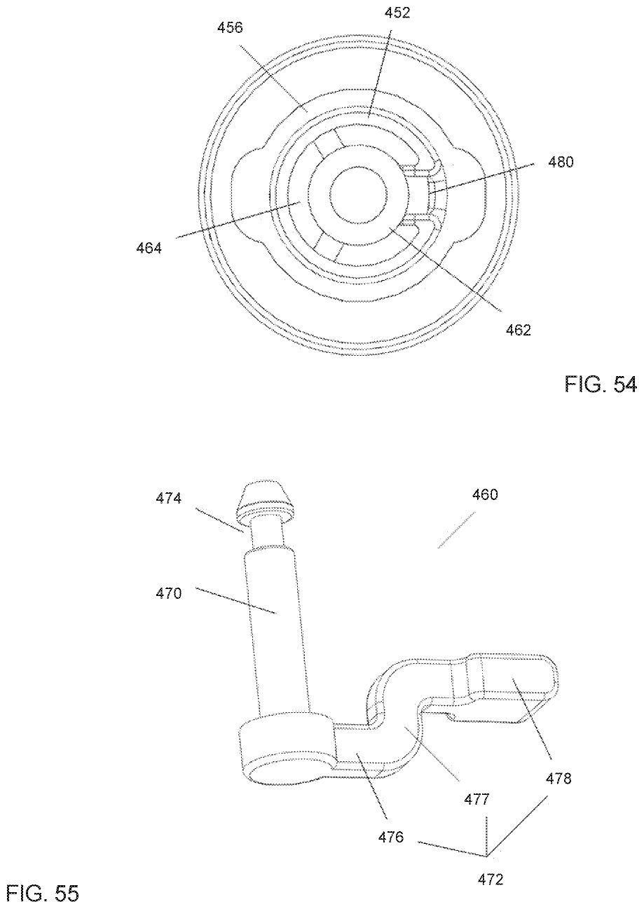

Referring to FIG. 54, the valve seat 456 is provided with a sealing groove 490, the opening of which is connected to the drain port 454. That is, the drain port 454, the sealing groove 490, the liquid passage 466), and the drain chamber 464 are sequentially connected. The valve stem 470 penetrates the sealing groove 490 and the drain chamber 464. Specifically, the support bracket 462 is positioned on the bottom wall of the sealing groove 490. When the sealing element 458 is subjected to hydraulic action, it adheres closely to the bottom wall of the sealing groove 490, covering the support bracket 462 and its liquid passage 466, preventing communication between the sealing groove 490 and the drain pipe 452 and thereby preventing the liquid from being discharged through the drain valve mechanism 450. When the valve control member 460 is driven to move the valve element 458 upward, the liquid passage 466 is opened, allowing the sealing groove 490 to communicate with the liquid passage 466, enabling the liquid to flow into the liquid passage 466 and thereby allowing the liquid within the liquid holding tray 134 to be discharged through the drain pipe 452.

Preferably, the inner sidewall of the sealing groove 490 is provided with a drain groove that communicates with the drain port 454. The valve element 458 is positioned within the sealing groove 490, and the liquid flows into the sealing groove 490 through the drain port 454, directly acting on the top of the valve element 458, with most of the pressure being applied to the top of the valve element 458, pressing it downward. If the liquid volume is large and the hydraulic pressure is high, a greater force is required to push the valve element 458 upward via the valve control member 460, making it difficult or even impossible to push the valve element 458 upward, which is time-consuming and laborious. The provision of the drain groove allows some of the liquid to flow to the side of the sealing element, dispersing the force acting on the top of the valve element 458 and facilitating user manipulation. During the process of lifting the valve element 458, it also enables the liquid to quickly flow into the liquid passage 466 through the side of the valve element 458, accelerating the drainage speed and improving drainage efficiency.

Referring to FIG. 49, the tray bed 200 of the liquid holding tray 134 can be provided with a depression 492. The depression 492 is disposed lower than the planar floor 494 of the liquid holding tray 134 so that the liquid ingredients flow toward the depression 492. The drain port 454 that fluidly communicates with the drain valve mechanism 450 is disposed in the depression 492. The elevational difference created by the depression 492 causes the liquid ingredients to flow more readily to the drain port 454 and out the drain valve mechanism 450. The depression 492 and the planar floor 494 of the tray bed 200 can be joined by a curved guide surface 496 to change the elevation of the tray bed 200.

As disclosed above, the liquid holding tray 134 can be attached to the refrigeration machine at an oblique angle with respect to the longitudinal direction 106 causing the liquid ingredients to flow longitudinal forward. The sloped arrangement of the liquid holding tray 134 directs the liquid ingredients to the depression 492 in the tray bed 200 to flow toward the drain valve mechanism 450 therein to more completely empty and drawing the tray bed.

### Evaporator Drum

Referring to FIG. 4, the evaporator drum 120 is a typically a cylindrical structure located in the ice-making region 128 that extends horizontally in the lateral direction 108 and that is configured to rotate with respect to the rotational axis 122 aligned parallel with the lateral direction 108. The evaporator drum 120 is located above the liquid holding tray 134 and is spaced so that the lower circumferential segment of the cylindrical structure is submerged in the liquid ingredients contained in the liquid holding tray 134. The evaporator drum 120 is operatively associated with the refrigeration system so that cylindrical surface is significantly cooled below the freezing point of the liquid ingredients. The liquid ingredients freeze and adhere to the cylindrical surface of the evaporator drum 120 as it rotates with respect to the liquid holding tray 134.

To decrease the temperature, the evaporator drum 120 corresponds with evaporation function of a typical refrigeration cycle. For example, the evaporator drum 120 may be a hollow cylinder that fluidly receives a compressed liquid refrigeration under pressure. The liquid refrigerant undergoes an endothermic phase changes and evaporates within the evaporator drum 120 thereby absorbing heat and reducing the temperature of the cylindrical surface of the cylindrical structure. The refrigerant, which is now in a vapor phase, is fluidly removed from the evaporator drum 120 and returned to a compressor that increases the pressure. The pressurized refrigeration vapor is fluidly directed through a condenser which functions as an exothermic heat exchanger to discharge the heat energy absorbed and removed from the evaporator drum 120.

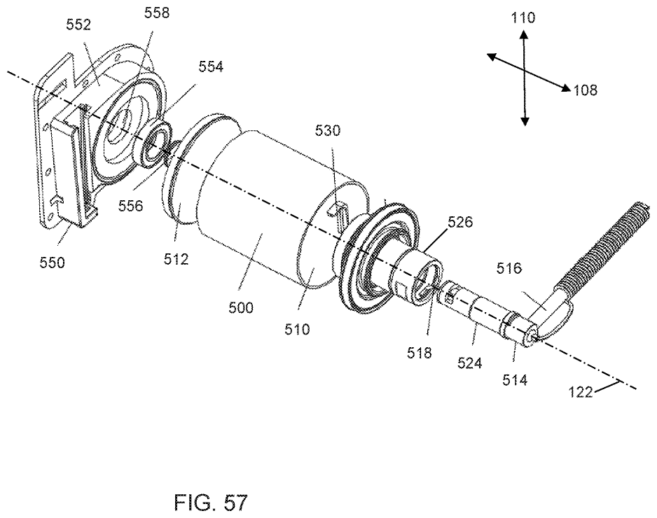

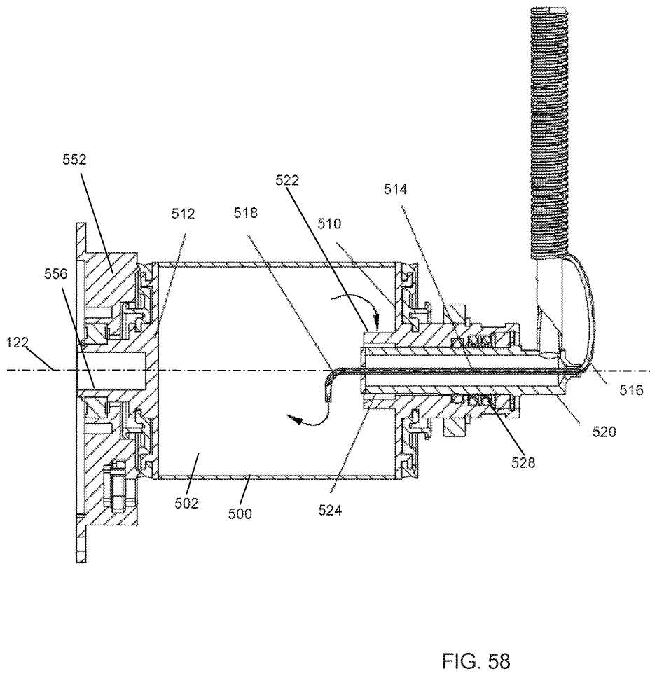

Referring to FIGS. 57 and 58, in an embodiment, the evaporator drum 120 is a structural cylinder 500 that defines an internal evaporation chamber 502, although in other embodiments different geometric shapes are contemplated. To fluidly direct the compressed liquid refrigeration into structural cylinder 500, the evaporator drum 120 is associated with a refrigerant introduction pipe 504 fluidly communicating with the evaporation chamber 502 and to remove the vapor refrigerant, the evaporator drum 120 is associated with a vapor return pipe 506 fluidly communicating with the evaporation chamber 502. The refrigerant introduction pipe 504 and the vapor return pipe 506 may be rigid tubes or possibly flexible hoses to fluidly channel and conduct the refrigerant.

During operation, the liquid refrigerant introduced by the refrigerant introduction pipe 504 evaporates inside the evaporation chamber 502 and absorbs heat for cooling inside the structural cylinder 500 so that the circumferential surface of the structural cylinder 500 performs cooling and ice-making. The refrigerant introduction pipe 504 is in communication with an external condenser or a throttling component. When the refrigerant introduction pipe 504 is in direct communication with the external condenser, the refrigerant introduction pipe 504 is preferably constructed as capillary tube having a throttling function. The throttling function controls the pressure and delivery of liquid refrigerant into the evaporation chamber 502 by the refrigerant introduction pipe 504. The vapor return pipe 506 is in fluid communication with an external compressor and is configured to allow the refrigerant, after evaporating inside the evaporation chamber 502, to return to the compressor for a next cycle.

To enclose the evaporation chamber 502, a first axial cover 510 is provided on one end of the structural cylinder 500 and is fixed thereto. When the evaporator drum 120 rotates about the rotational axis 122, the first axial cover 510 synchronously rotates with the structural cylinder 500. A second axial cover 512 may be provided at the second end of the structural cylinder 500 laterally opposite of the first axial cover 510 and parallel thereto. The second axial cover 512 is also fixedly attached to rotate with the structural cylinder 500.

In an embodiment, the refrigerant introduction pipe 504 and the vapor return pipe 506 both communicate with the evaporator chamber 502 through the first axial cover 510 of the structural cylinder 500 of the evaporator drum 120. The refrigerant introduction pipe 504 may be associated with an introduction section 514 that is physically configured to traverse and pass through the first axial cover plate and extends into the evaporator chamber 502. The introduction section 514 may be comprised of rigid pipes and hoses of a diameter adapted to convey the liquid refrigerant. For example, the introduction section 514 includes a connecting conduit 516 that is fluidly connected to the refrigerant introduction pipe 504 and an introduction conduit 518 located inside the evaporator chamber 502.

The introduction conduit 518 passes through the first axial cover 510 and communicates with the evaporator chamber 502. The introduction conduit 518 may extend concentrically into the structural cylinder 500 and may be coaxially aligned with the rotational axis 122 of the evaporator drum 120. In an embodiment, the distal end of the introduction conduit 518 may be bent normal to the rotational axis 122 toward the circumferential surface of the structural cylinder 500. The terminal portion of the introduction conduit 518 forms a “7-shaped” configuration, and the refrigerant is ejected from the introduction conduit 518 toward the circumferential wall of the structural cylinder 500. This enables rapid diffusion and evaporation of the refrigerant within the evaporation chamber 502. The liquid refrigerant vaporized on the internal surfaces of the structural cylinder 500 rapidly cooling the exterior of the evaporator drum below the freezing point.

To remove the vaporized refrigerant, a return gas section 520 associated with the vapor return pipe 506 is connected to the structural cylinder 500 and is in communication with the evaporation chamber 502. The return gas section 520 is disposed through the first axial cover 510 and includes a return gas hole 522 that is exposed within the evaporation chamber 502 thereby allowing evaporated refrigerant to return to the vapor return pipe 506. In an embodiment, the return gas section 520 is configured to pass through the axial center of the first axial cover 510 and is coaxially aligned with the rotational axis 122 of the evaporator drum 120. The return gas section 520 may locationally correspond with the centrally aligned location of the introduction conduit 518 and the two features may cooperatively extend through the center of the first axial cover 510. The introduction conduit 518 and the return gas section 520 can be parallel and coaxially aligned with each other.

For example, to traverse the axial center of the first axial cover 510 fixed to the evaporator cylinder 500, the return gas section 520 comprises a return gas connecting tube 524 and a return gas communication sleeve 526. The return gas communication sleeve 526 is fixedly attached to the first axial cover 510 and is axially aligned to the rotational axis 122. The return gas communication sleeve 526 defines a lumen or opening through the first axial cover 510 into the evaporator chamber 502. The return gas connecting tube 524 is concentrically disposed in the return gas communication sleeve 526 and coaxially aligned with the rotational axis 122. The return gas connecting tube 524 and the return gas communication sleeve 526 are rotatably connected to each other by a plurality of bearings 528 and rotate relative to each other with respect to the rotational axis 122. The return gas communication sleeve 526 can rotate in fixed relation with the evaporator drum 120 round the rotational axis 122 and the return gas connecting tube 524 remains stationarily fixed in relation to the vapor return pipe 506.

The return gas hole 522 is formed at the terminal ends of the return gas connecting tube 524 and the return gas communication sleeve 526 disposed inside the evaporator chamber 502 and allow the vaporized refrigerant to flow and return to the vapor return pipe 506.

In an embodiment, the introduction conduit 518 is fixed to the return gas connecting tube 524. The introduction conduit 518 passes through the return gas section 520 and is connected to the return gas connecting tube 524. Through an axial nesting structure, the introduction section 514 and the return gas section 520 are formed in a coaxial integrated layout, characterized in that the refrigerant delivery path of the introduction conduit 518 is entirely housed within the tube cavity of the return gas connecting tube 524. The introduction conduit 518 and return gas connecting tube 524 are held against relative rotation with respect to the return gas communication sleeve 526 by the plurality of bearings 528.

This eliminates the need for additional external piping, thereby substantially reducing lateral or radial space occupation of the overall evaporator structure. Furthermore, the tube wall of the return gas section 520 operatively serves as a mechanical support carrier for the introduction conduit 518, such that the refrigerant flows from the introduction section 514 to the evaporation chamber 502 directly through the interior lumens and paths of the return gas section 520. This eliminates the bending space required in traditional separate pipe layouts, thereby achieving compactness of the axial dimension of the evaporator and further reducing overall apparatus volume so as to meet the requirements of household devices. In addition, due to the coaxial integrated layout, resistance to refrigerant flow in the introduction section 514 and the return gas section 520 is reduced relative to traditional spiral-wound layouts, thereby balancing fluctuations in inlet pressure and return pressure and enhancing heat-exchange efficiency within the evaporation chamber 502.

During operation, the refrigerant may entrain the lubricating oil migrating from the lubricant used to lubricate components such as the condenser and the evaporator. If the lubricating oil that migrates into these components cannot be effectively returned, the amount of lubricating oil in the compressor will continue to decrease, eventually causing wear of the compressor and reducing service life. Moreover, the lubricating oil may enter the structural cylinder 500 together with the refrigerant and remain inside the evaporator chamber 502. Lubricating oil adhering to inner walls of the evaporator increases the thermal resistance of the condenser or the evaporator and adversely affects heat-transfer performance.

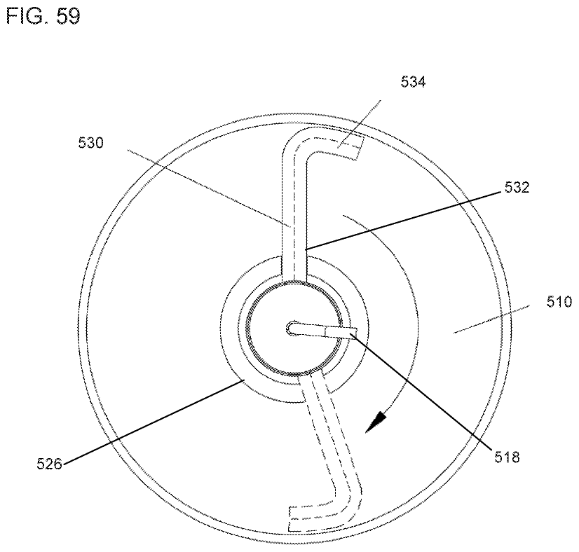

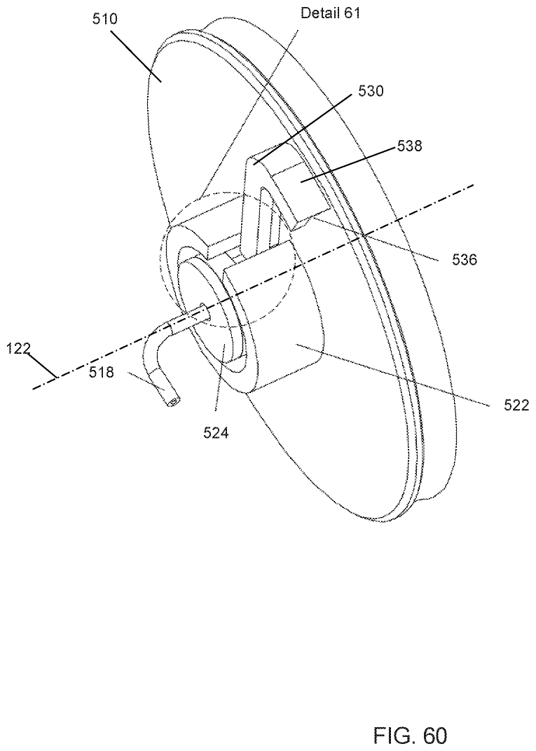

Referring to FIGS. 59 and 60, to improve an oil-return efficiency of the refrigerant inside the structural cylinder 500, an oil-return conduit 530 is provided within the evaporator chamber 502. When an inlet end of an oil-return conduit 530 moves to a high position due to fixed rotation with the structural cylinder 500 about the rotational axis 122, an outlet end of the oil-return conduit 530 is able to communicate with the return gas section 520. An inlet end of the oil-return conduit 530 is located adjacent to an inner surface of the structural cylinder 500). That is, the oil-return conduit 530 extends radially from the cylinder wall of the structural cylinder 500 toward the axial center of the evaporator chamber 502. The oil-return conduit 530 is capable of rotating together with the structural cylinder 500.

When the evaporator drum 120 rotates about the rotational axis 122, the oil-return conduit 530 rotates accordingly. When an inlet end of the oil-return conduit 530 moves to a low position within the evaporator chamber 502, the inlet scraps a bottom interior surface of the structural cylinder 500 to scrape up a lubricating oil film adhered to the interior as oil droplets. When the inlet of the oil-return conduit 530 rotates to the high position, the lubricating oil accumulated at the inlet end flows to an outlet of the oil-return conduit 530 and into the return gas section 520 disposed coaxially within the structural cylinder 500 and disposed centrally in the first axial cover 510 under a gravitational force The lubricant oil delivered to the return gas section 520 by the oil-return conduit 530 ultimately returns to the compressor together with a refrigerant airflow. Through a continuous rotational scraping action of the oil-return conduit 530, a residual oil film on an inner wall of the evaporation chamber 502 can be effectively removed so as to maintain a direct heat-transfer capability of a metal surface, and an oil-return efficiency can be improved.

The oil-return conduit 530 can be located adjacent to the first axial cover 510 and located inside the evaporator chamber 502 of the structural cylinder 500. The outlet end 532 of the oil-return conduit 530 is disposed near the center of the structural cylinder 500 and near the return gas section 520 that extends through the first axial cover 510. The lubricant captured by the oil-return conduit 530 can be readily transferred from the outlet end 532 to the return gas section 520. An inlet end 534 of the oil-return 530 is disposed at the circumferential edge of the first axial cover 510 proximate to the inner surface of the structural cylinder 500. On one hand, this facilitates the inlet end 534 periodically moving to a bottom region of the structural cylinder 500. On the other hand, this facilitates the inlet end 534 periodically moving to an upper region of the evaporation cylinder 500.

The return gas hole 522 is located near the outlet end 532 and can receive the lubricant oil transferred from the outlet end 532. The return gas hole 522 is configured to accelerate lubricating oil to flow from the outlet end 532 of the oil-return conduit 530 toward the return gas hole 522 by means of a negative-pressure effect inside the return gas section 520. The oil-return conduit 530 is disposed at a side portion of the return gas hole 522. When an inlet end 534 of an oil-return conduit 530 moves to a high position in the evaporator chamber 502, the outlet end 532 communicates with the return gas hole 522. Through a design in which the physical positions are adjacent, the scraped lubricating oil is enabled to directly drip into the return gas hole 522 and enter a compressor through the return gas section 520, thereby preventing oil droplets from remaining deposited inside the structural cylinder 502.

In an embodiment, the oil-return conduit 530 is fixed to the surface of the first axial cover 510 and rotates with first axial cover 510 about the rotational axis 122. The inlet end 534 of the oil-return conduit 530 is located toward the circumference of the first axial cover 510 and the inlet end 534 extends radially inward toward the center of the first axial cover 510. The oil-return conduit 530 rotates with the first axial cover around the rotational axis 122 thereby forming a continuous oil-return cycle through periodic actions of low-position oil scraping and flow guidance at a high position during rotation.

Referring to FIG. 60, the oil-return conduit 530 protrudes from the planar face of the first axial cover 510 and defines a first oil-collecting groove 536 between the face of the axial cover 510. Lubricating oil is accommodated inside the oil-collecting groove 536. The oil-collecting groove 536 guides lubricating oil to flow from the inlet end 534 of the oil-return conduit 530 to the outlet end 532. The oil-collecting grove 536 directs the lubricating oil from the inlet end 534 radially inward to the outlet end 532 centrally disposed with respect the rotational axis 122 of the evaporator drum 122 and proximate to the return gas section 520 protruding through the first axial cover 510. In another example, the oil-collecting groove 536 can be disposed into the planar face of the first axial cover 510 such that the oil-return conduit 530 is recessed into the structure of the axial cover.

To efficiently scrape oil, a hook-shaped groove 538 is provided at an end of the oil-return conduit 530 located at a peripheral edge of the first axial cover 510. The hook-shaped groove 538 extends outward from a side portion of the oil-return conduit 530 and forms, at its end, an inwardly recessed structure of a “7”-shape or an arc shape. The inwardly recessed “7”-shape or arc-shaped structure is configured to extend into an oil layer at a bottom of the structural cylinder 500 during rotation, so as to guide accumulated lubricating oil into the oil-collecting groove 536 through a “scooping” action. Meanwhile, the inwardly recessed “7”-shape or arc-shaped structure facilitates lubricating oil to transition from the hook-shaped groove 538 into the oil-collecting groove 536. The hook-shaped groove 538 communicates with the oil-collecting groove 536. When the first axial cover 510 rotates, the hook-shaped groove 538 scoops compressor oil into the oil-collecting groove 536.

In an embodiment, to direct the lubricating oil from oil-collecting conduit 530 to the gas return section 520, the first axial cover 510 includes a fixing cap 540. The fixing cap 540 protrudes from the planar face of the first axial cover 510 in the axial direction aligned with the rotational axis 122. The fixing cap 540 surrounds the return gas section 520 that extends axially through the first axial cover 510. The fixing cap 540 is surrounds the return gas section 520 and is configured to locationally fix the outlet end 532 of the oil-collecting conduit 530 with respect to the return gas hole 522. To allow oil-collecting conduit 530 to extend to the return gas section 520, the fixing cap 540 may include an axial slot 542. The axial slot 542 is parallel to the rotational axis 122 and allows the outlet end 532 of the oil-collecting conduit 530 to enter and interface with the return gas hole 522 such that lubricating oil is allowed to pass through the axial slot 542 and drip into the return gas hole 522 when the oil-collecting conduit 530 is aligned in the vertical direction 110 due to rotation of the evaporator drum 120 around the rotational axis 122.

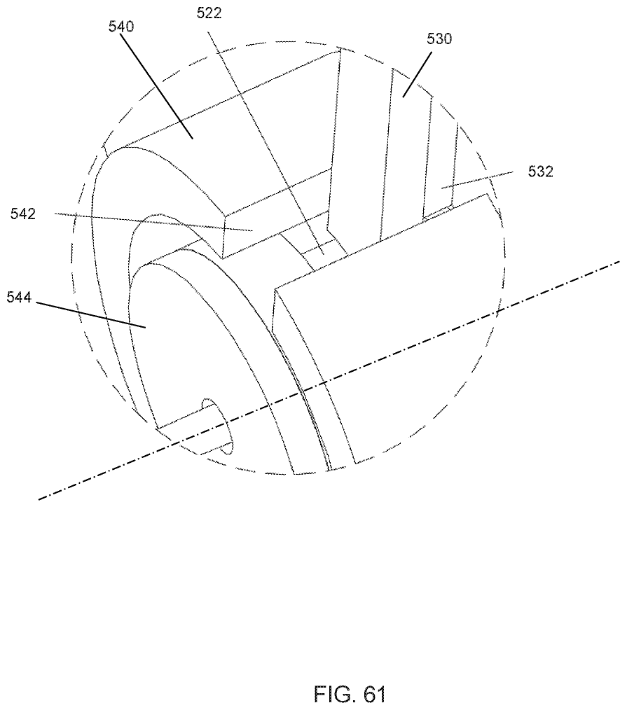

Referring to FIG. 61, the end of the gas return section 520 is provided with an end cover 544. The end cover 544 is a planar flat plate that is fixed to the axial end of the gas return section 520 perpendicular to the rotational axis 122. The introduction conduit 518 of the introduction section 514 is disposed through the end cover 544 to access the evaporator chamber 502. The end cover 544 both fixes the introduction conduit 518 and prevents the refrigerant discharged from the introduction conduit 518 from returning axially through the return gas hole 522, thereby avoiding short-circuit suction. The end cover separates the introduction conduit 518 from the return gas hole 522 so that the liquid refrigerant undergoes sufficient evaporation inside the structural cylinder 500 before returning to the gas return section 520.

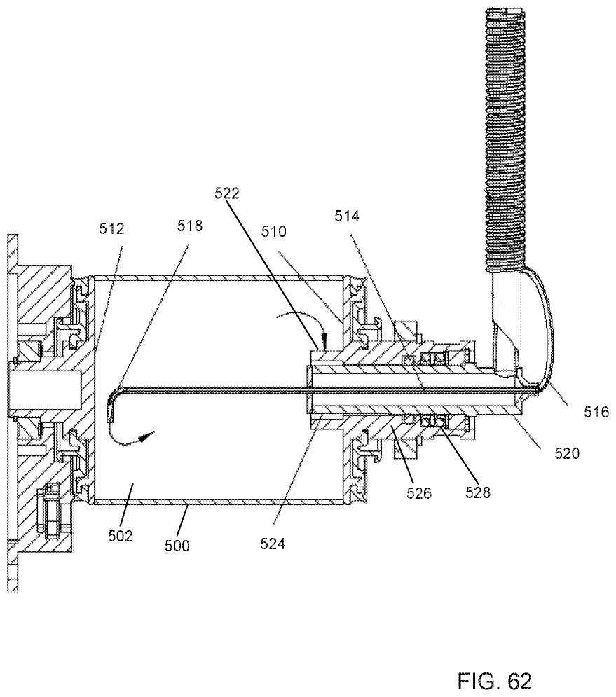

Referring to FIG. 62, in an embodiment, the distance between the introduction conduit 518 and the return gas communication sleeve 526 is further increased. Specifically, the structural cylinder 500 further comprises the second axial cover 512 disposed at an end of the structural cylinder 500 laterally opposite the first axial cover 510. The introduction section 514 and the return gas section 520 both pass through the first axial cover 510 and are positioned within the evaporation chamber 502. The end of the introduction section 514 is located adjacent to the second axial cover 512 and the end of the return gas section 520 is located adjacent to the first axial cover 510. Thus, the introduction conduit 518 and the return gas connecting tube 524 are positioned at opposite lateral ends within the structural cylinder 500, spaced significantly apart. The refrigerant ejected from the introduction conduit 518 located at the laterally opposite end of the cylinder structure 500 before removal via the return gas hole 522 at the first axial cover 510 undergoes full evaporation within the evaporation chamber 502, thereby enhancing heat-exchange performance and improving cooling efficiency.

Referring to FIGS. 57 and 58, to facilitate installation, the evaporator drum 120 comprises a mounting assembly 550. The mounting assembly 550 employs a single-side fixation design for the structural cylinder 500, thereby substantially simplifying installation and disassembly of the evaporator. Specifically, the mounting assembly 550 comprises a mounting plate 552, a bearing 554, and a connecting shaft 556. The mounting plate 552 is fixed to the interior of the refrigeration machine 100.

A first mounting hole 558 is disposed within the mounting plate 552. An outer ring of the bearing 554 is fixed within the first mounting hole 558, one end of the connecting shaft 556 is fixed to an inner ring of the bearing 554, and the other end of the connecting shaft 556 is connected to an end of the structural cylinder 500 opposite the first axial cover 510. During installation, the bearing 554 is first mounted within the first mounting hole 558, and the connecting shaft 556 is coupled to the inner race of the bearing 554, thereby achieving a connection between the structural cylinder 500 and the mounting plate 552. The mounting plate 552 and the structural cylinder 500 are connected into an integrated structure, and the integrated structure is subsequently inserted into the housing of the refrigeration machine 100.

### Detector Devices

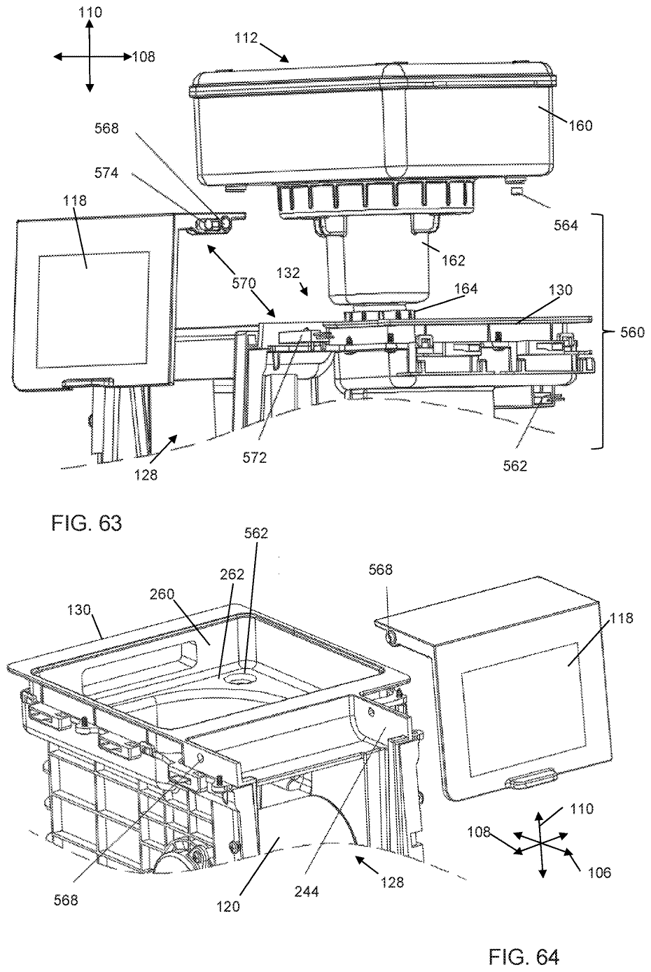

Referring to FIGS. 63 and 64, the refrigeration machine 100 can be equipped with one or more detectors or sensors to regulate operation and protect against misuse. For example, because many of the parts and components of the refrigeration machine 100 are detachable and can be disassembled to facilitate cleaning and improve sanitation, it is necessary to ensure the parts and components are correctly installed before initiating operation. Otherwise moving or cold parts may be exposed, creating the potential for injury or unintentional discharge of the liquid ingredients. To remedy these problems, the refrigeration machine 100 may include detectors and sensors strategically located and arranged to detect missing or improperly assembly covers and components.

The detectors and sensors can operate on any suitable technology and technique. The detectors and sensors can be magnetic hall effect sensors, infrared optical sensors, limit switches, electrical contact sensors etc. The detectors and sensors are operably associated with the control panel and can send and receive electrical data signals used to control and regulate operation of the refrigeration machine. The detectors and sensors described herein may operate independently or cooperatively, and any specific detectors and sensors can be omitted or additional detectors and sensors included.

The refrigeration machine 100 includes the storage device 112 liquid ingredient detachably mounted to the top of the housing cabinet 104. For example, the storage device 112 can be partly received in the entrances of the liquid passageway 132 of the housing liner assembly 130. The refrigeration machine also includes the rotatable cover 118 pivotally attached to the front of the housing cabinet 104 to occlude the ice-making region 128 during operation and prevent discharge of the liquid ingredients. The refrigeration machine 100 can include detectors and sensors to determine if the storage device 112 and the rotatable cover 118 are properly installed and position prior to the ice-making operation.

When the storage device 112 is mistakenly removed, the detectors and sensors can quickly detect this separation signal. Similarly, when the rotatable cover 118 is accidentally opened, the detectors and sensors can also promptly identify the change in its status. Thus, when the refrigeration machine 100 detects the abnormal situation of the storage device 112 being separated or the rotatable cover 118 being opened, it can quickly trigger the shutdown protection mechanism, preventing the device from continuing to operate under unsafe conditions. This protects against injuries and spillage.

The housing liner assembly 130 located in the housing cabinet 104 to direct and guide the liquid ingredients from the storage device 112 defines the liquid passageway 132 which receives the bottom of the storage device 112. The storage body 160 of the storage device 112, which is configured as a fluid tank or reservoir, can be detachably placed inside the liquid passageway 132. By accommodating the bottom of the storage body 160 in the liquid passageway 132, the displacement of the storage device 112 in the lateral and vertical directions 108, 110 is restricted, making the fit between the storage box (21) and the housing liner assembly more stable. This ensures the accuracy of the detectors and sensors and reduces the possibility of false detections caused by the shaking of the storage device 112, making the monitoring of whether the storage box is separated more reliable.

In the embodiments described herein, the housing liner assembly 130 may include an inner shell 240 that defines the structural recess 260 equipped with a support ledge 262. Part of the bottom of the storage device 112 can rest on the support ledge 262. The support ledge 262 thus contacts and supports the storage device 112 and prevents the storage device from being inserted too far vertically into the liquid passageway 132. The structural recess 260 and support ledge 262 allow detachable removal of the storage device 112.

Referring to FIGS. 63 and 64, to determine if the storage device 112 is properly installed in the liquid passageway 132, a first detection device 560 is located in the structural recess 260 and operatively arranged between the storage body 160 of the storage device 112 and the housing liner assembly 130. The first detection device 560 can be comprised of two components that cooperatively contact and interact to register the correct placement of the storage body 160 in the structural recess 260 of the housing liner assembly 130. By way of example, the detection device 560 can comprise a first detector 562 capable of sensing the presence of a first detected element 564. The first detected element 564 may be a prong or surface, a visual pattern, an electromagnetic element like a magnet or electric coil or the like depending upon the technical principle of the first detector 562. The first detector 562 is responsive to the first detected element 564 and is configured to undertake a responsive action such as sending an electronic data signal or activating an alert. The first detected element 564 functions as a trigger for the first responsive detector 562.

For example, the first detector 562 can be located on the support ledge 262 of the structural recess 260 arranged in a location to make contact with the underside of the storage body 160. The first detector 562 is preferably a magnetic control detector, and the first detected element 564 is preferably a magnet. In other embodiments, the first detector 562 can be an infrared detector, and the first detected element 564 corresponds to the detection position of the infrared detector. In one embodiment, the first detected element 564 is located at the bottom of the storage body 160, and the first detector 562 is located on the support ledge 262. In embodiments wherein the housing liner assembly 130 is removable, the first detector 562 may not be fixedly attached to the support ledge 262 so it may remain in electrical communication with a controller. In other embodiments, the first detected element 564 is mounted underneath connecting ledge 262, and the first detector 562 is located at the bottom of the storage body 160.

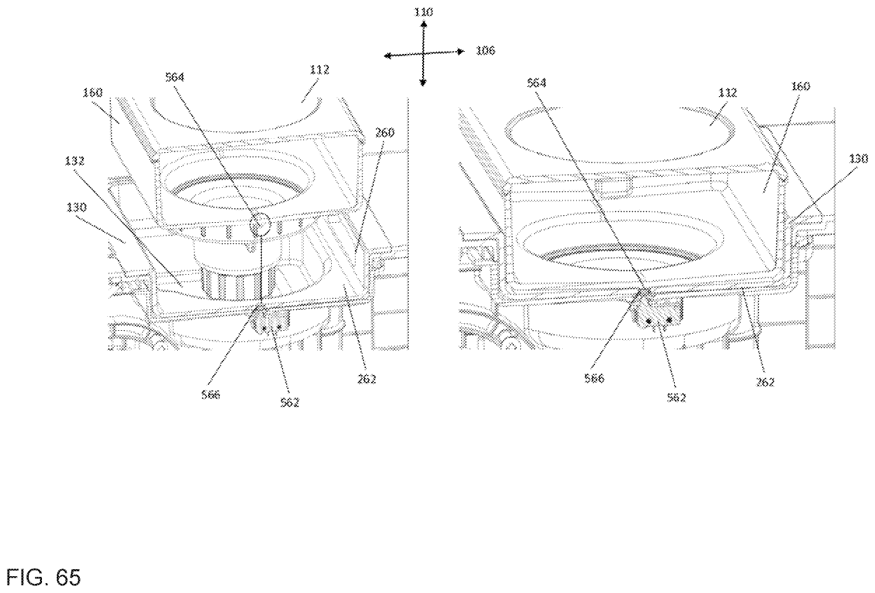

Referring to FIG. 65, in another embodiment, the first detector device 560 can be an electrical contact sensor. For example, the first detector 562 can be located proximate to the structural recess 260 of the housing liner assembly 130, such as to the underside of the support ledge 262. The first detector 562 can be configured as an electrical switch, such that when the first detector 562 is depressed or toggled, it completes or breaks an electrical circuit. The first detected element 564 can be formed as a prong or tab on the underside of the storage body 160 that corresponds in location to the first detector 562 mounted underneath the support ledge 262. To expose the first detector 562 for contact with the first detected element 564, an access aperture 566 or hole is disposed through the support ledge 262. When the storage body 160 is installed vertically into the structural recess 260, the first detected element 564 passes through the access aperture 566 in the support ledge 262 to contact and trigger the first detector 562.

To assist in securing the storage device 112 to the housing liner assembly 130, the first detector device 560 can also be configured to produce a mechanical lock. For example, the first detector 562 can apply a retention force to the first detected element 564 inserted into the access aperture 566. The first detector 562 retains and holds the first detected element 564 in the access aperture 566 preventing unintentional dislodgement or movement of the storage device 112. The first detector device 560 can be configured to produce an audible sound or tactile sensation when the first detector 562 is contacted by the first detected element 564, thereby providing an audible or haptic signal to the user that the storage device 112 has been properly aligned and installed with the housing liner assembly 130. A plurality of first detectors 562 can be provided on opposite lateral sides of the structural recess 260 to more completely detect and register insertion of the storage device 112.

Referring to FIG. 64, the rotatable cover 118 is pivotally mounted to the longitudinal front of the housing cabinet 104 for example, by a hinged connection 568 including for example hinge pins received into pin holes. The rotatable cover 118 can pivot about a pivot axis parallel with the lateral direction to open and cover the ice-making region 128. This structural design is simple to process, easy to assemble, and ensures a tight connection between the rotatable cover 118 and the housing cabinet 104, reducing shaking caused by gaps in the connection.

To determine if the rotatable cover 118 is lower, the refrigeration machine 100 can include a second detector device 570. The second detector device 570 can be a multicomponent arrangement including a second detector 572 that is responsive to the second detected element 574. The second detector 572 is preferably a magnetic control detector, and the second detected element 574 is preferably a magnet. In other embodiments, the second detector 572 can be an infrared detector, and the second detected element 574 corresponds to the detection position of the infrared detector. In one embodiment, the second detected element 574 is located on the side of the rotatably cover 118, and the second detector 572 is located on the side of the housing cabinet 104. When the rotatable cover 118 is rotated vertically upward, the second detector 572 no longer visually perceives the second detected element 574 triggering a response by the second detector device 570.

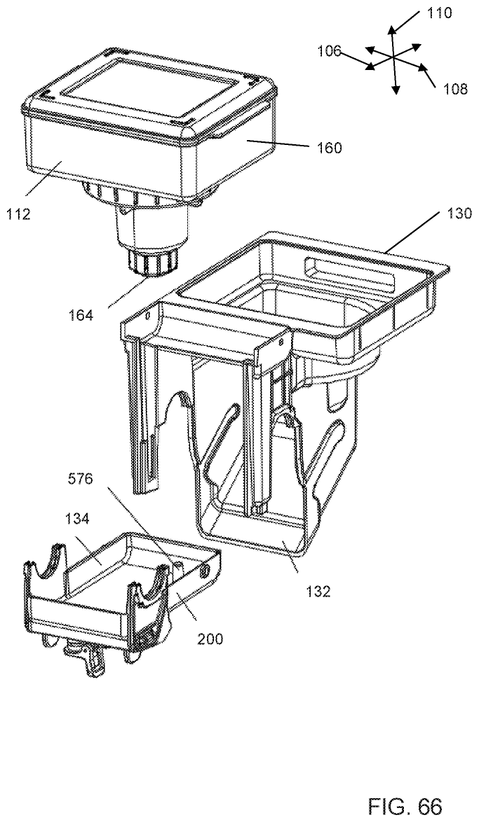

Referring to FIG. 66, as described above, the refrigeration machine 100 can include a liquid holding tray 134 that is insertable into the liquid passageway 132 defined by the housing liner assembly 130. The liquid holding tray 134 can be releasably installed and stably held with respect to the housing liner assembly 130 as described above. The liquid holding tray 134 defines a tray bed 200 with upright sidewalls to contain the liquid ingredients. The liquid holding tray 134 receives the liquid ingredients from the storage device 112 and receives water droplets, condensed water or residual beverages that may be generated during operation of the apparatus, thereby preventing liquid from directly dripping outside the device and causing contamination or safety hazard.

To dispense liquid ingredients from the storage device 112, the liquid holding tray 134 can include an actuation rod 576 that extends upright in the vertical direction 110 from the tray bed 200. The actuation rod 576 may be configured as a post designed to engage the dispensing valve mechanism 164 located at the bottom of the storage body 160. The actuation rod 576 corresponds in location with the position of the dispensing valve mechanism 164 when the storage device 112 has been securely mounted into the entrance of the housing liner assembly 130. When the storage device 112 is correctly placed in the housing liner assembly 130, the dispensing valve mechanism 164 is automatically opened by virtue of the abutment of the actuation rod 576 against the dispensing valve mechanism 164, so that liquid ingredients from the storage device 112 flow out as required without manual opening, and operational convenience is improved.

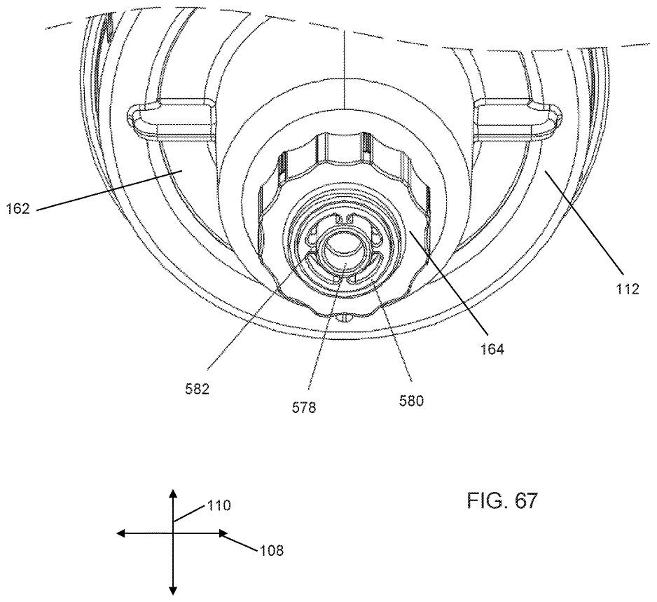

Referring to FIG. 67, the dispensing valve mechanism 164 may include a receiving hole 578 oriented downwardly in the vertical direction 110 and configured for receiving the actuation rod 576 extending upright from the liquid holding tray 134. The receiving hole 578 is shaped to mate with the actuation rod 576 and corresponds in location with the position of the actuation rod 576 when the storage device 112 and the liquid holding tray 134 have been installed. When the storage device 112 is placed in the housing liner assembly 130, the actuation rod 576 is accurately inserted along the opening of the receiving hole 578 so that the actuation rod 576 precisely abuts against the dispensing valve mechanism 164 and normal opening of the dispensing valve mechanism 164 is ensured.

Meanwhile, the cooperation of the actuation rod 576 and the receiving hole 578 forms a mechanical interlocking mechanism that effectively prevents the liquid holding tray 134 from being directly pulled out. After the storage device 112 is normally installed and the actuation rod 576 is inserted into the receiving hole 578, a fixed constraint is formed on the storage device 112. Because the liquid holding tray 134 and the storage device 112 have a mechanically linked relationship, the liquid holding tray 134 cannot be pulled out while the storage device 112 is installed. Only after the storage device 112 is removed and the actuation rod 576 is disengaged from the receiving hole 578 is the locked state of the liquid holding tray 134 released, thereby allowing a user to perform cleaning or replacement operations. This structural design avoids the risk of ingredients leakage and device damage caused by mistakenly pulling the liquid holding tray 134 and also prevents safety hazards that may arise from accidental withdrawal of the liquid holding tray 134 while the refrigeration machine 100 is running.

To protect the dispensing valve mechanism 164, the valve body of the dispensing valve mechanism 164 can include a limiting ring 580 that is circular and concentric to the cylindrical structure that defines the receiving hole 578. The limiting ring 580 is attached to the structure defining the receiving hole 578 by a plurality of support ribs 582 that extend radially between the concentrically aligned limiting ring 580 and the receiving hole 578 and that are angularly spaced about the circumferences of the limiting ring 580 and the receiving hole 578. The receiving hole 578 is held concentrically within the limiting ring 580 by the plurality of support ribs 582.

The support ribs 582 are deflectable. When the actuation rod 576 abuts against the receiving hole 578, the support ribs 582 can deflect to enable the cooperating structures to properly align. The receiving hole 578 is more stable at the central position of the limiting ring 580, preventing displacement or deformation when the actuation rod 576 is inserted, thereby protecting the overall structure of the dispensing valve mechanism 164. Particularly when the liquid holding tray 134 is accidentally pulled out, the support ribs 582 firmly support the receiving hole 578, limiting its wobbling. This prevents the actuation rod 576 from making abnormal contact with the dispensing valve mechanism 164 during the movement of the liquid holding tray 134, thereby preventing damage and further improving the protection of the dispensing valve mechanism 164.

The connection between the support ribs 582 and the limiting ring 580 forms a concave curved structure, and the connection between the support rib 582 and the outer wall of the receiving hole 578 also forms a concave curved structure. This curved structure helps to dissipate stress at the connection points. When external forces are applied to the support rib 582 by the actuation rod 576 or the pulled-out liquid holding tray 134, the stress is evenly distributed, preventing breakage at the connection points and strengthening the protection of the dispensing valve mechanism 164. At the same time, the curved structure makes the connection smoother, reducing weak points caused by structural discontinuities and improving the overall stability and service life of the dispensing valve mechanism 164.

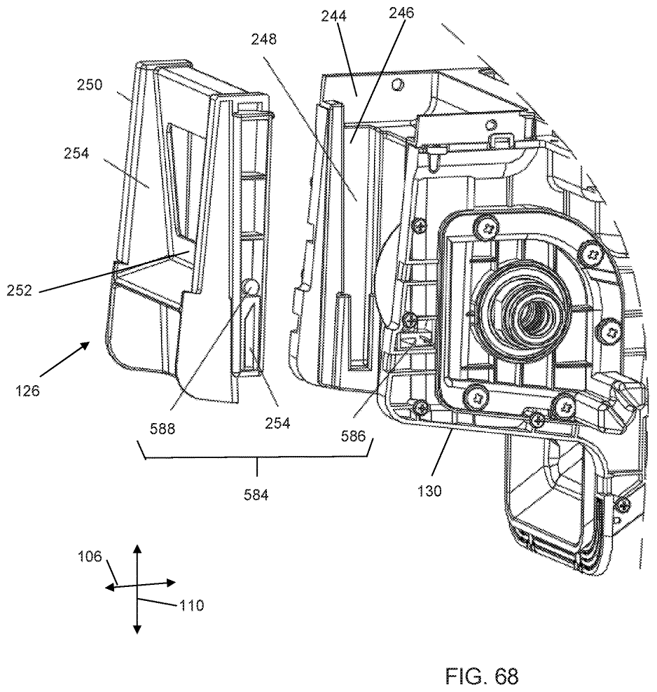

Referring to FIG. 68, as described above, the refrigeration machine 100 can include a blade assembly 126 that can be detachably installed on the housing cabinet 104 longitudinally forward and adjacent to the ice-making region 128. The blade assembly 126 comprises the metal scraping blade 252 to scape ice from the cylindrical surface of the evaporator drum and a blade holder 250 that fixedly holds and support the scraping blade 252. To attach the blade assembly 126, the housing cabinet 104 includes a blade insert frame 244 comprising a pair of laterally spaced frame legs 246 providing a bifurcated gap to receive the blade holder 250.

To determine if the blade assembly 126 is properly installed or is separated from the blade insert frame 244, the refrigeration machine 100 can include a third detector device 584. The third detector device 584 comprises a third detector 586 that cooperates with and is responsive to a third detected element 588. The third detected element 588 is a structural feature that functions as a trigger causing the third detector 586 to undertake some remedial action. The third detected element 588 may be a prong or surface, a visual pattern, a electromagnetic element like a magnet or electric coil or the like depending upon the technical principle of the third detector 586. The third detector 586 and the third detected element 588 may be operatively associated with the blade insert frame 244 and the blade holder 250 to register installation of the blade assembly 126 with respect to the blade insert frame 244.

In an embodiment, the third detector device 584 performs real-time monitoring of the installation of the blade holder 250 based on proximity sensing principles or mechanical contact triggering mechanisms. When proximity sensing is used, the third detector 586 includes an electromagnetic sensing coil or infrared sensing module, and a magnetic metal sheet or reflective material is embedded at the bottom of the blade holder 250. When the blade holder 250 is correctly installed within the blade insert frame 244, the sensing distance between the detection component and the blade holder 250 is within a preset safety threshold, and stable electrical signals are output. If the blade holder 250 becomes detached, the sensing distance exceeds the threshold, and the detection component immediately outputs an abnormal signal. When a mechanical contact triggering mechanism is used, an elastic metal contact is provided at the bottom or side of the blade insert frame 244. When the blade holder 250 is inserted, it presses the contact to close the circuit. When the blade holder 250 separates, the contact disconnects due to elastic recovery, triggering a detection signal through changes in the circuit's on/off state.

The third detected element 588 cooperates with the third detector 586 and can detect whether the blade holder 250 is removed from the blade insert frame 244. The third detector 586 is preferably a magnetic control detector, and the third detected element 588 is preferably a magnetic block. In other embodiments, the third detector 586 could be an infrared detector, with the third detected element 588 being the corresponding detection part of the infrared detector. In one embodiment, the third detected element 588 is located on the side of the blade holder 250, and the third detector 586 is located on the side of the blade insert frame 244. In other embodiments, the third detected element 588 is located on the side of the blade insert frame 244, and the third detector 586 is located on the side of the blade holder 250.

When the blade holder 250 accidentally separates from the blade insert frame 244, the detection mechanism can promptly identify the state change. Compared to the prior art, which lacks monitoring of the blade installation state and the risk that the blade holder 250 may separate, leading to abnormal equipment operation or safety accidents (such as the scraper blade 252 falling off and damaging other components or causing personnel injury), the application of the third detector device 584 can trigger the corresponding protection mechanism in a timely manner when the blade holder 250 is detected to be separated. This helps prevent the equipment from operating in an unsafe state, further enhancing the safety of the equipment and ensuring the safe operation of the apparatus and the safety of the operators.

In an embodiment, the third detector 586 can be located at the bottom of the insert slot 248 disposed in the frame leg 246 or at a predetermined distance from the bottom of the insert slot 248. The third detected element 588 is located at a corresponding location on the insertable flange 254. The locations of the third detector 586 and third detected element 588 are coordinated to ensure that the blade holder 250 is fully inserted into the blade insert frame 244 in the vertical direction 110 to active the third detector device 584. The arrangement ensures the blade holder 250 is securely held in the blade insert frame 244, for example, by fully actualizing the wedge-lock arrangement, and the blade assembly 126 is restrained against vibration and chatter.

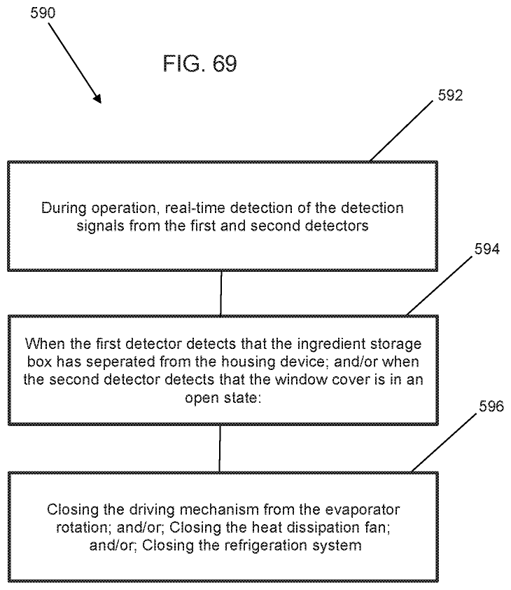

Referring to FIG. 69, there is illustrated a flow diagram 590 of a method by which the first, second, and third detector devices 560, 570, and 584 can be used to regulate operation of the refrigeration machine 100. The steps and operations of the flow chart can be executed by an electronic control system included with the refrigeration machine 100 and operatively associated with the control panel 116. The flow diagram 590 can be embodied as a computer readable program or software that is interpreted and performed by a computerized or electronic logic device. The programming for the flow diagram 590 can be stored in electronically readable memory associated with the refrigeration machine 100. The following operations and sequence are examples only and operations may omitted, added, and/or reordered.

The flow chart 590 may comprise the following operations executed in real time in response to data signal from the first detector 560 and the second detector 570:
Step 592, when the first detector 560 detects that the storage device 112 has separated from the housing cabinet 104, and/or when the second detector 570 detects that the rotatable cover 118 is in an open state:
Step 594, turn off the driving mechanism that drives the evaporator drum to rotate; and/or turn off the heat dissipation fan; and/or turn off the refrigeration system.

Alternatively, the data signal may be provided by any one or more of the first detector 560, the second detector 570, and the third detector 584.

During the ice-making operation of the refrigeration machine 100, the compressor of the refrigeration system starts, and the driving motor rotates the evaporator drum 120. Liquid ingredients form an ice layer on the evaporator drum 120, and the heat dissipation fan dissipates heat from the condenser. In operation, the system will continuously detect the detection signals of the first detector device 560, the second detector device 570, and/or the third detector device 584. This real-time detection approach allows the apparatus to always monitor the connection state of the storage device 112 and the housing cabinet 104, as well as the open/close status of the rotatable cover 118, providing timely and accurate data for subsequent control actions, ensuring the equipment can immediately respond to abnormal conditions of components.

In one embodiment, when the first detector device 560 detects that the storage device 112 has separated from the housing cabinet 104, or the second detector device 570 detects that the rotatable cover 118 is in an open state (or both the first detector device 560 and the second detector device 570 simultaneously detect the separation of the storage device 112 from the housing cabinet 104 and the open state of the rotatable cover 118), the system determines that the storage device 112 has been manually removed or the rotatable cover 118 has been manually opened. To eliminate safety hazards, the driving mechanism for rotating the evaporator drum will be turned off, thus preventing the evaporator from continuing to rotate in an exposed state, which could cause mechanical damage and other risks.

In another embodiment, when the first detector device 560 detects that the storage device 112 has separated from the housing cabinet 104 or the second detector device 570 detects that the rotatable cover 118 is in an open state (or both the first detector device 560 and the second detector device 570 simultaneously detect the separation of the storage device 112 from the housing cabinet 104) and the open state of the rotatable cover 118), the system determines that the storage device 112 has been manually removed or the rotatable cover 118 has been manually opened. To eliminate safety hazards, the heat dissipation fan will be turned off, thus preventing airflow disturbances that could cause liquid splashes or avoid personnel from contacting the running fan components, reducing safety risks.

In another embodiment, when the first detector device 560 detects that the storage device 112 has separated from the housing cabinet 104, or the second detector device 570 detects that the rotatable cover 118 is in an open state (or both the first detector device 560 and the second detector device 570 simultaneously detect the separation of the storage device 112 from the housing cabinet 104 and the open state of the rotatable cover 118) the system determines that the storage device 112 has been manually removed or the rotatable cover 118 has been manually opened. To eliminate safety hazards, the refrigeration machine will be turned off, thus preventing further operation of the compressor, evaporator, and other components, which could otherwise cause mechanical damage and other risks.

In another embodiment, the motor, the heat dissipation fan, and the refrigeration system can be turned off simultaneously, effectively reducing the probability of safety accidents and further ensuring the personal safety of the user.

The method further includes the following steps:
When the first detector device 560 detects that the storage device 112 has separated from the housing cabinet 104, timing begins;

Within the first preset time:
If the first detector device 560 detects that the storage device 112 has been reinserted into the housing cabinet 104, restart the driving mechanism and/or heat dissipation fan;
If the first detector device 560 detects that the storage device 112 is still separated from the housing cabinet 104, turn off the compressor.

When the first detector device 560 detects that the storage device 112 has separated from the housing cabinet 104, a timing operation begins. This timing action provides the apparatus with a staged sequence of dependent operations to adopt a more reasonable control strategy based on the status change of the storage device 112. Within the first preset time, if the first detector device 560 detects that the storage device 112 has been reinstalled into the housing cabinet 104, the driving mechanism and/or the heat dissipation fan will be restarted, allowing the apparatus to quickly resume normal operation, reducing work interruptions caused by the brief separation, and ensuring the continuity of cold drink production. This design takes into account the possibility that the user may temporarily remove the storage device 112 for short-term operations (e.g., quickly replenishing materials), balancing the efficiency and safety of the apparatus.

If, within the first preset time, the first detector device 560 detects that the storage device 112 is still separated from the housing cabinet 104, the compressor will be turned off. This is because the compressor is the core component of the refrigeration system in cold-drink apparatus. Continuous operation consumes a large amount of energy, and when the storage device 112 has been separated for a long time, the refrigeration demand no longer exists or has been greatly reduced. Additionally, the heat dissipation fan for the condenser has been turned off. Continuous operation of the compressor could lead to issues such as excessive pressure within the system. This also further strengthens the safety protection of the apparatus, preventing unnecessary risks that may arise from the compressor continuing to operate in the state where the storage device 112 has been separated for an extended period, posing a safety hazard. In an embodiment, the first preset time may be 30 seconds.

Similarly, the following steps are included:
When the second detector device 570 detects that the rotatable cover 118 is in the open state, a timing operation begins;

Within the second preset time:
If the second detector device 570 detects that the rotatable cover 118 has been closed, restart the driving mechanism and/or heat dissipation fan;
If the second detector device 570 detects that the rotatable cover 118 is still in the open state, turn off the compressor.

Within the second preset time, if the second detector device 570 detects that the rotatable cover 118 has been closed again, it indicates that the user has completed the operation and the apparatus has returned to a safe state. In this case, the control logic will drive the driving mechanism and/or the heat dissipation fan to restart, ensuring that the cold drink production process is not overly disrupted and maintaining the device's continuous operational capacity.

If, at the end of the second preset time, the second detector device 570 still detects that the rotatable cover 118 remains open, it indicates that the apparatus may be in an abnormal usage state. In this case, turning off the compressor becomes a necessary measure. This is because keeping the rotatable cover 118 open for an extended period would damage the sealing of the ice-making region 128, leading to a sharp decline in refrigeration effectiveness. Furthermore, continuous operation of the compressor would cause energy wastage and may even affect the apparatus's lifespan due to excessive load. In an embodiment, the second preset time may be 10 to 30 seconds.

The method further includes the following steps:
During operation, real-time detection of the detection signals from the third detector device 584:

When the third detector device 584 detects that the blade holder 250 is separated from the housing cabinet 104:
Turn off the driving mechanism that drives the evaporator to rotate; and/or
Turn off the heat dissipation fan.

In the course of operation, the control method will continuously monitor the detection signal from the third detector device 584 to understand the connection status between the blade holder 250 and the blade insert frame 244. Since the scraper blade 252 in the blade holder 250 is a potentially hazardous component, the stability of its installation state directly affects the safety of the apparatus operation, making real-time monitoring of its status especially critical.

When the third detector device 584 detects that the blade holder 250 has separated from the blade insert frame 244, the control logic will immediately trigger the closure of the driving mechanism for the evaporator rotation, and/or the closure of the heat dissipation fan. This is because after separation of the blade holder 250, the scrapping blade 252 may be in an unstable state. If the driving mechanism continues to rotate the evaporator at this point, an accidental collision may occur between the two, causing component damage or more serious safety accidents. Closing the heat dissipation fan can prevent airflow disturbances that could cause liquid splashing or avoid personnel coming into contact with operating fan parts, thereby reducing safety risks.

### Ice-making Operation

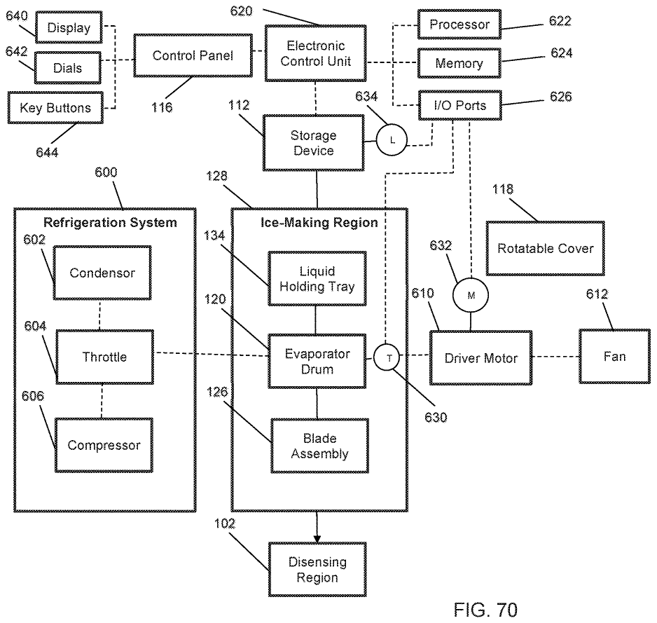

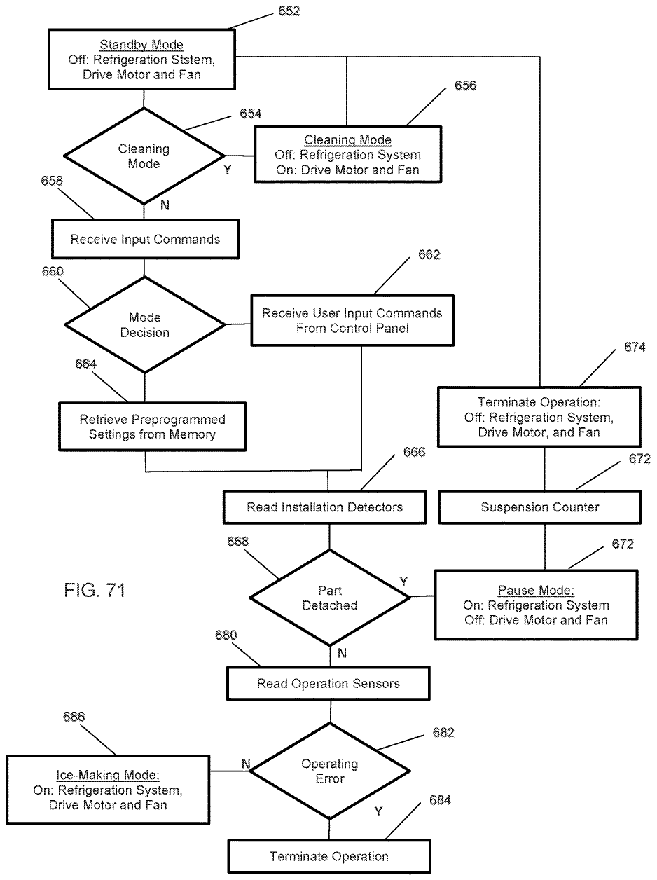

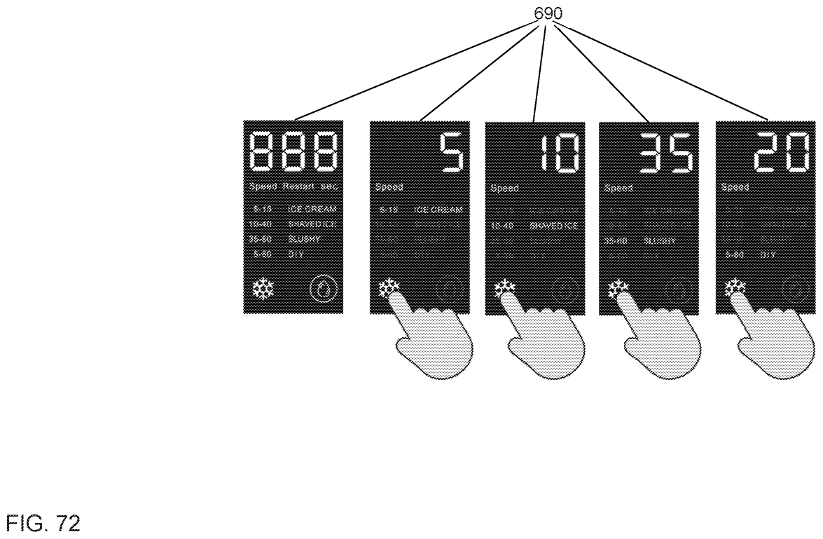

Referring to FIGS. 70 and 71, there is schematically illustrated the layout and the methods by the refrigeration machine 100 conducts an ice-making operation that converts the liquid ingredients to ice which is dispensed for consumption. The liquid ingredients include water, fruit juices, dairy products, alcoholic spirits, and similar consumable liquids. The refrigeration machine 100 and the associated ice-making process are versatile and adapted to make a variety of frozen and semi-frozen products from different liquid ingredients.

Referring to FIG. 70, with continued reference to the proceeding figures, the various machine parts and components of the refrigeration machine 100 described above are shown in operative relation. These include the storage device 112 for receiving and storing the liquid ingredients, which may be periodically poured into the tank-like storage body 160 and can be selectively dispensed through the dispensing valve mechanism 164. The storage device 112 is upstream of and in fluid communication with the liquid holding tray 134. The liquid holding tray 134 is configured with a tray bed having upright sidewalls to receive and contain the liquid ingredients. The liquid holding tray 134 is also operatively associated with the evaporator drum 120 which can be partly submerged into the liquid ingredients contained in the tray bed that freeze and adhere to the circumferential surface of the evaporator drum 120. The evaporator drum 120 is rotatably disposed with respect to the blade assembly 126 fixating the position of the scraping blade that scraps the frozen ingredients from the circumferential surface for serving.

The storage device 112 is detachably mounted to the top of the housing cabinet in the vertical direction 110. The ice-making regions 128, in which the liquid holding tray 134, evaporator drum 120, and blade assembly 126 are located, is downstream and vertically below the storage device 112. Gravity thereby assists in the directional flow of the liquid ingredients through the refrigeration machine 100. The dispensing region 102 where the ice shavings can be dispensed to a serving container is located downstream of vertically below the blade assembly 126 in the ice-making region 128 to receive the falling ice shavings.

To reduce the temperature of the evaporator drum 120, the refrigeration machine includes a refrigeration system 600 that conducts a thermodynamic cycle. In addition to the evaporator drum 120, the refrigeration system 600 includes a condenser 602, an expansion valve or throttle 604, and a compressor 606. The components of the refrigeration system 600 are fluidly interconnected by hoses or rigid piping to circulate a fluid refrigerant in both liquid and vapor phases. Liquid refrigerant is introduced into the evaporator drum 120 where it evaporates in an endothermic phase change absorbing heat energy from the ice-making region 128. The refrigerant vapor is pressurized in the compressor 606 and returns to the liquid phase in the condenser 602 thereby rejecting the absorbed heat.

The components of the refrigeration system 100 can be accommodated in the housing cabinet 104. For example, referring to FIG. 5, the refrigeration system 600 can be located in the cabinet interior 124 enclosed by the exterior panels so that the refrigeration machine 100 is provided as a self-contained unit. The refrigeration system 600 can be separated from the ice-making region 128 and the fluid contacting parts of the refrigeration machine 100 for insulation purposes.

To rotate the evaporator drum 120 with respect to the liquid holding tray 134, a drive motor 610 is included in the refrigeration machine 100. The drive motor 610 can be an electric motor that converts electrical power to rotational motions and torque. The drive motor 610 can be operatively connected to the evaporator drum 120 to cause rotation with respect to the rotational axis 122. In the disclosed arrangement, the evaporator drum 120 is oriented in the lateral direction 108 and traverses the liquid passageway 132 defined by the housing liner assembly 130 so that the ice shavings scrapped off by the blade assembly 126 fall to the dispensing region 102 under gravity. Other orientations and arrangements of the evaporator drum 120 and drive motor 610 are possible. To enable the lateral orientation, the evaporator drum 120 may be connected to the drive motor 610 indirectly through a belt or chain drive arrangement. In possible embodiments, the drive motor 610 may be directly connected and coaxially arranged with the evaporated drum 120.

The drive motor 610 can be a variable speed motor and may operate on direct current associated with a variable power supply. The rotational speed of the drive motor 610 can be selectively adjusted, for example, between 5 to 60 RPM. Adjusting the speed of the drive motor 610 is proportional to and directly changes the rotational speed of the evaporator drum 120. The rotational speed of the evaporator drum in turn effects the ice-making process. For example, for thicker or denser liquid ingredients such as dairy products, prolonged contact with the evaporator drum 120 is necessary to lower the temperature below the freezing point. Rotating the evaporator drum 120 prolongs the thermal contact with the liquid ingredients.

Conversely, increasing the rotational speed of the evaporator drum 120 reduces contact time with the ingredients and can speed up production output of the refrigeration machine 100. Related, increasing the rotational speed of the evaporator drum 120 may result in dispensing warmer products which is desirable for producing semi-fluid beverages such as slushies. The variable speed of the drive motor 610 may be selectively adjusted based on the desired beverage or the liquid ingredients.

Where the drive motor 610 is a variable speed DC motor, it may be associated with a power convertor to convert the grid supplied AC electrical power. Alternatively, the drive motor 610 can operate on other electrical power configurations. For example, using alternating current, the rotational speed of the drive motor 610 can be adjusted by a mechanical transmission operatively disposed between the evaporator drum 120.

To address heat generated by the refrigeration system 600 and the drive motor 610, a cooling fan 612 can be disposed in the cabinet interior 124 of the housing cabinet 104. The cooling fan 612 can include an impeller or blades and causes airflow to circulate within the cabinet interior 124 during operation. The cooling fan 612 may be operatively connected and directly driven by the drive motor 610 or may be an operatively distinct and separate machine part.

To regulate the ice-making operations, the refrigeration machine 100 is functionally associated with an electronic control unit or module referred herein as an electronic controller 620. The electronic controller 620 is an electronic or computer-enabled device configured for active and automated control and execution of operations and functions associated with the refrigeration machine 100. The electronic controller 620 can be embedded system with the hardware and functionality located on a signal chip or package, although in possible configurations the functionality of the electronic controller 620 may be distributed on a plurality of devices.

The electronic controller 620 can include processor 622 that can include digital circuitry and logic circuits capable of conducting logic operations. The microprocessor 622 can be embodied as a central processing unit (CPU), an application specific integrated circuit (ASIC), or a field programmable gate array (FPGA) comprising a plurality of transistors and similar circuits that are capable of reading, manipulating and outputting data in electronic form. The processor 622 can include logic circuits for processing computer readable programs and applications embodied in executable software code and written in a suitable programming language.

The electronic controller 620 can include non-transient programmable memory 624 or other data storage capabilities that may be in random access memory or more permanent non-volatile forms of data storage media. Common examples of computer-readable memory 624 include RAM, PROM, and EPROM, a FLASH-EPROM, and any other memory chip or cartridge. The memory 624 is capable of storing software instructions from the computer executable programs and applications including instructions and associated data that can be read and processed by the microprocessor 622. The software and data may take the form of instruction sets, rules, definitions, applications, routines, libraries, databases, lookup tables, data sets, and the like.

To exchange information and send commands, the electronic controller 620 can include one or more input/output (I/O) communication ports 626. The communication ports 626 can send and receive data and information in the form of electronic data signals transmitted through electrical conductors including wires, conductive traces, and communication busses. The communication ports 626 can operate on any appropriate communication protocol. The electronic controller 620 can communicate with the sensors and detectors associated with the various machine parts by sending and receiving electronic data signals through the communication ports 626.

For example, the communication ports 626 can be communicatively linked to the first detector device 560 associated with the storage device 112, the second detector device 570 associated with the rotatable cover 118, and the third detector device 584 associated with detachment of various machine parts, the detector devices may be referred to as installation detectors.

The electronic controller 620 can also be associated with a plurality of operation sensors that measure and are responsive to operating conditions and activities associated with the ice-making process conducted by the refrigeration machine 100. Examples of operation sensors may include temperature sensors 630 associated with the ice-making region 128, motor sensors 632 associated with the drive motor 610, and level sensors 634 associated with the storage device 112. The temperature sensor 630 may be located in the evaporator drum 120. The motor sensor 632 can measure motor speed or torque, or may measure electrical characteristics like current and voltage. The level sensor can be a float sensor or switch to measure the quantity of liquid ingredients accommodated by the refrigeration machine 100.

To receive commands related to the ice-making process, the electronic controller 620 is functionally associated with the control panel 116 of the refrigeration machine 100. The control panel 116 functions as a user interface and can receive commands and can output status information regarding operation of the refrigeration machine 100. As shown in FIG. 1, the control panel 116 is preferably located at readily accessible location on the housing cabinet 104 such as above the dispensing region 102.

The control panel 116 can be associated with various inputs and outputs to interface with the user. For example, the control panel 116 can include a visual display 640 such as an LCD display with touchscreen capabilities. In an embodiment, the control panel 116 can be a manual interface with tactile buttons and switches, LED indicator lights, and similar manual controls. In a particular example, the control panel 116 may include a speed dial 642 that rotates to manually adjust the rotational speed of the evaporator drum 120 as described. The control panel 116 may include one or more preset buttons 644 or keypads for automating the ice-making operation. The controls and settings associated with the control panel 116 include characteristics like product selection, temperature, thickness and consistency, and other properties of the edible products being produced.

In an alternative embodiment, the rotational speed of the drive motor 610 may be adjusted in a still lower range, such as between 1-5 RPM for ice cream making. The slower rotational speed allows for sufficient time to cool of the ingredients by the evaporator drum as the evaporator drum picks up the ingredients liquid holding tray 134.

Additionally, the rotational speed of the motor may be dynamically adjusted and maintained at a set speed, such as 3 RPM. The motor sensor 632 may detect a change in speed and cause the controller to adjust the rotational speed back to the set speed.

Referring to FIG. 71, there is illustrated a flow diagram of the ice-making operation 650 executed by the refrigeration machine 100. The steps and operations of the flow diagram are executed by the electronic controller 620 included with the refrigeration machine 100 and operatively associated with the control panel 116. The flow diagram of the ice-making operation 650 can be embodied as a computer-readable program or software that is interpreted and performed by a computerized or electronic logic device. The programming for the flow diagram 650 can be stored in electronically readable memory 624 associated with the electronic controller 620. The following operations and sequence are examples only and operations may omitted, added, and/or reordered.

The ice-making operation may start in an initial standby mode 652 in which the refrigeration machine 100 is powered on but the different operating components are not running. For example in the standby mode 652, the refrigeration system 600, drive motor 610 and cooling fan 612 may not be operating. In standby mode 652 the refrigeration machine 100 is awaiting commands or input from the user.

One example may be a cleaning command which the user can direct using the control panel 116. The cleaning command, which can be recognized by the electronic controller 620 in a cleaning decision 654, is a direction to clean the refrigeration machine 100 after some period of use, for example, to flush out the previous ingredients. The cleaning decision 654 can initiate a cleaning mode 656 in which the electronic controller 620 regulates the states of the different operating components and parts. For example, in the cleaning mode 654, the refrigeration system 600 may be powered off and the drive motor 610 may remain powered on. The user can detach certain machine parts to access the evaporator drum 120 to clean it. In other examples, the cleaning mode 654 may power off or deactivate the drive motor and fan in addition to the refrigeration system.

The ice-making operation 650 may proceed to a mode input step 658 in which the user inputs an operating command using the control panel 116. The mode input command may be indicative of a particular mode of the ice-making operation 650. For example, the ice-making operation 650 can proceed automatically in accordance with preset instructions for producing the desired edible product. In another example, the ice-making operation can proceed manually in which the user exerts control over the operation of the refrigeration machine 100. The electronic controller 620 conducts a mode decision 660 for assessing and responding to the mode input step 658.

If manual operation is directed, the mode decision 660 proceeds to a manual mode. In manual mode, the user inputs the commands for controlling the ice-making operation through the control panel 116. The electronic control 620 receives the input user commands through a command input step 662. For example, the user may select the rotational speed of the evaporator drum 120 using the speed dial 642. The speed dial 642 may be a potentiometer adjusting the electric characteristics of the drive motor 610 such as current or voltage or the dial may adjust a transmission. The rotational speed of the evaporator drum 120 is related to the consistency of the liquid ingredients and the desired products, which slower speeds prolonging exposure to the evaporator drum resulting in lower temperatures and a colder product.

If preset or automatic operation is directed, the command decision proceeds to a preset mode. In the preset mode, the electronic controller 620 conducts a retrieval step 664 in which preprogrammed settings are retrieved from memory 624. The preprogrammed settings include the necessary instructions for producing the desired edible product. For example, the preprogrammed settings may include the rotational speed of evaporator drum, as set though the drive motor, and setting for operation of the refrigeration system 600. The preprogrammed settings can be stored in a computer readable data file and multiple files may exist for different edible products.

Before proceeding, the ice-making operation 650 may check that the refrigeration machine 100 is prepared for operation. For example, the electronic controller 620 can conduct a detector reading step 666 in which it electronically communicates with the installation detectors. The installation detectors include the first, second, and third detector devices 560, 570, and 584 associated with the storage device 112, the blade assembly 126 and the rotatable cover 118. The electronic controller 620 analyzes the data signal read from the installation detectors in a detachment decisions step 668 to determine if any machine parts are detached or not properly installed and present a hazard.

If the detachment decision step 668 determines one or more machine parts are detached, the electronic controller 620 proceeds to a pause mode 670. The pause mode 670 may be embodied as a temporary pause of the ice-making operation 650 to enable the reinstallation of the problematic machine part. During the pause mode 670, the drive motor 610 and cooling fan 612 may be powered off and the refrigeration system 600 may remain running. In pause mode 670, the evaporator drum 120 is stationary to avoid interfering with installation of machine parts and shutdown of the refrigeration system 600, which require significant power to restart, is avoided. The pause mode 670 can be accompanied by an audible or visual alert to notify the user that one or more machine parts are unattached.

The pause mode 670 can be associated with a duration or period. For example, the electronic controller 620 can include a counter 672 which is activated in response to the detachment decision step 668. The counter 672 can operate for a predetermine period after which the electronic controller 620 can again conduct the detector reading step 666 by communicating with the installation detectors. If the machine parts are still not properly installed, for example, the refrigeration machine is unattended, the electronic controller 620 proceeds to a termination step 674. During the termination step 674, the electronic controller 620 powers off the refrigeration system 600, drive motor 610, and cooling fan 612. The ice-making operation 650 may return to the standby mode 652.

The ice-making operation 650 may check the operating status of the refrigeration machine 100. For example, the electronic controller 620 can conduct a sensor reading step 680 in which it electronically communicates with the operation sensors. The operational sensors include the temperature sensors 630, motor sensors 632, and level sensors 634. The electronic controller 620 analyzes the data signals read from the operational sensors to determine refrigeration machine 100 is operation problematically. The electronic controller 620 analyzes the data signals from the operation sensors in an operation error decision 682.

The operation error decision 682 can detect errors with the ice-making operation 650 in various ways. For example, if the storage device 112 is low or depleted of liquid ingredients, the operation error decision 682 can register that condition as an error. The quantity of liquid ingredients may be measured directly by the level sensor 634 in the storage device 112. Alternatively, the quantity of the liquid ingredients may be indirectly inferred based on the temperature of the evaporator drum 120 measured by the temperature sensor 630. If the liquid ingredients have been depleted and the liquid holding tray 134 is empty, the temperature of the evaporator drum 120 will decrease significantly because the thermodynamic transfer of energy between the liquid ingredients and evaporator drum ceases. The electronic controller 620 can be programed to correlate the temperature measured by the temperature sensor 630 associated with the evaporator drum 120 to the quantity of the liquid ingredients.

The speed or current of the drive motor 610, which may be converted or correlated to motor torque, can also be indicative of errors in the ice-making operation 650. If the blade assembly 126 is impinging too sharply against the evaporator drum 120, or the liquid ingredients are too frozen, the motor torque will rise accordingly more force is required of the drive motor 610 to rotate the evaporator drum 120. The electronic controller 620 can be programed to correlate the data readings from the motor sensor 632 with these operating errors.

If the operation error decision 682 is positive and the electronic controller 620 registers and error with the ice-making operation 650, the electronic control 620 conducts a termination step 684 or operation. As suggested, during the termination step 684, the electronic controller 620 powers off the refrigeration system 600, drive motor 610, and cooling fan 612. During the termination step 684 the electronic controller 620 may also command an audible or visual alert to notify the user. Problematic operation of the refrigeration machine 100 and possible damage is avoided.

If the operation error decision 682 is negative, the ice-making operation 650 proceeds to an ice-making mode 686 to produce the desired frozen edible product. The electronic controller 620 powers on the refrigeration system 600, drive motor 610, and cooling fan 612 and regulates their operation in accordance with the manual mode or present mode as determined by the mode command decision 660. After the product is dispensed, the ice-making operation 650 terminate or may return to the standby mode 652.

Referring to FIG. 72, there is illustrated representative displays 690 that may be presented on the display screen 640 associated with the control panel 116 to interface with the user. The displays 690 may be used to input the user commands associated with the mode input step 658 and the command input step 662. The refrigeration machine 100 can operate in a manual mode with the user adjusting settings related to the desired product or liquid ingredients and a preset mode with the user selecting predetermine settings stored in memory 624 corresponding to the desired product and/or liquid ingredients. The electronic controller 620 may be programmed with a plurality of predetermined settings. The pre-stored settings may correlate the variables effecting the ice-making operation such as rotational speed of the evaporator drum, the circumference and surface area of the evaporator drum, effectiveness of the refrigeration system, and the characteristics of the liquid ingredients.

Importantly, the rotational speed of the evaporator drum 120 determines the duration of thermal contact with the liquid ingredients in the liquid holding tray 134, which effects the consistency of the edible product and may be affected by the characteristics of the liquid ingredients. For example, dairy products for producing ice cream require prolonged refrigeration for the phase change to occur. Slower rotational speeds correspond with iced products and faster rotational speeds may product semi-frozen beverages. Further manual mode allows the user to adjust the rotational speed and the consistency of the edible product. The displays 690 presents the adjustable and/or preset settings to the user and can receive commands, inputs, and selections.

The foregoing operations and steps of the algorithm are examples only and the order and sequence of the steps may change, steps may be added or omitted, and the steps may be combined and reordered in any suitable manner.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A refrigeration machine for preparing iced edibles comprising:
a housing cabinet defining a cabinet interior;
a storage device for storing ingredients;
an evaporator drum rotatably disposed in the cabinet interior and configured to contact and freeze the ingredients;
a holding tray removably installed in the cabinet interior and accessibly disposed with respect to the evaporator drum, the holding tray adapted to receive the ingredients from the storage device; and
a blade assembly mounted to the housing cabinet proximate to the evaporator drum, the blade assembly being slidably detachable from the housing cabinet and including a scrapping blade adapted to scrape the ingredients frozen to the evaporator drum.

2. The refrigeration machine of claim 1, wherein the blade assembly includes a blade holder and the blade is fixedly attached to the blade holder.

3. The refrigeration machine of claim 1, wherein the housing cabinet further comprises a housing liner assembly removably disposed in the cabinet interior.

4. The refrigeration machine of claim 3, wherein the blade assembly is slidably attached to the housing liner assembly or the housing cabinet by a wedge-lock arrangement.

5. The refrigeration machine of claim 4, wherein the housing liner assembly or the housing cabinet includes one or more slots for receiving respective flanges of the blade assembly.

6. The refrigeration machine of claim 3, wherein the housing liner assembly and the liquid holding tray cooperatively provide a first hole and a second hole laterally spaced apart from each other and adapted to encircle one or more shafts of the evaporator drum.

7. The refrigeration machine of claim 6, further comprising a first seal assembly disposed between the first hole and a first shaft of the evaporator drum and a second seal assembly disposed between the second hole and a second shaft of the evaporator drum.

8. The refrigeration machine of claim 3, wherein the liquid holding tray comprises a release mechanism to releasably latch the liquid holding tray to the housing liner assembly or the housing cabinet.

9. The refrigeration machine of claim 8, wherein the release mechanism includes an elastic element arranged to urge a securing tab to engage in the ho using liner assembly or the housing cabinet.

10. The refrigeration machine of claim 3, wherein the housing liner assembly defines a guide slot that slidably receives a guide pin located on the liquid holding tray during installation.

11. The refrigeration machine of claim 1, wherein the liquid holding tray comprises a drain valve mechanism to drain the ingredients.

12. The refrigeration machine of claim 1, wherein the liquid holding tray includes an inclined surface or a depression arranged to direct liquid ingredients to the drain valve mechanism.

13. The refrigeration machine of claim 12, wherein the drain valve mechanism comprises:
a drain pipe defining a valve seat and a valve element located in the drain pipe and movable against and away from the valve seat, and
a valve actuating handle that is selectively set between opened and closed positions of the drain valve mechanism.

14. The refrigeration machine of claim 1, wherein the liquid holding tray comprises an overflow valve.

15. The refrigeration machine of claim 1, wherein the evaporator drum defines an evaporator chamber that is in fluid communication with a refrigerant introduction pipe and a vapor return pipe.

16. The refrigeration machine of claim 1, further comprising a drive motor operatively disposed to rotate the evaporator drum.

17. The refrigeration machine of claims 1, further comprising a detector device operatively disposed to detect detachment of the storage device.

18. The refrigeration machine of claim 1, further comprising a detector device operatively disposed to detect detachment of the blade assembly.

19. The refrigeration machine of claim 3, wherein the housing liner assembly comprises an inner shell that is detachably insertable into an outer shell.

20. The refrigeration machine of claim 1, further comprising a control panel to interface with an operator, the control panel including a speed dial to adjust rotational speed of the evaporator drum.
